(19) United States
(12) Patent Application Publication
(10) Pub. No.: US 2026/0339321 A1
(43) Pub. Date: Oct. 29, 2026

(54) HUMANOID ROBOT DATA COLLECTION SYSTEM HAVING VIRTUAL REALITY DISPLAYS

(71) Applicant: Figure AI Inc., San Jose, CA (US)

(72) Inventors: Victor Ragusila, San Jose, CA (US); Louis Foucard, San Jose, CA (US); Patrick Varin, San Jose, CA (US); Moritz Alexander Graule, San Jose, CA (US); Samuel Jaccob Baker, San Jose, CA (US); Ali Fuat Ozhan, San Jose, CA (US)

(21) Appl. No.: 19/656,881

(22) Filed: Apr. 23, 2026

Related U.S. Application Data
(60) Provisional application No. 63/792,998, filed on Apr. 23, 2025.

(51) Int. Cl. G05D 1/224; G02B 27/00; G02B 27/01; G05D 1/2285; G05D 101/15; G05D 109/12; G05D 111/50; G06F 3/01; G06F 3/16

(52) U.S. Cl. CPC G05D 1/2245; G02B 27/0093; G02B 27/017; G02B 27/0179; G05D 1/2285; G06F 3/012; G06F 3/014; G06F 3/017; G06F 3/167; G02B 2027/0187; G05D 2101/15; G05D 2109/12; G05D 2111/52

(57) ABSTRACT

A portable data collection system for capturing operator movement data to control or train a humanoid robot. The system includes a wearable apparatus, such as a base mount with an adjustable back harness, supporting first and second articulated arms pivotably coupled thereto. Each articulated arm comprises rigid frame links connected by joints instrumented with joint encoders. Gloves coupled to distal portions of the arms include hand sensors measuring finger movement. A head-mounted display presents visual feedback from the robot. A piloting control system, communicatively coupled to the encoders and hand sensors, generates control data and selectively suspends and resumes its generation or transmission—for example, upon detecting operator movement outside a defined task workspace or velocity profile, and upon detecting a predetermined resumption gesture, actuation, or voice command. A shared time synchronization clock enables timestamped logging of sensor measurements paired with robot-state records, supporting consistent operator-side and robot-side signal characteristics.

### CROSS-REFERENCE TO RELATED APPLICATIONS

This application claims the benefit of and priority to U.S. Provisional Patent Application Nos. 63/792,998, filed on Apr. 23, 2025, which is fully incorporated herein by reference.

### TECHNICAL FIELD

This disclosure relates to systems, methods, and techniques for data collection having virtual reality displays for use with a humanoid robot. The system maps and/or transforms data from a camera arrangement, potentially including a vertical arrangement of cameras, associated with a humanoid robot to a display arrangement, such as a horizontal arrangement of viewports contained in a virtual reality (VR) headset, particularly focusing on minimizing motion-to-glass latency.

### BACKGROUND

Robotic systems are widely used to perform tasks in remote, hazardous, or otherwise inaccessible environments, and teleoperation—the remote control of such robots by a human operator—is a foundational enabling technology. Recent advances in virtual reality (VR) have produced compelling teleoperation interfaces in which a head-mounted display (HIMD), or VR headset, presents the operator with an immersive visual and auditory rendering of the robot's surroundings, thereby improving situational awareness and the intuitiveness of control. VR-based teleoperation has been applied in manufacturing, maintenance, disaster response, and planetary exploration, and is increasingly relied upon to address labor shortages for undesirable or unsafe work. In such systems, the operator is placed within a sensory loop with the remote robot, with operator head motion, hand motion, and gaze direction mapped to corresponding robot behaviors and visual attention.

Notwithstanding these benefits, the practical realization of seamless and effective VR teleoperation remains constrained by several technical challenges. A principal limitation is the latency between the robot and the operator's VR interface, particularly the visual latency between the robot's camera feed and the images presented in the HMD. Elevated visual latency introduces perceptible delay between the operator's head movements or control inputs and the corresponding visual feedback, producing a sense of disconnection, degrading task precision, and slowing reaction times. It is also a well-documented contributor to cybersickness, which limits operator comfort and reduces the usable duration of a teleoperation session. The sources of this latency are multi-faceted and include image acquisition at the robot's sensors; processing of the acquired data (which, in the case of imagery, may entail re-projection, stitching, or format conversion to render the content suitable for stereoscopic presentation); network transmission between the robot and the operator station; and rendering within the VR system itself. Compounding these factors, many existing robotic vision systems employ camera configurations that are not optimized for direct stereoscopic presentation in VR, necessitating additional image-processing steps that further add to latency.

As VR displays advance toward higher resolutions and frame rates, the processing and transmission burden on teleoperation systems continues to grow, making efficient, low-latency handling of sensor data increasingly important. Existing approaches typically struggle to balance image quality, computational load, and bandwidth demands while maintaining the low latency required for an immersive and responsive experience. A further and less commonly addressed challenge arises from a mismatch between the geometric baseline of the robot's cameras and the horizontal baseline expected by a VR HMD matched to the human interpupillary distance. In humanoid platforms in particular, packaging constraints within the head may dictate a vertical camera baseline, introducing geometric transformation costs that are not present in conventional stereo VR pipelines. There is accordingly a need for VR teleoperation systems that bound end-to-end latency within envelopes suitable for comfortable and effective operator control, while accommodating the stereoscopic geometry actually produced by robotic sensor platforms.

### SUMMARY

The present disclosure relates to wearable data collection and teleoperation systems for capturing human operator movement to control, and/or generate training data for, a humanoid robot, and to complementary systems, methods, and devices for transforming image data captured by cameras on a humanoid robot into low-latency stereoscopic imagery rendered on a virtual reality (VR) headset worn by the operator. Together, these subsystems provide an end-to-end VR teleoperation platform in which operator-side motion is captured, suspended, and resumed through an intelligent clutching mechanism while the operator simultaneously receives real-time visual feedback derived from vertically arranged robot-head cameras and reprojected into a horizontal stereoscopic view matched to the operator's interpupillary distance.

In one aspect, the portable data collection system comprises a base mount and an adjustable harness coupled to the base mount and configured to secure the base mount to the back of a human operator. A first articulated arm and a second articulated arm are each pivotably coupled to the base mount, each comprising a plurality of rigid frame links connected by a plurality of joints, together with a plurality of joint encoders configured to measure rotational movement of those joints. In certain embodiments, each articulated arm comprises at least seven joints, defining at least seven degrees of freedom between the base mount and the distal portion of the arm; in other embodiments, each arm comprises first, second, and third rigid frame links connected by first, second, and third joints, with an encoder at each joint. A first glove is coupled to a distal portion of the first articulated arm, and a second glove is coupled to a distal portion of the second articulated arm, each glove including one or more hand sensors configured to measure finger movement of the operator including movement of individual finger joints such as at least one thumb joint and optionally coupled to the distal portion of the corresponding arm via a glove mount.

A piloting control system is communicatively coupled to the joint encoders and the hand sensors and is configured to suspend and resume the generation or transmission of control data that is based, in part, on signals from those sensors. The piloting control system may comprise sensor-interface circuits for the joint encoders and hand sensors, a kinematic-mapping processor configured to generate robot control commands from the sensor measurements, and an interface configured to transmit the robot control commands to a whole-body controller of the robot. The system may further comprise a torso inertial measurement unit (IMU) coupled to the base mount, a first wrist IMU coupled to the distal portion of the first articulated arm, and a second wrist IMU coupled to the distal portion of the second articulated arm, from which, together with the joint encoder signals, the piloting control system determines a six-degree-of-freedom pose of each wrist of the operator relative to the operator's torso, for example by fusing these measurements.

The piloting control system may suspend the generation or transmission of control data in response to detecting operator movement that falls outside a defined task workspace or outside a defined task velocity profile, and resume generation or transmission in response to detecting a predetermined resumption movement. A clutch mechanism operable by the operator may also manually trigger suspension for example, a pressure-sensitive grip configured to trigger suspension when the operator's grip relaxes below a threshold in the range of 5 to 20 Newtons, or a physical button providing tactile feedback and requiring an actuation force of 2 to 10 Newtons. Suspension may be selectively applied to a predefined subset of degrees of freedom (for example, the arms) while control data continues to be generated or transmitted for one or more remaining degrees of freedom, such as a head-tracking channel. During suspension, the piloting control system may continue to collect measurements from the joint encoders and hand sensors while withholding corresponding control data. Upon resumption, the piloting control system may apply a ramping period, for example of between approximately 0.5 and 2 seconds, during which the control data is generated subject to velocity and acceleration limits, such that motion of the controlled robot smoothly re-engages rather than resuming instantaneously. A haptic feedback mechanism may provide multi-modal sensory confirmation to the operator of successful engagement and disengagement, including clicks, vibrations, or changes in resistance, and voice commands may also trigger suspension or resumption, optionally processed with a recognition accuracy above 95%.

A data storage device coupled to the piloting control system, together with a time synchronization clock shared between the portable data collection system and the humanoid robot, enables the piloting control system to log timestamped records comprising measurements from the joint encoders and the hand sensors paired with robot-state data received from the robot, each record timestamped using the shared clock. In certain embodiments, this shared clock is implemented as IEEE 1588 Precision Time Protocol (PTP) synchronization with sub-microsecond accuracy, such that operator-side and robot-side samples can be correlated at a precision finer than the inter-frame interval of the vision subsystem. Clutch-engagement intervals, suspension intervals, sensor measurements, and corresponding robot control commands may be logged to a training-data store. A head-mounted display may be worn by the operator, comprising a head position sensor communicatively coupled to the piloting control system and configured to provide head positional data, and the piloting control system is configured to maintain a visual feedback path from the humanoid robot to the head-mounted display during any interval in which generation or transmission of control data is suspended. In further embodiments, the joint encoders and one or more IMUs of the portable data collection system are of a common sensor technology with corresponding joint encoders or IMUs installed on the humanoid robot, such that sensor-level noise and bias characteristics propagate substantially identically through the operator-side and robot-side signal chains.

In another aspect, the portable data collection system comprises a wearable apparatus configured to be worn by an operator and powered by a battery; a display carried by the wearable apparatus and configured to present visual data to the operator; one or more sensors configured to detect operator movements; and a clutch controller configured to (i) generate a suspension message in response to detecting operator movement that falls outside a defined task workspace or outside a defined task velocity profile, (ii) in response to the suspension message, suspend the generation or transmission of control data, (iii) generate a resumption message in response to detecting a predetermined resumption movement by the operator, and (iv) in response to the resumption message, resume generation or transmission of the control data. The display may comprise a virtual reality headset configured to display visual data received from a humanoid robot in communication with the wearable apparatus, optionally including a head position sensor and an eye-tracking sensor, and the clutch controller is configured to maintain the visual feedback path from the robot to the headset during suspension, thereby preventing operator disorientation.

The defined task workspace may comprise a spatial region extending not more than approximately one meter from a nominal operator position, with a threshold exceeding 1 meter of repositioning movement triggering suspension, and the defined task velocity profile may comprise an operator-movement velocity not exceeding approximately two meters per second, with a threshold velocity exceeding 2 meters per second triggering suspension. The clutch controller may utilize anomaly detection algorithms to identify movements outside the defined task workspace, and may comprise an intelligent clutch module configured to run at 100 to 500 Hz. The intelligent clutch module may use machine learning models trained on datasets of 103 to 105 operator interactions to predict and automatically engage suspension during natural pauses lasting 2 to 10 seconds; more generally, the defined task workspace, the defined task velocity profile, or both, may be defined by a machine-learning model trained on prior operator-movement records associated with a task performed by the operator, and the clutch controller may update these definitions as additional operator-movement records are accumulated. The clutch controller may further comprise a machine-learning model trained on prior operator interactions to predict a pause or transition in an operator workflow, and may generate the suspension message when an eye-tracking system detects that the operator is looking away from a primary task area for a period exceeding 3 seconds, or when the eye-tracking sensor indicates that the operator's gaze has remained outside a defined task area for more than 3 seconds.

The predetermined resumption movement may comprise one or more of a predefined gesture detected by the sensors, actuation of an operator-actuated device integrated with the wearable apparatus, a voice command recognized by a speech-recognition module, interaction with a tracked controller associated with the virtual reality headset, or selection, by gaze dwell, of a virtual button presented on the display. Resumption may be performed over a ramping period of between approximately 0.5 seconds and approximately 2 seconds, subject to velocity and acceleration limits, such that motion of the controlled robot smoothly re-engages, and the clutch controller may apply a hysteresis interval between issuance of a resumption message and subsequent issuance of a further suspension message, the hysteresis interval selected to inhibit oscillation between suspension and resumption states. The system may further comprise a first articulated arm and a second articulated arm pivotably coupled to the wearable apparatus, each arm comprising a plurality of rigid frame links connected by joints, with the sensors comprising joint encoders that measure rotational movement of the joints. The suspension message may be configured to cause suspension for a predefined subset of degrees of freedom while leaving generation or transmission unaffected for one or more remaining degrees of freedom for example, suspending control for at least one but fewer than all robot arm joints while visual data continues to be presented. A haptic output device carried by the wearable apparatus may provide tactile confirmation when a suspension or resumption message is generated, and a data storage device coupled to the clutch controller, together with a time synchronization clock shared with a humanoid robot, enables the clutch controller to log each suspension and resumption message with a timestamp derived from the shared clock alongside sensor measurements, with clutch-engagement intervals, sensor measurements, and control commands logged to a training-data store.

In a further aspect, the portable data collection system comprises a wearable apparatus configured to be worn by an operator and powered by a battery; a display carried by the wearable apparatus and configured to present visual data; a first glove configured to be worn by the operator and comprising one or more hand sensors configured to measure finger movement; and a piloting control system communicatively coupled to the hand sensors and configured to suspend and resume generation or transmission of control data based in part on the hand sensors. A first articulated arm may be pivotably coupled to the wearable apparatus, comprising rigid frame links connected by joints, with joint encoders measuring rotational movement of the joints, and the first glove may be coupled to a distal portion of the arm via a glove mount. A second glove may be worn on the opposite hand, comprising one or more additional hand sensors that likewise contribute to the control data, and the hand sensors of each glove are configured to measure movement of individual finger joints of the corresponding hand, including at least one thumb joint. A wrist IMU may be coupled to the first glove or to the glove mount, providing orientation data of the operator's wrist to the piloting control system, such that the control data is further based on wrist orientation measured by the wrist IMU, and the display may comprise a virtual reality headset with a head position sensor that provides head positional data to the piloting control system.

The piloting control system in this aspect may be configured to suspend generation or transmission of control data in response to operator movement that falls outside a defined task workspace or velocity profile, and to resume in response to a predetermined resumption movement. A clutch mechanism comprising, for example, a button with tactile feedback requiring 2 to 10 Newtons of actuation force may trigger the piloting control system, and the display may provide a virtual button, with suspension triggered when the operator selects the virtual button via gaze dwell of 0.5 to 2 seconds. Suspension may be selectively applied such that hand-sensor control data is suspended while head tracking remains active to maintain situational awareness. Gesture recognition, using a gesture library of 10 to 50 commands, may serve as a suspension or resumption trigger, including a predefined clutch gesture detected via the hand sensors, with a resumption finger gesture similarly detected. A haptic feedback mechanism integrated into the first glove may provide vibration at frequencies of 100 to 300 Hz upon suspension of the control data, and a separate foot pedal communicatively coupled to the piloting control system may allow the operator to selectively engage and disengage suspension. In some embodiments, the piloting control system is configured to resume transmission immediately, with latencies under 50 ms; in others, resumption applies a ramping period subject to velocity and acceleration limits for smooth re-engagement. During suspension, the display continues presenting visual data in particular, a head-mounted display continues to receive continuous visual feedback from the robot during suspension to prevent operator disorientation. The wearable apparatus may comprise a base mount and an adjustable harness configured to secure the base mount to the back of the operator, and a time synchronization clock shared between the wearable apparatus and the humanoid robot enables the piloting control system to log records comprising hand-sensor measurements paired with robot-state records received from the robot, each record timestamped using the shared clock, with suspension intervals, timestamped sensor measurements, and corresponding control commands logged to a training-data store. As with the earlier aspects, the hand sensors may be of a common sensor technology with corresponding sensors installed on the humanoid robot, such that sensor-level noise and bias characteristics propagate substantially identically through operator-side and robot-side signal chains, and the piloting control system may comprise sensor-interface circuits for the hand sensors, a kinematic-mapping processor configured to generate robot control commands from the hand-sensor measurements, and an interface configured to transmit the robot control commands to a controller of the robot.

Complementing the operator-side subsystems above, the disclosure further provides a system for transforming image data from robot cameras into VR imagery presented to the operator of the wearable apparatus. The system comprises a humanoid robot having a head with a vertical arrangement of cameras comprising an upper camera and a lower camera separated by a vertical baseline of 15-35 cm, the cameras optionally including fisheye lenses with a field of view exceeding 120 degrees; an edge computing node comprising a graphics processing unit (GPU) and a hardware encoder, located within 10 meters of the robot; a VR headset with a refresh rate of at least 90 Hz and integrated eye-tracking sensors; and a Wi-Fi 6E or 5G URLLC network connection between the robot, edge computing node, and VR headset. The edge computing node is configured to receive image data directly from the vertical arrangement of cameras via a dedicated MIPI CSI-2 interface, bypassing the robot's main processing stack, and to preprocess the image data by correcting fisheye lens distortion, adjusting perspective alignment between the upper and lower cameras, and compensating for vertical offset using a homography-based rectification algorithm. The node then transforms the preprocessed image data from the vertical arrangement into a horizontal stereoscopic view for VR using a Semi-Global Matching (SGM) algorithm implemented on a Field-Programmable Gate Array (FPGA) to generate a dense depth map with sub-centimeter accuracy, followed by Depth Image Based Rendering (DIBR) to synthesize horizontally aligned stereoscopic views matched to the operator's interpupillary distance.

The edge computing node further optimizes the transformed image data by encoding using hardware-accelerated H.264 Baseline profile with a latency under 6 milliseconds, reducing resolution in peripheral regions based on eye-tracking data, and applying latency-compensation algorithms comprising asynchronous timewarp (ATW) with a 20-millisecond prediction window, asynchronous spacewarp (ASW) when frame rates drop below 45 frames per second, phase sync techniques to coordinate rendering with VR display refresh cycles, and Kalman-filter-based predictive tracking with IMU sensor fusion. The node implements IEEE 1588 Precision Time Protocol (PTP) for sub-microsecond synchronization between cameras, and the optimized transformed image data is returned to the VR headset via the Wi-Fi 6E or 5G URLLC connection with Quality of Service (QoS) prioritization, enabling rendering in viewports with less than 20 ms motion-to-photon latency. In some embodiments, the upper and lower cameras are each angled downward at 7.5 degrees relative to a horizontal plane, such that the combined field of view aligns with a manipulation workspace in front of the robot at torso height near the optical axis of each camera; each camera has a resolution of at least 4 megapixels, a frame rate of at least 60 frames per second, and a global shutter with exposure times less than 5 milliseconds, and the two cameras capture overlapping fields of view with at least 80% overlap. This combination of resolution, frame rate, and global-shutter exposure time yields per-frame readout intervals short enough to maintain sub-pixel stability during rapid robot or head motion. In further embodiments, the edge computing node determines disparity between upper and lower camera images using a Census Transform-based cost function with a 9×7 window size, generating a dense depth map with a minimum of 256 depth levels using SGM with 8 aggregation paths and a uniqueness ratio of 0.95, and the Census Transform-based cost function may be implemented in dedicated fixed-function logic elements of the FPGA such that cost-volume construction exhibits a deterministic worst-case execution time measured in microseconds per scan line; the dense depth map is used in a 3D warping function that preserves depth cues and minimizes geometric distortion in the peripheral regions of the rendered image.

In a corresponding method, image data from a vertical arrangement of cameras on a humanoid robot head is received by an edge computing node via a dedicated MIPI CSI-2 interface, where the cameras are separated by a 15-35 cm baseline, include fisheye lenses exceeding 120 degrees field of view, and have a global shutter with exposure under 5 milliseconds. The method preprocesses the image data by correcting fisheye lens distortion using a Brown-Conrady model with at least 5 distortion coefficients, adjusting perspective alignment using a homography matrix optimized to minimize the Loop & Zhang distortion metric, and compensating for vertical offset using a calibrated transformation matrix. The preprocessed image data is transformed into a horizontal stereoscopic view by generating a dense depth map with sub-centimeter accuracy using SGM implemented on an FPGA, creating a 3D point cloud from the depth map and camera parameters, and rendering novel stereoscopic views from virtual camera positions separated by the operator's measured interpupillary distance. The transformed image data is optimized by encoding using hardware-accelerated H.264 Baseline profile with a maximum bitrate of 50 Mbps; implementing foveated encoding with three distinct quality regions based on real-time eye tracking; applying ATW with a prediction window calibrated to the measured end-to-end system latency; applying ASW when frame rates drop below 45 fps; applying phase-sync techniques to align rendering with the VR display's vertical blanking interval; applying an extended Kalman filter for predictive tracking with sensor fusion from headset IMU data sampled at 1000 Hz; and implementing IEEE 1588 PTP for sub-microsecond synchronization between cameras. The optimized transformed image data is returned to a VR headset with a refresh rate of at least 90 Hz via a Wi-Fi 6E or 5G URLLC connection with QoS prioritization, for rendering at less than 20 ms motion-to-photon latency. In some embodiments, the cameras are angled downward at 0 to 40 degrees relative to horizontal, each having a resolution of at least 4 megapixels and a frame rate of at least 60 fps, and are calibrated using a checkerboard pattern with at least 10×10 internal corners to determine intrinsic and extrinsic parameters with a reprojection error less than 0.5 pixels; calibration may be performed prior to deployment, re-run as part of a field-service procedure upon detection of drift or mechanical disturbance, and stored in non-volatile memory of the robot head from which the edge computing node loads the parameters at startup to parametrize its distortion-correction and rectification pipelines. Disparity determination may use a Census Transform-based cost function with variable window size and a disparity search range of at least 128 pixels, and SGM aggregation may use 8 paths with a P1 penalty of 8 for small disparity changes and a P2 penalty of 32 for larger disparity changes; the SGM parameters P1 and P2 may be adjusted at runtime in response to scene statistics, with textured regions aggregated using a larger P2 penalty and low-texture regions using a smaller P1 penalty, to balance depth smoothness against edge fidelity, and a 3D warping function using sub-pixel interpolation may be applied for smooth transitions between views.

The disclosure also provides a humanoid robot configured for VR image data transformation with on-board processing. The robot comprises a head assembly with a vertical camera arrangement (15-35 cm baseline, fisheye lenses exceeding 120 degrees, global shutter under 5 ms, resolution of at least 4 megapixels); a processing stack comprising an FPGA, a GPU, and a hardware H.264 Baseline encoder with latency under 6 ms; a Wi-Fi 6E or 5G URLLC network interface with QoS prioritization; and a dedicated MIPI CSI-2 interface connecting the cameras directly to the processing stack. The processing stack captures image data at at least 60 fps, preprocesses the data on the FPGA using Brown-Conrady distortion correction with at least 5 coefficients, homography-based perspective alignment minimizing the Loop & Zhang distortion metric, and calibrated vertical-offset compensation and transforms the preprocessed data into a horizontal stereoscopic view via SGM on the FPGA with 8 aggregation paths, constructs a 3D point cloud, and renders novel stereoscopic views at the operator's interpupillary distance. The stack then optimizes the output with hardware encoding at up to 50 Mbps, foveated encoding with three regions, ATW, ASW, phase sync, extended Kalman filter predictive tracking with headset IMU sensor fusion, and IEEE 1588 PTP synchronization, and transmits the data to a VR headset with at least 90 Hz refresh rate for rendering at less than 20 ms motion-to-photon latency. In certain embodiments, the cameras are angled 0-30 degrees downward, with 20 cm vertical baseline and at least 80% field-of-view overlap, and calibrated with a 10×10 checkerboard to sub-half-pixel reprojection error. Disparity determination uses a Census Transform cost function with a 9×7 window and at least 128 pixel search range; SGM produces at least 256 depth levels with P1=8 and P2=32; and DIBR hole-filling addresses disocclusion regions using background-texture synthesis, neural inpainting, and/or temporal infilling from prior-frame depth, in each case operating on the SGM-produced dense depth map.

The VR headset for displaying such transformed image data comprises a display with left and right viewports having a combined resolution of at least 4K (3840×2160) pixels, a refresh rate of at least 90 Hz, and a horizontal field of view of at least 100 degrees; an eye tracking system with a sampling rate of at least 120 Hz and accuracy within 0.5 degrees of visual angle; an IMU with a sampling rate of at least 1000 Hz; a GPU capable of at least 5 TFLOPS; and a Wi-Fi 6E or 5G URLLC network interface with QoS prioritization. The headset processor receives an H.264 Baseline profile encoded stream with a maximum bitrate of 50 Mbps, decodes it with a hardware decoder with latency under 1 ms, and applies final optimizations including ATW with a 20 ms prediction window, ASW using depth information to generate intermediate frames when the received frame rate drops below 45 fps, and predictive tracking using an extended Kalman filter that fuses IMU data with historical pose information to predict head position 20 ms in the future. Rendering occurs at less than 20 ms motion-to-photon latency using low-persistence display technology with a duty cycle of less than 30% to reduce motion blur. The headset processor may further apply foveated rendering based on eye-tracking data, rendering a high-resolution foveal region within 5 degrees of gaze at native display resolution, a medium-resolution parafoveal region between 5-15 degrees at 50% of native resolution, and a low-resolution peripheral region beyond 15 degrees at 25% of native resolution, utilizing GPU variable-rate shading to render different regions at different resolutions in a single pass. The boundaries between these regions may be smoothed by a transition zone of one to three degrees of arc to avoid visible banding, and this reduces computational load by at least 30% and further decreases motion-to-photon latency to less than 15 ms for the foveal region. In further embodiments, the processor applies a sensor fusion algorithm comprising an extended Kalman filter with a 12-state model (position, velocity, orientation, and gyroscope bias) combining IMU data (3-axis gyroscope at at least 0.01 deg/s precision, 3-axis accelerometer at at least 0.01 g precision) with eye tracking data to generate a predicted head pose and gaze direction 20 ms in the future. This predicted pose enhances the accuracy of ATW by applying a non-linear motion model that accounts for acceleration and jerk components of head movement, of ASW by incorporating depth information to handle disocclusions more accurately, and of predictive tracking by adapting prediction parameters based on current velocity and acceleration of head movement. The processor also dynamically adjusts the size and shape of the foveal, parafoveal, and peripheral regions based on the predicted pose and gaze direction, current rendering performance metrics, and network latency measurements with the foveal region expanding during rapid head movements to compensate for prediction uncertainty and contracting during steady gaze to maximize rendering efficiency.

In a further aspect in which heavier computational workloads are offloaded from the robot, the disclosure provides a system for low-latency image transformation for VR teleoperation. The system comprises a humanoid robot with a head assembly carrying a vertical arrangement of cameras (20 cm vertical baseline; fisheye lens with 170-degree field of view; global shutter with 2 ms exposure; resolution of 4K (3840×2160) at 90 fps); an edge computing node located within 10 meters of the robot and comprising a server-grade CPU with at least 16 cores, a GPU with at least 16 GB of VRAM and hardware-accelerated ray tracing, an FPGA programmed for real-time stereo matching, and a hardware video encoder supporting H.264, H.265, and AV1; a VR headset with 120 Hz refresh rate, 4K-per-eye resolution, 240 Hz eye tracking, and 1000 Hz IMU; and a dedicated Wi-Fi 6E network connection with 160 MHz channels in a private network with QoS prioritization and a measured round-trip time of less than 5 ms. The edge computing node receives raw image data directly from the cameras via a dedicated MIPI CSI-2 interface with a bandwidth of at least 10 Gbps, bypassing the robot's main processing stack and using Direct Memory Access (DMA) with zero-copy buffer management. It performs real-time vertical-to-horizontal view transformation using a hybrid approach combining SGM on the FPGA for initial depth estimation (2048×1536 pixels, 256 disparity levels) with neural radiance fields (NeRF) implemented via NVIDIA Instant-NGP on the GPU with a multi-resolution hash grid encoding of 16 levels and a network width of 64 channels, or alternatively 3D Gaussian splatting (3DGS) with adaptive density control of 2-5 million Gaussians. Latency compensation algorithms include ATW with a 20 ms prediction window calibrated using a PID controller that adapts to measured end-to-end latency, and ASW using depth-aware reprojection that incorporates both the SGM dense depth map and the NeRF or 3DGS volumetric representation. The node streams transformed and compensated image data to the VR headset using hardware-accelerated H.264 Baseline profile encoding with a target bitrate of 50 Mbps for the foveal region and 20 Mbps for peripheral regions, implementing foveated encoding based on real-time eye tracking, and using the QUIC transport protocol with forward error correction—yielding rendering with less than 20 ms motion-to-photon latency in the foveal region and less than 30 ms in peripheral regions.

In some embodiments of this edge-computing aspect, the node receives IMU data from the robot at 1000 Hz (3-axis gyroscope at 0.01 deg/s precision, 3-axis accelerometer at 0.01 g precision) and fuses this data with the raw image data using an extended Kalman filter with a 15-state model (position, velocity, orientation, gyroscope bias, and accelerometer bias) and a measurement update rate of 90 Hz synchronized with camera frame rate via IEEE 1588 PTP with sub-microsecond accuracy. The improved pose estimate is used in vertical-to-horizontal view transformation and latency compensation to pre-render views along predicted camera trajectories and to cache intermediate results of the NeRF or 3DGS computation, with the predicted camera trajectories sampled at a set of pose candidates spanning a prediction horizon of approximately 20 ms and pose-indexed intermediate results stored in cache memory and invalidated upon detection of a pose deviation exceeding 1 cm of translation or 1 degree of rotation between the indexed pose candidate and a newly observed actual pose. The edge computing node may comprise an FPGA with at least 500,000 logic elements programmed to perform initial image preprocessing—lens distortion correction using a Brown-Conrady model with 8 distortion coefficients, color space conversion from Bayer RAW to YUV 4:2:0, and temporal noise reduction using a 3-frame moving average with motion compensation—and its GPU, operating in a real-time priority mode with dedicated compute and memory resources isolated from other system processes, executes the NeRF or 3DGS techniques using custom CUDA kernels with 16-bit floating-point precision.

In a corresponding adaptive method, image data is captured using a vertical camera arrangement on a humanoid robot head (20 cm baseline, fisheye 170-degree field of view, 2 ms exposure global shutter, 4K at 90 fps) and transmitted to an edge computing node via MIPI CSI-2 with at least 10 Gbps bandwidth, DMA, and zero-copy buffer management. The method continuously monitors network latency using active probing at 100 Hz, available computational resources at the edge computing node (including GPU utilization, memory bandwidth, and thermal headroom), and VR headset metrics including motion-to-photon latency measured via a photodiode-based testing apparatus. It dynamically selects a transformation algorithm based on current system latency—choosing homography-based rectification implemented on an FPGA with 0.5 ms processing latency when network round-trip time is below 5 ms, or neural view synthesis using Instant-NGP with a 16-level multi-resolution hash grid and 64-channel network width when network round-trip time exceeds 5 ms. The selection logic may be further refined using active probing via ICMP packets sent at 100 Hz and timestamped with microsecond precision to measure average round-trip time and jitter: homography-based rectification is selected when round-trip time is below 5 ms, jitter is below 1 ms, and GPU utilization exceeds 80% or thermal headroom falls below 10 °C, using a pipelined FPGA architecture with 16 parallel processing elements and a fixed-point representation with 16-bit precision; neural view synthesis is selected when round-trip time is above 5 ms or jitter exceeds 1 ms, and GPU utilization is below 80% with thermal headroom above 10 °C, using Instant-NGP with adaptive quality scaling that adjusts the number of training iterations (5,000-15,000), multi-resolution hash grid resolution (16-24 levels), and network width (32-128 channels) based on available computational resources.

Foveated encoding is applied based on real-time eye tracking data (sampling rate 240 Hz, accuracy within 0.5 degrees, latency of less than 5 ms), dividing each frame into three concentric regions: a foveal region within 5 degrees of gaze encoded at full resolution and 50 Mbps, a parafoveal region between 5-15 degrees at half resolution and 20 Mbps, and a peripheral region beyond 15 degrees at quarter resolution and 10 Mbps. A Kalman filter applied to the raw gaze data reduces noise and predicts gaze position 50 ms in the future using a non-linear motion model accounting for saccadic eye movements, and the three regions are delineated based on the predicted gaze direction and a model of human visual acuity that accounts for the contrast sensitivity function (CSF) at different eccentricities. Region-specific encoding parameters may be applied: the foveal region is encoded using H.264 High profile with quantization parameter (QP)=18, a 30-frame key frame interval, and a B-frame count of 2; the parafoveal region using H.264 Main profile with QP=24, a 60-frame key frame interval, and a B-frame count of 1; and the peripheral region using H.264 Baseline profile with QP=28, a 90-frame key frame interval, and no B-frames. Transformed and encoded image data is transmitted to the VR headset using the QUIC transport protocol with forward error correction, adaptive congestion control tuned for real-time media, and QoS prioritization with Differentiated Services Code Point (DSCP) marking set to Expedited Forwarding (EF). Rendering occurs in the VR headset with adaptive resolution and frame rate based on measured end-to-end latency, implementing a control system that adjusts rendering parameters to maintain motion-to-photon latency below 20 ms in the foveal region including dynamically switching between native 120 Hz rendering when latency budget permits and 60 Hz rendering with ASW when computational or network constraints are detected.

In a still further aspect, a hybrid camera-based VR teleoperation system is provided in which the humanoid robot head assembly includes both a vertical arrangement of internal cameras—an upper camera angled downward at 7.5 degrees and a lower camera 20 cm below, also angled downward at 7.5 degrees, each with a fisheye 170-degree field of view and 4K resolution at 60 fps—and a horizontal arrangement of external cameras comprising a left camera and a right camera separated by a horizontal baseline of 6.5 cm matching average human interpupillary distance, each with a rectilinear 90-degree field of view and 2K (2048×1536) resolution at 120 fps. A computing architecture (server-grade CPU with at least 16 cores, GPU with at least 16 GB VRAM and hardware-accelerated ray tracing, FPGA programmed for real-time stereo matching, and hardware video encoder supporting H.264, H.265, and AV1) communicates with a VR headset (120 Hz refresh, 4K per eye, 240 Hz eye tracking, 1000 Hz IMU). High-resolution narrow field-of-view data from the horizontal external cameras is received via a dedicated MIPI CSI-2 interface with at least 5 Gbps bandwidth, and wide field-of-view data from the internal vertical cameras via a separate dedicated MIPI CSI-2 interface with at least 10 Gbps bandwidth, using DMA with zero-copy buffer management.

The computing architecture fuses the two image data streams using a transformer-based multi-view synthesis neural network comprising 12 encoder layers, 8 attention heads, and a 768 hidden dimension, trained on a dataset of 100,000 multi-view images captured by the robot's cameras with ground-truth depth information obtained from a LiDAR sensor. Training uses a combination of L1 photometric reconstruction loss (weight 0.8), perceptual loss based on VGG-16 features (weight 0.1), and adversarial loss from a PatchGAN discriminator (weight 0.1), using the Adam optimizer with learning rate 1e−4 and batch size 8 for 500,000 iterations. In further embodiments, the multi-view synthesis network comprises an encoder network that extracts features from the high-resolution narrow field-of-view image data and the wide field-of-view image data, implemented as a modified ResNet-50 architecture with dilated convolutions in the later stages to increase receptive field size without reducing spatial resolution, and with feature pyramid network (FPN) connections to preserve multi-scale information; a fusion network that combines the extracted features and generates a volumetric scene representation, implemented as a transformer with cross-attention mechanisms that allow features from different camera views to attend to each other, followed by a 3D convolutional network that constructs a volumetric feature grid with 128 channels and 64 depth planes; and a renderer network that synthesizes novel views from the volumetric scene representation based on the operator's current head pose and gaze direction, implemented as a differentiable ray marching algorithm that samples the volumetric feature grid at 64 points along each ray and processes these samples through a small MLP with 4 layers of 128 units each to predict RGB color and density values. Gaze-contingent rendering driven by VR headset eye-tracking prioritizes the operator's current gaze direction by allocating 80% of computational resources to the foveal region within 5 degrees of the gaze point, 15% to the parafoveal region between 5-15 degrees, and 5% to the peripheral region beyond 15 degrees. Fused and gaze-optimized image data is streamed to the VR headset using QUIC with forward error correction, adaptive congestion control tuned for real-time media, and QoS prioritization with DSCP marking set to Expedited Forwarding (EF), yielding less than 20 ms motion-to-photon latency in foveated regions and less than 30 ms in peripheral regions. In some embodiments, the computing architecture receives IMU data from sensors on the robot at 1000 Hz, including 3-axis gyroscope readings with a precision of 0.01 deg/s, 3-axis accelerometer readings with a precision of 0.01 g, and 3-axis magnetometer readings with a precision of 0.1 microtesla, and fuses this data with the image data streams using an extended Kalman filter with a 15-state model (position, velocity, orientation, gyroscope bias, and accelerometer bias) at a measurement update rate synchronized with the camera frame rates via IEEE 1588 PTP with sub-microsecond accuracy. The improved pose estimate is used in multi-view synthesis and gaze-contingent rendering to further reduce motion-to-photon latency by pre-rendering views along predicted camera trajectories and caching intermediate results of the neural network computation, with a cache invalidation strategy based on a distance metric in 6-DOF pose space that triggers recomputation when the predicted pose deviates by more than 1 cm in translation or 1 degree in rotation from the cached poses.

Taken together, the aspects described above provide a portable, untethered teleoperation platform for a humanoid robot in which the operator-side motion capture and clutching subsystems cooperate with the robot-side or edge-side vision transformation and VR rendering subsystems to deliver low-latency, high-fidelity bidirectional teleoperation and high-quality training-data capture. The suspend-and-resume clutch functionality whether manually actuated, automatically triggered by workspace or velocity violations, driven by gaze behavior, or machine-learned pause prediction permits the operator to disengage control without loss of visual feedback or data continuity, while ramping, hysteresis, and haptic confirmations ensure smooth and unambiguous transitions between piloted and suspended states. The vertical-to-horizontal view transformation pipelines, implemented in hardware-accelerated SGM, DIBR, NeRF, 3DGS, and/or transformer-based multi-view synthesis, and optimized with ATW, ASW, phase sync, predictive Kalman filtering, foveated encoding, and QUIC, Wi-Fi 6E, or 5G URLLC transport, enable the operator to receive stereoscopic imagery matched to their interpupillary distance at motion-to-photon latencies below 20 ms in the foveal region. Matching sensor technology between operator and robot, IEEE 1588 PTP time synchronization between the operator-side and robot-side signal chains with sub-microsecond accuracy, and shared timestamping of suspension and resumption events alongside raw and transformed data streams together support faithful transfer of captured motion to robot control and to downstream learning systems.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command and/or be commanded by, control and/or be controlled by, and/or interact;

FIG. 2 is a block diagram illustrating components of the humanoid robot of FIG. 1;

FIG. 3A is a perspective view of a humanoid robot of FIGS. 1-2;

FIG. 3B is a diagram illustrating actuators contained within the humanoid robot of FIGS. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8 is a block diagram of an onboard artificial intelligence (AI) system for the humanoid robot of FIGS. 1-3B;

FIG. 9 is a schematic diagram of a portable data collection system having: (i) a humanoid robot, (ii) a mobile data collection apparatus, (iii) data storage, (iv) a secondary computer, (v) a display, and (vi) a clutch in communication directly or via a network;

FIG. 10 is a diagram showing an open loop connection between the operator wearing the wearable training apparatus and the robot of FIG. 9;

FIG. 11 is a diagram showing a closed loop connection between the operator wearing the wearable training apparatus and the robot of FIG. 9;

FIG. 12A is a diagram showing the relationship between the cameras of the robot and the eyes of the user wearing the wearable training apparatus, where the vertical arrangement of optical sensors of the robot provides a reoriented view for the user;

FIG. 12B is a diagram showing an external set of cameras affixed to the robot head;

FIG. 13 is a conceptual diagram illustrating example dataflows between components for transforming image data for VR displays;

FIG. 14 is a conceptual diagram of a system for robot-based image transformation for VR display;

FIG. 15 is a conceptual diagram of a system for edge computing node-based image transformation for VR display;

FIG. 16 is a conceptual diagram of a split processing architecture for transforming images for VR display;

FIGS. 17A and 17B illustrate a flowchart of a process for transforming image data for VR display;

FIG. 18 illustrates example top and bottom images that can be captured using cameras on a robot;

FIG. 19 illustrates an example of the images from FIG. 18 transformed into stereo images for the left and right viewports of a VR headset; and

FIG. 20 illustrates an example view of what a user sees when wearing the VR headset of FIG. 19.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure. The level of abstraction selected for each described element is intended to allow a person of ordinary skill in the art to make and use the described systems and methods without undue experimentation.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be a condition of operation. Rather, in some embodiments, such features may be arranged in a different manner and/or order than shown in the illustrative figures. Additionally, the inclusion of a structural or method feature in a particular figure is not meant to imply that such feature is used in all embodiments and, in some embodiments, may not be included or may be combined with other features. The figures may omit certain elements for clarity, and elements depicted in one figure may be combined with elements depicted in another figure to form additional embodiments of the disclosed systems and methods.

### A. INTRODUCTION

General-purpose humanoid robots emulate human form and functionality with two legs, two arms, and a face-like screen. With the general-purpose humanoid robot's emulation of the human body, arises a corresponding set of design considerations for torso and arm assemblies that can closely replicate human movements, capabilities, and structural nuances. The considerations for the torso and arm assemblies to be capable of mimicking human structure and functions extend far beyond cosmetic resemblance. For example, it is also desirable that the torso and arm assemblies enable the end effector of the robot to be able to seamlessly interact with and physically manipulate diverse objects in complex environments while performing in a durable, cost-effective, and controllable manner using the robot's limited resources, including its battery power resources. Such mechanical capability may be paired with a sensing and control subsystem that provides the robot with perception, planning, and execution faculties suitable for the targeted tasks.

To enable the humanoid robot to seamlessly interact with and physically manipulate diverse objects in complex environments, data may be collected to train the artificial intelligence-based models that are running on the computer that are either local to the robot, remote to the robot, and/or a combination of both. To collect the above described data, a robot data collection system can be used that includes a wearable training apparatus configured to be worn by a human user and is designed to control the robot to perform a given task or command. As part of the wearable training apparatus, a virtual reality (VR) headset can be used by the human operator. The VR headset can be configured to display visual feedback by streaming images and video captured by the robot's cameras during both training and runtime operation. This allows the user to experience the robot's visual perspective in real-time, enabling more precise control, intuitive decision-making, and a deeper understanding of the robot's environment while collecting high-quality training data. The immersive VR interface can enhance the operator's ability to interact with complex environments through the robot, ensuring the robot's movements and actions more accurately reflect human-like manipulation during both data collection and autonomous execution phases.

Accordingly, the disclosed technology provides for arranging an external set of cameras on the robot, collecting image data from those cameras, and mapping or transforming that image data from a vertical arrangement of the cameras to a horizontal arrangement of viewports contained in the VR headset. The image contained in the viewport can be in stereovision view. However, said system can have high latency that may be greater than 750 milliseconds (ms), making it unusable. Thus, described herein are solutions to enable motion-to-photon latencies to be below 300 ms, preferably below 170 ms, and most preferably below 20 ms. The reduced latency can result from improved data transmission paths between the external set of cameras and a processor (e.g., a computing architecture) that transforms the image data. For example, the image data generated by the external set of cameras can be transmitted directly to the processor, thereby bypassing the robot's processing stack. Alternative architectures may involve dedicated connections like MIPI CSI-2 directly to an encoding/processing unit or utilizing protocols like RDMA (Remote Direct Memory Access) over compatible networks to minimize CPU involvement in data transfer. Sometimes, the image data can pass through the robot processing stack, where the image data can be preprocessed, before being transmitted to the processor for the heavier transformation operations. Such preprocessing might include Bayer demosaicing, lens distortion correction, or timestamp synchronization using protocols like PTP (Precision Time Protocol), performed efficiently on robot hardware (e.g., ISP or FPGA) before transmission. In yet some implementations, the image data may also be used for developing and training robot control models, which calls for careful consideration of data routing and potential impacts on real-time latency if shared resources are contended.

While latency in image capture can vary widely, optimized sensors can achieve latencies in low single-digit milliseconds or even microseconds for event detection. More conventional mobile camera sensors may introduce around 15 ms of effective delay before processing can begin. Sometimes, camera circuitry may add ~6 ms, while a particular USB camera setup can exhibit 100 ms frame extraction time. The frame refresh interval can add a delay uniformly distributed between 0 and 1/frame rate (e.g., 0-16.7 ms for 60 frames per second (fps)). In selecting cameras for the described VR feed path, capture latency may be minimized by choosing sensors with short readout intervals, global-shutter operation, and output interfaces such as MIPI CSI-2 that support direct delivery into processing hardware without an intermediate USB enumeration stack.

Moreover, a task of transforming views from a vertical stereo baseline to a horizontal VR display can introduce unique geometric challenges beyond general view synthesis. The fundamental mismatch lies in orientation of the baseline—the line connecting optical centers of two cameras. In the input (e.g., vertical stereo), the baseline can be vertical, while the desired output (e.g., for standard VR head-mounted displays (HMDs)) can require an effective horizontal baseline corresponding to the user's eye separation. This geometric disparity can have direct implications for epipolar geometry, a set of constraints governing a relationship between corresponding points in two images. Standard stereo algorithms and hardware may often be highly optimized for the horizontal baseline case, where epipolar lines (the lines on which corresponding points lie) are typically horizontal after a rectification process. A vertical baseline, however, can result in epipolar lines that may not generally be horizontal in raw images, potentially being vertical or slanted depending on camera convergence. This can lead to non-standard epipolar configurations, such as epipoles appearing within the image boundaries, which can pose significant problems for traditional rectification techniques. Consequently, algorithms must either rectify the vertical stereo pair into a virtual horizontal configuration or employ view synthesis methods capable of handling arbitrary input geometries and generating novel views consistent with the target horizontal baseline. Examples of rectification techniques include Homography-Based Rectification, Polar Rectification, or learned rectification using neural networks. View synthesis methods include Depth Image Based Rendering (DIBR), Multi-Plane Images (MPI), Neural Radiance Fields (NeRF), or 3D Gaussian Splatting (3DGS), each with different computational costs and latency profiles.

The system's stereovision processing can be highly dependent on an applied algorithm, resolution, and/or hardware. Software implementations on CPUs can be slow, potentially hundreds of milliseconds (e.g., 391 ms example). Field-Programmable Gate Array (FPGA) implementations can offer significant acceleration, with reports of sub-2 ms latency for disparity computation at 60 fps. Embedded GPU implementations can show real-time performance, often measured in frames per second (e.g., 32 fps implies ~31 ms per frame processing time), though the exact latency can depend on the specific GPU and algorithm. Deep learning inference can add its own latency component. The choice of stereo hardware target therefore may represent a trade-off between determinism (favoring FPGA), flexibility (favoring GPU), and cost, and the disclosed systems may employ any of the above options alone or in combination within a single edge computing node.

The system may include hardware encoders can be designed for low latency. Implementations of H.264 Baseline profile on FPGAs can report adding less than 1 ms. NVIDIA's NVENC can show, as another illustrative example, a median latency of around 6 ms for H.264, though this may depend on the preset, GPU generation, and load. Xilinx VCU low-latency mode can target 4 ms encode latency. Alternative low-latency codecs like JPEG XS or techniques like foveated encoding can also be considered to reduce bandwidth and potentially encoding latency. Software encoding may be substantially slower, potentially tens or hundreds of milliseconds depending on the complexity and CPU power. Buffering within the encoder can add further delays, from milliseconds to potentially a second. Similar to encoding, hardware decoders can be very fast. H.264 Baseline hardware decoders report less than 1 ms latency. Another example decoder measured mean decoding latency around 0.3 ms.

A total VR rendering (MTP) latency within a VR system itself (e.g., from head motion input to photon output) for headsets has also been measured to be initially between 21 ms and 42 ms, which can then be functionally reduced to 2-13 ms by motion prediction algorithms once movement is established. Breaking this down, rendering time may contribute roughly 17 ms or more, and display mechanisms another 17 ms or more at 60 hertz (Hz). For PC VR streaming setups (e.g., which can include encoding/transmission/decoding not accounted for in pure MTP measurements above), application-to-photon latencies of 40-50 ms can be considered typical or achievable, often requiring careful optimization across the entire pipeline: capture, processing, encoding, network transmission, decoding, and rendering. VR systems actively can work to keep the perceived latency, especially for head rotation, below the significant 20 ms threshold using techniques like asynchronous timewarp (ATW). Other techniques include asynchronous spacewarp (ASW) for frame interpolation, predictive tracking, and phase synchronization.

It should be understood that network transmission may be the most variable time component. Round-trip times (RTTs) for wired LAN can be low single-digit milliseconds (e.g., 6.6 ms RTT), while Wi-Fi can add significant latency (e.g., 58 ms RTT) though Wi-Fi 6/6E/7 with appropriate QoS configurations (e.g., WMM) can significantly improve Wi-Fi latency and reliability compared to older standards. Cellular networks (4G/5G) typically exhibit higher latency (e.g., 115 ms RTT), although 5G URLLC aims for <1 ms user plane latency, achieving this consistently end-to-end is difficult. Long distances, like transatlantic links, result in hundreds of milliseconds RTT (e.g., 240 ms). One-way latency is approximately half the RTT in symmetric conditions, but asymmetry is common. Utilizing edge computing nodes closer to the robot can mitigate latency introduced by long-distance network links.

Accordingly, the disclosed technology provides solutions for accurately and efficiently transmitting and transforming image data from cameras attached to or otherwise a part of robots into data for display in VR headsets. The disclosed technology achieves said solutions to reduce or otherwise eliminate the latencies described herein. This involves optimizing each stage of the pipeline, from sensor selection and data acquisition, through geometric transformation and view synthesis, to encoding, network transport, decoding, and final rendering with latency compensation techniques. The disclosed solutions may produce a measurable technological improvement over prior teleoperation pipelines, in that the end-to-end motion-to-photon latency at the foveal region of the VR headset may be maintained below approximately 20 milliseconds under typical operating conditions, thereby improving the functioning of the computer, device, and network carrying the teleoperation signals.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein. Terms introduced with example syntax (e.g., by example) are not intended to limit the scope of the term. When a term is defined in a manner that departs from its customary usage, the definition provided herein controls for purposes of interpreting this specification.

Although selected human medical terminology is used to describe features and/or relative positions related to the humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base. A humanoid robot as defined herein may have one or more sensors (e.g., cameras, inertial measurement units, force sensors) mounted on any of its components to enable perception and control.

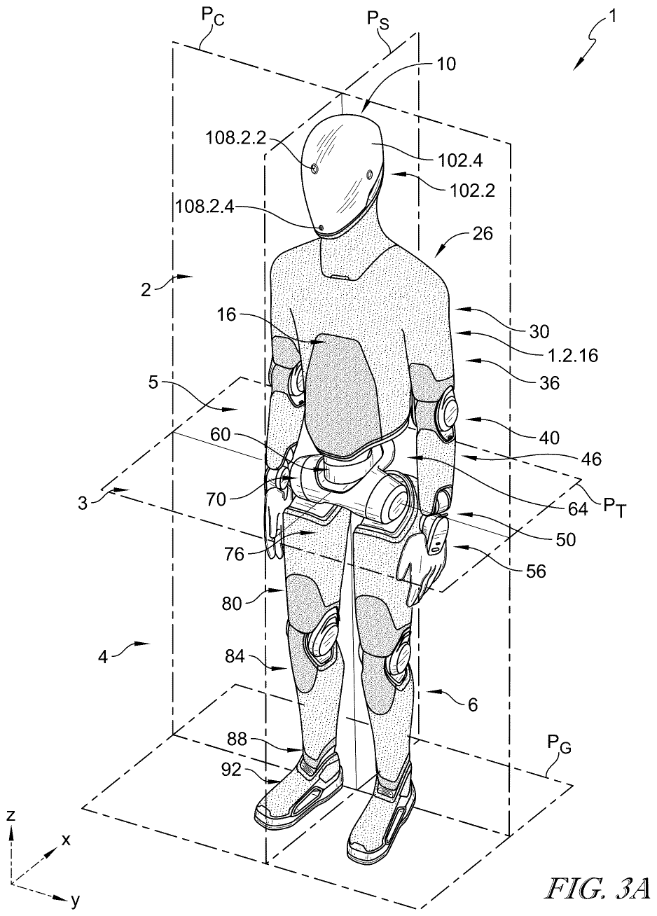

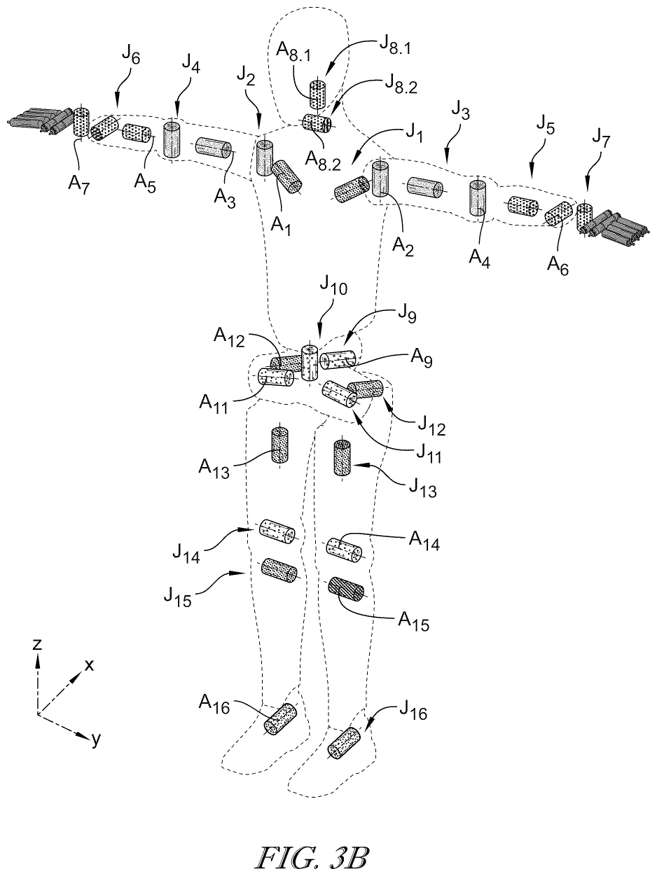

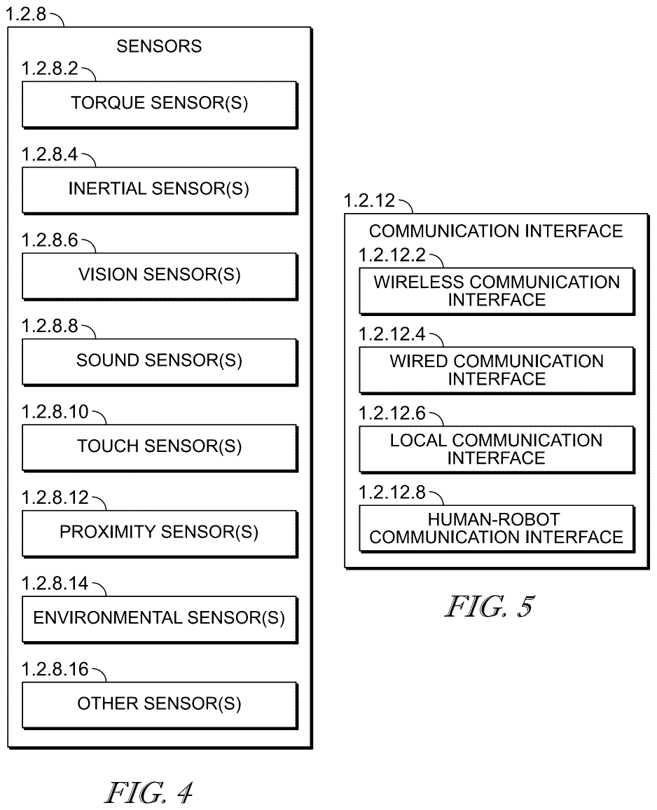

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A. The neutral state serves as a reference pose from which other poses may be defined, and from which actuator angles and joint ranges may be measured.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state. The extended state may be used as a reference configuration for kinematic analysis of the arm assemblies. In the extended state, the rotational axes of the elbow joints may be aligned with the coronal plane of the robot. The extended state may also be used during diagnostic or calibration procedures to measure arm range of motion and joint encoder alignment.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A₁₀ of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (P_{C}) is a vertical plane that contains the rotational axes A₁₁ of the hip flex actuators (J11) located in the hips 70 (and likewise may contain an axis defined by a line connecting the midpoints of a left hip flex actuator (J11) axis (A₁) and a right hip flex actuator (J11) axis (A₁) and rotational axis A₁₀ of torso twist actuator (J10) located in the spine 60 of the robot 1. As shown in these figures, the coronal plane (Pc) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1. The transverse plane may serve as a reference for defining the vertical position of components of the robot 1 along the Z-axis. In further embodiments, the transverse plane may be used to partition the robot into upper-body and lower-body subsystems for purposes of control and data collection.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (C_{P}) is present and shown. The origin point may serve as a reference origin for defining the position of other components of the robot 1 in three-dimensional space. Coordinates of components may be expressed relative to the origin point in the X, Y, and Z directions defined below.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point. The reference axes provide a Cartesian basis for expressing the poses of components of the robot 1 and of any associated operator-facing apparatus. The reference axes may also be used to express camera extrinsics for the cameras on the head of the robot 1 relative to the robot's body frame.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians. The range of motion for each actuator may be set by a hard-stop, a soft-stop (e.g., a software-enforced angular limit), or a combination of both. The range of motion may be selected to emulate the corresponding range of motion of a human joint, subject to mechanical design constraints. In some embodiments, the range of motion of an actuator may be restricted during particular operational modes, such as transport or calibration.

Degrees of Freedom (DoF): the number of parameters that define the configuration of the kinematic chain and possible movements associated therewith. The degrees of freedom of the robot 1 include the sum of the degrees of freedom of the individual joints. In one illustrative embodiment, the robot 1 has two degrees of freedom at the head assembly 10, seven degrees of freedom in each arm assembly 5, at least two degrees of freedom in the torso 16, and six degrees of freedom in each leg assembly 6. The total number of degrees of freedom of the robot 1 may be adjusted by adding or removing joints in various assemblies.

Singularities: geometric configurations of the robot's joints in which one or more degrees of freedom are effectively lost due to the alignment or overlap of rotational or translational axes, which in some cases is also affected by interference of extents of components where one or more of the components are moved by the joint. Singularities may be avoided by the movement controller 1302 through path planning that maintains the robot 1 away from poses near singular configurations. In some embodiments, singularities may be used advantageously to lock a joint at a particular configuration while still allowing motion in other degrees of freedom. Detection of approaching singularities may be based on the determinant of the robot's Jacobian matrix falling below a threshold.

Actuator Bearing: a specific component of the individual actuator that is generally ring-shaped with parallel edge guides, wherein the rotational axis (A₁) of the actuator is centered within the actuator bearing and orthogonal to the parallel edge guides. Within this application, the actuator bearings of individual actuators are referenced to further define orientation of the rotational axes and/or relative size of the individual actuator. The actuator bearing may be of any type suitable for the loads encountered by the actuator, including ball bearings, roller bearings, crossed-roller bearings, or combinations thereof. In further embodiments, the actuator bearing may be integrated with the actuator's gear reduction to provide a compact structural assembly.

Actuator bearing plane (Bₙ): a plane defined mid-width of actuator bearing between parallel edge guides and orthogonal to the rotational axis (Aₙ). The actuator bearing plane may serve as a geometric reference for defining the location of the actuator within the robot's kinematic chain. For example, the position of the actuator within a limb may be specified by the location of the actuator bearing plane along the limb's central axis. The actuator bearing plane may also be used to define the relative orientation of an actuator with respect to adjacent actuators in a kinematic chain.

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above. Textiles may be used as external covers for any of the assemblies of the humanoid robot 1 or the wearable training apparatus 3200. A textile cover may include one or more layers with different mechanical properties (e.g., an inner stretchable layer and an outer abrasion-resistant layer).

### C. ROBOT(S) AND ENVIRONMENT

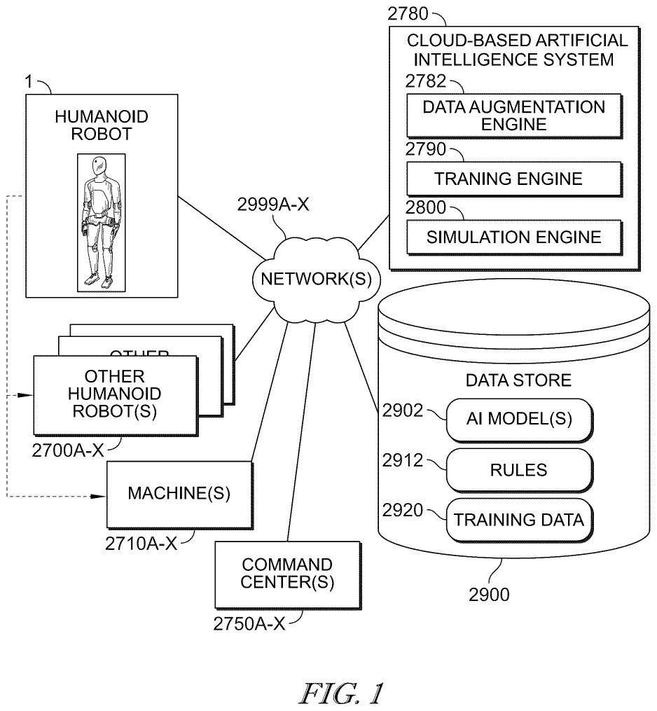

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location. In some embodiments, coordination between the humanoid robot 1 and other humanoid robots 2700A-X at different geographical locations may be arranged through the command centers 2750A-X or the remote AI system 2780.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines. Interaction with the machines 2710A-X may involve physical contact, button presses, lever manipulation, or other forms of actuation by the humanoid robot 1. In some embodiments, the machines 2710A-X may also be instrumented and may transmit their state (e.g., operational mode, load, temperature) to the command centers 2750A-X or the humanoid robot 1 via the one or more networks 2999A-X.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task. The assignment decision may be based on factors such as battery level, current task queue, distance to the task location, capability manifest, or any combination thereof. In some embodiments, the command centers 2750A-X may also dynamically re-assign tasks in response to robot failures or changes in task priority.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of vision data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/IIL techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands of AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800. In further embodiments, one or more of the engines 2782, 2790, and 2800 may execute across a set of distributed compute instances in a cloud environment, with load balancing and sharding of workloads being handled by a cloud orchestration layer. In yet further embodiments, portions of the engines 2782, 2790, and 2800 may execute at an edge computing node positioned near the humanoid robot 1 to reduce end-to-end latency for particular tasks.

### D. HUMANOID ROBOT

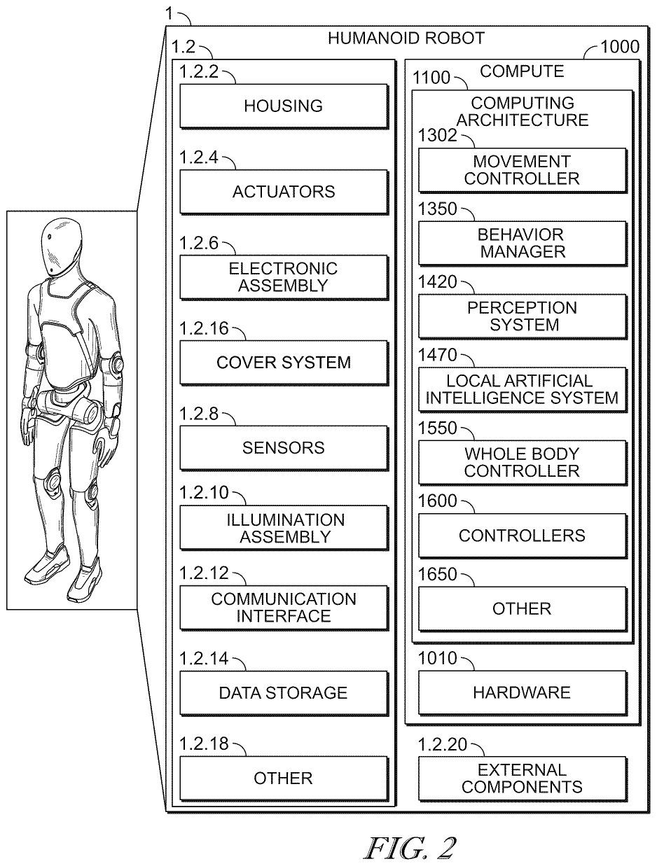

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, cover system 1.2.16, external components 1.2.20, other components 1.2.18, and (ii) compute 1000 that includes a computing architecture 1100 including instructions to be executed on computing hardware 1010 comprising at least one processor.

### a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot. In the disclosed systems, the humanoid robot configuration provides a set of geometric constraints on the placement of the cameras 108.2.2, 108.2.4 on the head 10.1, and these constraints in turn inform the design of the vertical-to-horizontal stereoscopic transformation pipeline described herein.

### i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6. These regions may be designed and assembled as modular subsystems, such that repairs or upgrades may be performed on one region without complete disassembly of the others.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane (P_{S}) but is asymmetrical about Z-Y and X-Y planes that intersect the head and are parallel to the coronal plane (Pc) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end. The curvilinear geometry of the head 10.1 may accommodate the sensor openings for the upper camera 108.2.2 and the lower camera 108.2.4 while maintaining continuity of the exterior shell 102.2. The camera openings may be integrated into the exterior shell 102.2 to maintain the overall head shape and to present an uninterrupted surface for cleaning.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane (P_{S}). This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any pertinent safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences-without relying on the main displays. This method of communication may be more power-efficient than displays, and may relay information more rapidly. In further embodiments, the illumination assembly 1.2.10 may be coordinated with audible status tones generated by the head and neck assembly 10 to provide a multi-modal indication of the robot's state.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1. In some embodiments, the head 10.1 may further house an inertial measurement unit (IMU) of common sensor technology with inertial measurement units carried on a wearable apparatus 3200 worn by an operator, such that the operator-side and robot-side inertial measurement units exhibit substantially matched noise characteristics, bias stability, and axis alignment, which results in a cross-platform mapping from operator motion to robot motion that resolves to an identity-plus-calibration transformation.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from vision and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle. In teleoperation mode, the head actuators J8.1, J8.2 may be commanded by head pose data received from a VR headset 3152 worn by the operator, such that the operator's head motion maps through a kinematic transformation onto the robot's head motion.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms. These linear actuators or parallel-link mechanisms may offer higher precision or load capacity in certain applications. In yet further embodiments, the head 10.1 may be mounted to the neck through a gimbal arrangement that provides multi-axis motion without the use of discrete actuators at each axis.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback. In some embodiments, the modular head design may include a standardized connector that permits the head 10.1 to be detached from the neck for maintenance without disconnecting individual sensor cables. 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16. The torso 16 may further serve as a primary mechanical load path between the lower body of the robot 1 and its upper body. In some embodiments, the torso 16 may include removable access panels that permit service of the electronics assembly 1.2.6 without disassembly of the arm assemblies 5 or the head and neck assembly 10.

The electronics assembly 1.2.6 within the torso 16 includes various interconnected components that are used for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies 5 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

### b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are desired to perform such a diverse array of generalized tasks.

### i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table. Each actuator (J1)-(J16) may be driven by a brushless DC motor coupled to a gear reduction stage, with position and torque feedback provided by one or more encoders and optional current-sensing circuitry in the motor driver.

TABLE 2

| Actuator | Qty | Actuator Name | Informal Actuator Name(s) | Axis |
|---|---|---|---|---|
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand pitch, flick | A₆ |
| (J7) 520 | 2 | wrist pivot | wrist/hand z, wrist/hand yaw, wave | A₇ |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, forward kick | A₁₁ |
| (J12) 768 | 2 | hip roll | hip x, hip/leg roll, sideways kick | A₁₂ |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or first ankle | A₁₅ |
| (J16) 900 | 2 | foot roll | talus, foot roll, foot x, second ankle | A₁₆ |

It should be understood that in other embodiments, some of these systems, assemblies, components, and/or parts may be omitted, combined, or replaced with alternative systems, assemblies, components, and/or parts. In further embodiments, additional actuators may be added to provide supplementary degrees of freedom (e.g., a head roll actuator, additional torso degrees of freedom, or toe articulation). In yet further embodiments, the actuators may be driven by alternative motor technologies, such as permanent magnet synchronous motors, linear actuators, pneumatic actuators, or hydraulic actuators, with corresponding changes to the drive electronics and control software.

### c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

### i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

### ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650. Each of these subcomponents may be implemented as one or more software modules executing on the compute hardware 1010, as dedicated hardware, or as a combination of the two. The subcomponents may communicate with one another through shared memory, inter-process message queues, or network sockets. In further embodiments, one or more of the subcomponents may be replicated or distributed across multiple compute hardware instances for redundancy or load balancing.

### 1. Movement Controller

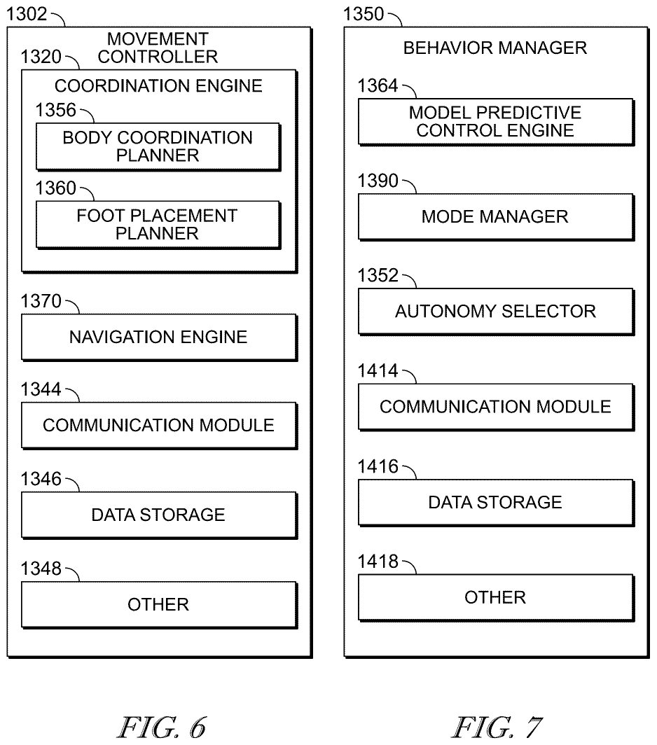

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1. In some embodiments, the navigation engine 1370 may implement simultaneous localization and mapping (SLAM) using any of a monocular visual SLAM pipeline, a stereo SLAM pipeline (e.g., using the cameras 108.2.2, 108.2.4 of the head 10.1), a visual-inertial SLAM pipeline (e.g., using an IMU in the torso 16), or a LiDAR-based SLAM pipeline.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several key technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

### 3. Local AI System

Another technical challenge addressed by the local AI system 1470 is the integration and interpretation of multi-modal sensory data. The humanoid robot 1 is equipped with various sensors, including vision, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that priority processes receive adequate computational power while less urgent tasks are managed efficiently. This dynamic resource management enables the robot 1 to maintain optimal performance across a wide range of operational scenarios, from simple repetitive tasks to complex problem-solving situations.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Overtime, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 4. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470. In some embodiments, the perception system 1420 may be structured as a pipeline of processing stages, with each stage operating on the output of the preceding stage and producing intermediate representations that are consumed by downstream modules.

### 5. Local AI System

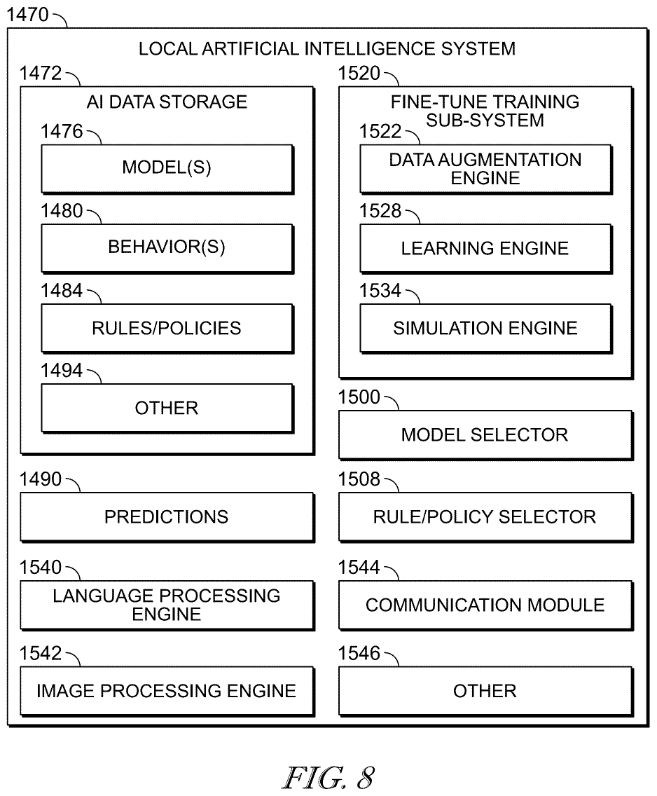

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 8. The distribution of inference between the local AI system 1470 and the remote AI system 2780 may be governed by latency requirements, available bandwidth, and privacy considerations, with time-sensitive inference (e.g., motor control) running locally and less time-sensitive inference (e.g., long-horizon planning) running remotely.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including vision, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time. In some embodiments, rules and policies 1484 may include hard constraints (e.g., safety interlocks that cannot be overridden at runtime) and soft constraints (e.g., preferences for smoother trajectories). In further embodiments, the rule and policy selector 1508 may apply a precedence ordering among active rules and policies 1484 to resolve conflicts between them.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input vision data (e.g., as obtained by sensors 1.2.8 such as cameras or in preloaded training data). In some embodiments, the image processing engine 1542 may share hardware acceleration resources (e.g., GPUs, NPUs) with the vertical-to-horizontal view synthesis pipeline described herein, with the sharing arbitrated by the local AI system 1470 based on current workload priorities.

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470. In further embodiments, the communications module may implement a publish/subscribe pattern in which subsystems publish state information on named channels and downstream consumers subscribe to the channels of interest. In yet further embodiments, the communications module may provide a Quality of Service guarantee on channels that carry time-sensitive data, such as the image stream from the cameras 108.2.2, 108.2.4 to the image processing engine 1542.

### 6. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 7. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices. In further embodiments, the other components 1650 may include a health monitoring module that tracks the temperature and current draw of each actuator 1.2.4 and issues alerts when a tracked value exceeds a threshold indicative of pending failure.

### E. PORTABLE DATA COLLECTION SYSTEM

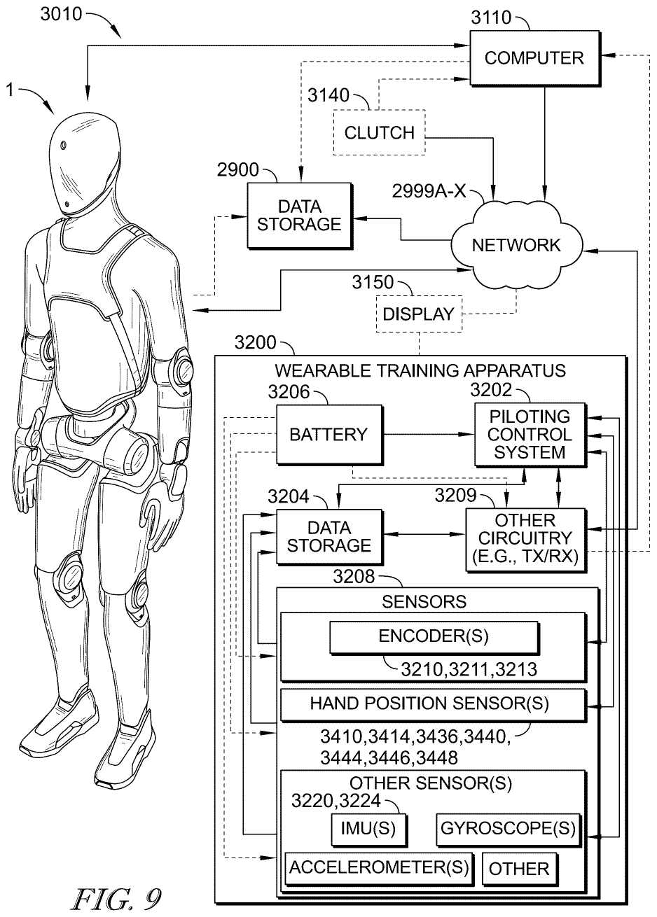

As best illustrated in FIG. 9, the portable data collection system 3010 may include: (i) a mobile data collection apparatus 3200, (ii) a computer 3110, (iii) a data storage database 2900, (iv) a clutch 3140, (v) a display 3150, which may be a headset device, and/or (vi) the robot 1 in data communication via a network 2999A-X. The data collection system 3010 includes a mobile data collection apparatus 3200 to be worn by an operator (also referred to as a pilot, user, teleoperator, data collector, apparatus wearer, or human operator) to collect pilot movement data associated with the operator's movements. This pilot movement data may be utilized by a robot 1 for training models and executing teleoperation tasks. The pilot movement data may be stored locally within data storage 3204 on the apparatus 3200, stored remotely in the data storage database 2900, and/or transmitted in real-time to the robot 1 through the network 2999A-X. This data may be incorporated into training data of the robot 1 to be utilized to perform tasks in the operational environment, including manipulation tasks, locomotion patterns, and complex multi-step procedures.

The data collection system 3010 is designed to collect data derived from the movements of the operator while performing various tasks and activities. Specifically, while wearing the apparatus 3200, the operator generates pilot movement data that may include or relate to: (i) the position and/or movement of the operator in space while performing a task, including translational and rotational components in three-dimensional space, (ii) the relative spatial locations of anatomical joint centers of rotation, including shoulder, hip, elbow, knee, wrist, ankle, and/or finger joints, (iii) the velocity and acceleration profiles of each tracked body segment, and/or (iv) any other data about the operator that is relevant to the control and training process (e.g., grip force patterns, hand orientation trajectories, or movement timing sequences). The pilot movement data may be captured at sampling rates ranging from 1 Hz to 10 kHz, with higher sampling rates providing finer temporal resolution for rapid movements. In some embodiments, the sampling rate may be dynamically adjusted based on the detected movement velocity or task complexity to optimize data quality while managing storage and bandwidth constraints.

This pilot movement data may encompass: (a) the position and movement of the operator's torso, including actions such as twisting or bending at the waist with angular measurements in roll, pitch, and yaw axes, and the operator's location within a training environment tracked through both relative and absolute positioning methods, (b) the position and movement of the arms of the operator, where such tracking may detail the operator's shoulder motion, elbow flexion and extension, wrist pose (defined by both position and orientation) in six degrees of freedom, and hand or finger gestures, which can be captured via gloves 3400 coupled to the mobile data collection apparatus 3200 or other sensors with sufficient resolution to distinguish individual finger movements (e.g., each joint) of the operator, and/or (c) the position and movement of the legs of the operator, where such tracking may detail the operator's hip motion, knee flexion and extension, ankle pose (defined by both position and orientation) in six degrees of freedom. In alternative embodiments, the pilot movement data may also include head position and orientation data captured through sensors integrated into the display 3150 or through separate head-mounted sensors. The tracking of leg movements may enable full-body teleoperation scenarios where the robot 1 replicates both upper and lower body motions of the operator.

The pilot movement data can be captured by the mobile data collection apparatus 3200 as sensor data, which may then be transferred to another component for further processing or storage through various communication protocols. This recipient component may be: (i) a remote computer (e.g., a command center 2750) connected via wireless or wired networks, (ii) the computer 3110 integrated with or separate from the apparatus 3200, or (iii) another computing system or architecture, such as the whole body controller (WBC) 1550 operating on compute 1000 of the robot 1. This data transfer enables the execution of instructions to generate robot control data or log data for training purposes, such as training the robot 1 itself through supervised learning methods, or training models like Bipedal Action Models (BAMs) for use in controlling the robot 1. The data transfer may occur at various rates depending on the application demands, ranging from batch transfers for offline training to real-time streaming for teleoperation. In some embodiments, the data transfer may employ data compression algorithms to reduce bandwidth requirements while preserving data fidelity for time-sensitive teleoperation applications.

The disclosed data collection system 3010 is a cost-effective solution that may not require an overly complex mechanical design to achieve robust human data capture while maintaining high fidelity in motion tracking. This type of data collection system 3010 simplifies the overall data collection process when compared to some alternatives and may not demand a substantial number of additional external sensors or environmental detection devices, such as the external cameras often utilized for tracking in traditional motion capture systems. For example, the data collection system 3010 does not inherently demand an extensive external camera setup that calls for controlled lighting, which is a common condition for purely vision-based motion capture systems that rely on optical markers. Because the primary positional data is collected through integrated sensors directly coupled to the operator wearing the mobile data collection apparatus 3200, there are generally no line-of-sight occlusion or “black-out” spots created by machines, furniture, or other structures present in the training environment. This can be a significant problem for external camera-based systems where occlusions may result in data loss or interpolation errors. In addition to avoiding such black-outs, the disclosed system is less expensive than highly complex, large-scale motion capture setups that demand dedicated facilities and extensive calibration procedures.

The data collection system 3010 includes onboard sensors integrated directly into the wearable structure, and thus generally does not demand a quiet acoustic environment. Additionally, the apparatus 3200 is designed to be portable as it is worn by the operator, relatively lightweight in comparison to full exoskeletons, and quicker to manufacture due to simpler mechanics than a full force-feedback exoskeleton which may have complex actuator assemblies. Further, the data collection system 3010 minimizes the infrastructure footprint when compared to fixed base systems and can eliminate the use of a complicated walking base simulator, numerous external wires that may restrict movement, or extensive external tracking components such as ceiling-mounted camera arrays. As a result, a large quantity of pilot movement data can be collected at a relatively low cost per hour, and this data can be used for training the robot control models (e.g., machine learning, BAM models). The portability of the apparatus 3200 also enables data collection in diverse environments, including outdoor settings, industrial facilities, and confined spaces that would be impractical for fixed motion capture installations.

### a. Computing Environment

As shown in FIG. 9, the portable data collection system 3010 includes a mobile data collection apparatus 3200, a computer 3110, a data storage database 2900, 3204, a clutch 3140, and the robot 1, which are in data communication with each other via a network 2999A-X. The mobile data collection apparatus 3200 is configured to be worn by a human operator to collect and send sensor data to be received and processed by computer 3110. The processed control data is sent from the computer 3110 to the robot 1 via the network 2999A-X for execution by the robot's control systems. The mobile data collection apparatus 3200 can communicate with the computer 3110 via the network 2999A-X. In some embodiments, the mobile data collection apparatus 3200 can communicate directly with the robot 1 via the network 2999A-X, bypassing the computer 3110 for reduced latency applications. In this embodiment, the computer 3110 may be integrated into: (i) the mobile data collection apparatus 3200 and/or (ii) robot 1.

The robot 1 includes a whole body controller (WBC) 1550 that is configured to receive and process control data derived from the mobile data collection apparatus 3200 through kinematic transformation and motion planning algorithms. The WBC 1550 also generates torque targets and current signals for selected actuators (J1-J7) for movement of the actuators (J1-J7). The WBC 1550 further collects robot data from the movement of the actuators (J1-J7) and communicates the robot data to the data storage database 3204 for later training use. The WBC 1550 of the robot 1 can communicate with the computer 3110 via the network 2999A-X to receive and process the control data that is derived from the sensor data that was obtained from the mobile data collection apparatus 3200. The WBC 1550 of the robot 1 can also communicate with the data storage database 3204 collected robot data for training a neural network model and/or running a data collection application to train a neural network.

### i. Computer

The computer 3110 may comprise, for example, a server computer, a secondary computer, or any other system providing computing capability suitable for real-time data processing. Alternatively, the computer 3110 may comprise a plurality of computing devices that may be arranged, for example, in one or more server banks or computer banks or other arrangements. Such computing devices may be located in a single installation or may be distributed among many different geographical locations for redundancy and load balancing. The computer 3110 can include technology that trains a neural network model and/or run a data collection application to train a neural network. The computer 3110 may also include the edge computing node described elsewhere herein and may serve as the computing architecture 3110 for purposes of the vertical-to-horizontal image transformation described herein.

The data collection system 3010 may also include a computer system 3110 that is designed to process the sensor data at rates of 100-1000 Hz in order to generate robot data that can be sent to the robot's whole body controller 1550 in order to allow for the mobile data collection apparatus 3200 to control the robot 1 or cause the robot 1 to mimic the movements of operator with latencies under 50 ms. In addition to performing this data generation function with computational throughputs of 1-10 GFLOPS, the computer system 3110 may perform additional functionalities associated with data collection and storage, some of which may include using filtering algorithms such as Butterworth or Chebyshev filters with cutoff frequencies of 10-100 Hz, compression algorithms achieving compression ratios of 10:1 to 100:1, or other data manipulation methods or algorithms including outlier detection and removal.

The computer system 3110 may comprise various computing architectures to perform its intended functions with appropriate performance characteristics. Examples of such architectures include a server computer with multi-core processors, a secondary computer with GPU acceleration, or any other system that provides suitable computing capability of 10-100 TFLOPS for real-time processing. In some implementations, the computer system 3110 may comprise a distributed computing environment, which incorporates a plurality of interconnected computing devices communicating through high-speed networks. These computing devices may be arranged in various configurations, such as in server banks with blade servers, computer banks with rack-mounted systems, or other suitable distributed architectures supporting horizontal scaling. The computing devices may be co-located in a single physical installation with dedicated cooling and power infrastructure, or they may be distributed across multiple geographical locations connected through wide-area networks. This architecture might be implemented as an edge compute node with processors such as NVIDIA Jetson or Intel NUC that is situated geographically close to the robot 1 and the operator in order to minimize network latency to under 5 ms. Alternatively, it could be integrated partially or wholly within the robot 1 itself using the robot's onboard computing resources or within the apparatus 3200 for latency-sensitive image transformation tasks, depending on the chosen processing architecture and power constraints. Sometimes, the computer system 3110 may be deployed on the edge, for instance, as part of the processor and computing architecture of the robot 1 with shared memory architectures. In yet other embodiments, one or more of the operations and/or processes that are performed by the computer system 3110 may be performed by processors and/or an edge computing architecture of the robot 1, thereby improving processing efficiency by 30-50% and the use of computational resources across the disclosed technology as a whole through load balancing and task distribution.

### ii. Clutch

The data collection system 3010 may include an optional clutch 3140 that is designed to allow the operator to selectively pause the transmission of robot control data from the computer 3110 to the robot 1. This robot control data is derived from sensor data, which in turn was derived from the collected human data processed through the kinematic mapping algorithms. This feature may allow the operator to reposition their hands or body to a more ergonomic or natural position without causing unintended movements of the robot 1, preventing potential collisions or task errors, before they resume operation of the mobile data collection apparatus 3200. By implementing this pause functionality with software and hardware interlocks, the system 3010 may prevent the unintended hand motions of the operator, which can occur during such repositioning over periods of 1-10 seconds, from being translated into corresponding movements of the hands 56 or other parts of the robot 1.

The operator may activate the clutch 3140, for example, by using their hand to press a button with actuation forces of 2-10 N, to temporarily suspend the transmission of the robot control data that is related to certain degrees of freedom. In some configurations, the clutch 3140 may be configured to suspend transmission for all degrees of freedom simultaneously through a master enable/disable signal. In other configurations, it may be set to suspend transmission for only a predefined subset of degrees of freedom, such as only the arm movements (suspending joints J1-J7), while leaving the head tracking active to maintain the situational awareness of the operator through continuous visual feedback. Upon the release or deactivation of the clutch 3140, the mobile data collection apparatus 3200 and the computer 3110 may resume the process of generating and transmitting the robot control data with smooth trajectory blending. The resumption of this control data transmission may be immediate with latencies under 50 ms, or it may incorporate a brief ramping period of 0.5-2 seconds to ensure the smooth re-engagement of the motion of the robot 1 using velocity and acceleration limits.

The clutch 3140 may be implemented in various physical forms, such as a button with tactile feedback, a switch with definitive positions, a trigger mechanism with proportional control, or another type of operator-actuated device that is integrated directly into the mobile data collection apparatus 3200, for example, on a hand-held component with ergonomic placement or on the main body of the mobile data collection apparatus 3200 within easy reach. This integration may allow the operator to selectively engage and disengage the clutch 3140 with one or both hands as appropriate during the performance of a task. For instance, a pressure-sensitive grip on a handheld controller with force thresholds of 5-20 N could be configured to function as the clutch 3140, disengaging control whenever the operator relaxes their grip below the threshold.

In alternative embodiments, the clutch 3140 may be implemented as a separate, discrete device with wireless or wired connectivity. For example, the clutch 3140 could take the form of a foot pedal with adjustable resistance that is coupled to the computer 3110 and positioned on the floor for foot activation by the operator, or it could be made accessible to another supervising operator through a control panel. A supervising operator might utilize such a separate clutch 3140 to intervene in the operation for safety with emergency stop capabilities or for training purposes during skill transfer sessions. Alternative methods for clutch activation could involve the use of voice commands that are recognized by the system 3010 with recognition accuracies above 95%, gesture recognition that is performed using the sensors 3208 on the apparatus 3200 with gesture libraries of 10-50 commands, or even a predictive clutch engagement system using machine learning models. For example, a specific spoken phrase like “Pause robot” processed through speech recognition could activate the clutch 3140, and the phrase “Resume robot” could deactivate it with voice activation latencies under 500 ms.

Predictive engagement of the clutch 3140 might function based on detecting movement patterns that are indicative of non-task-related actions through anomaly detection algorithms, for example, large, rapid repositioning movements of the operator that fall outside the typical workspace (exceeding 1 meter) or velocity profile (exceeding 2 m/s) of the task being performed. A software-based clutch interface, which could be presented on the display 3150 or on an auxiliary screen with touch or gaze interaction, could also allow for activation through gaze control with dwell times of 0.5-2 seconds or through interaction with a tracked controller that is associated with the VR headset. The display 3150 could present a virtual button with visual feedback that the operator selects either via gaze dwell time or by pointing at it with a controller tracked at 90-120 Hz.

The clutch 3140, whether it is implemented as a physical or a virtual device, may incorporate advanced haptic feedback technologies providing multi-modal sensory confirmation. This haptic feedback could provide the operator with a tactile confirmation, such as a click with forces of 2-5 N, a vibration at frequencies of 100-300 Hz, or a change in resistance from 10 N to 30 N, that indicates the successful engagement and disengagement of the clutch 3140. Such feedback enhances the confidence of the operator and improves the overall usability of the system 3010 with user satisfaction scores improving by 15-25%. Additionally, the system 3010 may implement an intelligent clutch behavior, which could be managed by a dedicated intelligent clutch module running at 100-500 Hz. This intelligent clutch module might use machine learning algorithms trained on datasets of 103 to 105 operator interactions to analyze the movements of the operator and the current task context, thereby learning to predict and automatically engage the clutch 3140 during natural pauses lasting 2-10 seconds or transitions in the operator's workflow. This would further enhance the ergonomics and usability of the mobile data collection apparatus 3200, reducing operator fatigue by 20-30%. For example, if the system 3010 detects that the operator is looking away from the primary task area for an extended period exceeding 3 seconds, the intelligent clutch module might infer that a pause is intended and automatically engage the clutch 3140 with predictive accuracies above 90%.

In some embodiments, the clutch 3140 may support selective per-degree-of-freedom disengagement, such that a subset of robot joints J1 through J7 is suspended while a head-tracking channel remains active and a visual feedback path from the vertical arrangement of cameras 108.2.2, 108.2.4 to the VR headset 3152 is maintained throughout clutch engagement. This preservation of the visual feedback path during clutch engagement may allow the operator to reposition their arms or body while continuing to observe the robot's environment through the VR headset 3152, thereby avoiding disorientation during the clutch interval. In further embodiments, the clutch 3140 may be coupled to a clutch-engagement signal processed by the piloting control system 3202, and the piloting control system 3202 may log the clutch-engagement intervals into the training-data store alongside the associated sensor measurements and robot control commands.

### iii. Display

The portable data collection system 3010 may include a display 3150 that provides visual feedback to the operator from the robot 1 and/or from the operator's viewpoint with refresh rates of 60-144 Hz and resolutions from Full HD to 8K. To provide this visual feedback with minimal latency, the display 3150 can be incorporated into one or more types of devices, including but not limited to: standard computer monitors that use technologies like liquid crystal display (LCD) with response times of 1-5 ms, organic light-emitting diode (OLED) with infinite contrast ratios, microLED with brightness exceeding 1000 nits, or quantum dot displays with color gamuts covering 100% of DCI-P3; virtual reality (VR) or augmented reality (AR) headsets (e.g., Sony PlayStation VR with 120 Hz refresh rate, the HTC Vive with 2K per eye resolution, the Apple Vision Pro with micro-OLED displays, and the Meta Quest series with inside-out tracking), which may function as the headset device; and other head-mounted display (HMD) configurations, including those where a mobile device is positioned within a headset frame (e.g., Google Cardboard-style viewers supporting phones with 5-7 inch displays, Merge VR Goggles with adjustable lenses, Carl Zeiss VR One Plus with 100-degree field of view, Xiaomi Play2 with focus adjustment, and similar models, as well as projected displays with lumens ratings of 3000-10000). A headset device may include a head position sensor, such as an internal IMU, configured to determine a position of a head of the operator and provide head positional data to the piloting control system.

In some embodiments, the display 3150 may be alternatively implemented using technologies such as transparent displays with 50-80% transparency, holographic projectors creating 3D images without glasses, electronic ink (e-ink) panels with power consumption under 10 mW, laser projection systems with 4K resolution, multi-panel display arrays creating wrap-around views, curved monitors with 1000R-1800R curvature, flexible displays that can be rolled or folded, retinal projection systems directly imaging onto the retina, and/or any other known display or display system technology that is suitable for presenting the visual feed of the robot 1. Projection mapping systems with 10,000+ lumens could serve as an alternative for the display 3150, projecting the view of the robot 1 or related information onto surfaces within the environment of the operator, an approach which offers a different form of immersion or situational awareness when compared to head-mounted displays.

In some embodiments, the display 3150 may further include advanced optical components with specific optical characteristics. Examples of such components include Fresnel lenses with focal lengths of 40-50 mm, pancake lenses reducing thickness by 50%, waveguide optics with efficiency above 85%, or diffractive optical elements with sub-wavelength features, which can be used, particularly in HMDs, to enhance visual clarity to 20/20 vision equivalent, widen the field of view to 110-200 degrees, and minimize optical distortion to less than 2% across the field in augmented and virtual reality environments. Additional implementations may integrate adaptive optics that are capable of adjusting their focal lengths in real-time from 0.5 to 3 meters, in order to accommodate the specific vision conditions of the operator or to simulate focus changes that correspond to the sensor focus of the robot 1. Tunable polarization filters with extinction ratios of 1000:1 might also be included to improve contrast and reduce glare under the varying environmental lighting conditions from 10 to 100,000 lux that are reported by the robot 1.

Furthermore, high-refresh-rate displays, such as those operating at 120 Hz, 144 Hz, 240 Hz or higher, may be utilized in conjunction with motion prediction algorithms predicting 16-33 ms ahead to further reduce the perceived latency to under 20 ms and improve the real-time responsiveness of the visual feedback. Variable Refresh Rate (VRR) technologies supporting ranges of 48-144 Hz, adapted for VR use cases, could also help to smooth the visual performance by allowing the display 3150 refresh rate to synchronize with the rendering rate of the graphics pipeline, although fixed high refresh rates combined with latency compensation techniques like Asynchronous Timewarp (ATW) reducing latency by 20-40 ms and ASW maintaining smooth motion at 45 fps input are common strategies in VR. VRR can reduce screen tearing and stutter by 90%. These collective enhancements all contribute to creating a more immersive and accurate visual representation of the operational environment of the humanoid robot 1 for the operator with presence scores above 4.5 on a 5-point scale. The overall goal is to achieve a seamless and realistic operator experience with motion-to-photon latencies under 20 ms.

In order to transform visual data that is received from the robot 1, which may be captured in a vertical stereo vision format using vertically separated cameras with baselines of 50-200 mm, into a horizontally oriented stereo image that is suitable for human viewing (e.g., a VR headset with horizontal IPD of 58-72 mm), specialized software methods may be implemented achieving transformation latencies under 10 ms. These methods may include geometric rectification using homography transformations with 3×3 matrices, disparity re-projection techniques maintaining depth accuracy within 1%, convolutional neural networks (CNNs) with 10⁶ to 10⁸ parameters specifically trained for stereo image conversion tasks, and adaptive warping techniques with per-pixel displacement maps. Algorithms such as those that are based on epipolar geometry transformation can be applied to remap the vertically aligned depth or image data into a horizontal stereo pair while attempting to maintain accurate depth perception for the viewer with depth estimation errors under 5%. This category of methods broadly covers various view synthesis and image rectification techniques, such as Depth Image Based Rendering (DIBR) with depth map resolutions of 1080p, Neural Radiance Fields (NeRF) with 105 to 10⁶ sample rays, 3D Gaussian Splatting (3DGS) with 104 to 10⁶ Gaussians, Multi-Plane Images (MPI) with 32-128 depth planes, or direct learned transformations that are executed on the appropriate processing hardware capable of 1-10 TFLOPS, which could be located on the robot 1, on an edge computer 3110, or distributed between them with task allocation based on available compute.

Alternative transformation methods may involve the use of light field rendering techniques with 5×5 to 15×15 view arrays, where the system captures or synthesizes a richer representation of the light rays in the scene. This allows for view generation from different perspectives with angular resolution of 0.5-2 degrees, which can offer more comfortable viewing experiences or enable features like variable focus from 30 cm to infinity. The choice between these different transformation methods may involve trade-offs concerning computational cost (GFLOPS used), the quality of the output image (PSNR above 30 dB), the amount of introduced latency (target under 10 ms), and the robustness of the method to different scene types or camera configurations. Additionally, interpolation methods that use optical flow estimation with sub-pixel accuracy can further enhance the alignment between the transformed left and right eye images in order to reduce visual distortion to under 1% and provide a more natural viewing experience for the operator. Optical flow information can also be utilized in techniques like Asynchronous Spacewarp (ASW) or similar frame interpolation methods generating intermediate frames at 90-120 Hz. These methods can be used to synthesize intermediate frames when the system cannot consistently maintain the target frame rate of the display 3150, thereby improving the perceived smoothness of the motion by maintaining apparent frame rates above 90 fps.

The display 3150 and/or the portable data collection system 3010 may also include capabilities for integrating additional sensor modalities to provide an enriched interaction experience for the operator with multi-modal feedback improving task performance by 15-30%. Multi-modal interaction serves to enhance the level of control precision and situational awareness. These modalities may include eye-tracking sensors with accuracies of 0.5-1 degree and sampling rates of 120-250 Hz, gesture recognition systems which may use cameras or other sensors detecting 20-50 distinct gestures, capacitive or resistive touch interfaces with response times under 10 ms which may be on associated controllers or on the display 3150 itself, voice control systems with vocabulary sizes of 1000-10000 words, or biometric sensors like heart rate monitors (30-250 BPM) or galvanic skin response sensors (0.01-100 μS) providing physiological feedback. These additional sensors provide alternative input channels for the operator with recognition accuracies above 95%.

Eye-tracking technology that is integrated into a VR headset is particularly relevant in this context with calibration times under 30 seconds. Eye-tracking has several applications in VR enhancing both performance and user experience. It enables gaze-contingent rendering, which involves rendering higher detail only in the area where the operator is currently looking (typically 20-30 degrees), and it also enables foveated encoding, which involves compressing the video stream more aggressively in the peripheral vision areas with compression ratios of 10:1. These techniques serve to optimize both rendering performance and bandwidth usage by 40-60%. Both of these techniques can significantly reduce the computational load and the network bandwidth demand for rendering and transmitting the high-resolution video stream from the robot 1. The resulting efficiency gains are substantial, enabling higher resolution displays or reduced hardware demand.

Furthermore, other sensor modalities, beyond those related to the interaction of the operator, may be incorporated to enhance the ability of the display 3150 to interpret and present the perception of the robot 1 of its surroundings with enhanced environmental awareness. These may include depth-sensing cameras that provide depth maps with 1-10 mm accuracy at 30-60 fps, infrared sensors for enhanced vision in low-light conditions down to 0.001 lux, electromagnetic motion tracking systems for providing precise positional awareness of tracked objects or controllers with sub-millimeter accuracy, environmental microphones that are integrated into the display 3150 device for spatial audio processing with 360-degree sound localization, thermal imaging sensors for detecting heat signatures, and/or any other sensors that are disclosed elsewhere herein as being part of the robot 1 or the system 3010.

Integrating spatial audio rendering with 7.1 or Atmos support, which is synchronized accurately with the visual feed presented on the display 3150 with audio-visual sync within 40 ms, can further enhance the immersion and situational awareness of the operator for teleoperation tasks improving task completion rates by 10-20%. Haptic feedback mechanisms that are integrated into the display 3150 device or its associated controllers, such as vibrating motors operating at 20-1000 Hz or force feedback elements providing up to 40N, could provide tactile cues that correspond to events in the environment of the robot 1 or provide feedback related to the actions of robot 1, thereby complementing the visual and audio information with response times under 20 ms.

Separate and apart from the calibration procedures for the mobile data collection apparatus 3200, the display 3150 itself may also utilize its own calibration procedures using 2-5 minutes. These procedures, which may employ image processing techniques and corrective transformation matrices updated at 60-120 Hz, may be implemented to ensure color accuracy within ΔE<2, geometric fidelity with distortion under 1%, and depth perception consistency within 5% in the visuals that are presented to the operator. These display calibrations may include machine learning-based error correction algorithms with neural networks of 104 to 10⁶ parameters that dynamically adjust for image distortions based on real-time feedback or the known hardware characteristics of the display 3150. This can help to compensate for issues like lens aberrations in HMDs (typically 1-5% distortion), motion blur effects with 1-10 ms persistence, and to adapt to the different environmental lighting conditions from 10 to 100,000 lux that are being experienced by the robot 1.

The calibration processes might utilize standardized reference targets, such as color checker patterns with 24 color patches that are viewed by the cameras of the robot 1, structured light scans of known geometries with patterns projected at 30-120 Hz, or pre-computed depth maps with resolutions matching the display, in order to derive calibration equations or lookup tables that are able to mitigate distortion and ensure visual consistency across varying operational conditions with calibration accuracies better than 1%. Operator-specific calibration profiles for the operator could also be stored and applied, which would account for individual operator preferences or visual characteristics, such as their interpupillary distance (IPD) ranging from 52-78 mm. This Personalization improves both comfort reducing eye strain by 30-50% and accuracy for the operator improving depth perception accuracy by 10-20%.

Ensuring an accurate calibration between the cameras of the robot 1, including their intrinsic parameters like focal length (typically 3-50 mm) and distortion coefficients (k1, k2, p1, p2, k3), and their extrinsic parameters like their relative position (accurate to 1 mm) and orientation (accurate to 0.1 degrees), especially the vertical baseline separation if applicable (typically 50-200 mm), and then correctly mapping the resulting stereo view to the measured IPD of the operator in the VR headset is an integral process. This accurate mapping helps to provide a comfortable and accurate stereoscopic viewing experience with vergence-accommodation conflicts minimized, preventing eye strain for the operator during sessions lasting 2-8 hours and avoiding misperceptions of depth or scale in the presented view with depth accuracy maintained within 5%. Furthermore, advanced computational imaging techniques, such as multi-view stereo reconstruction using 2-8 camera views, photometric calibration to ensure consistent brightness and color response across 0.1-100,000 lux, and adaptive exposure correction algorithms with dynamic ranges of 120 dB, may be employed on the image data before it is displayed, in order to enhance the accuracy and reliability of the visual data being presented. Real-time optimization algorithms running at 60-120 Hz may also be implemented to compensate for minor discrepancies in the stereo vision alignment that might occur during operation, which ensures that the depth information remains reasonably accurate within 2-3% error and dynamically responsive to any environmental changes. Techniques for online camera calibration updating every 10-60 seconds or adaptive rectification with sub-pixel accuracy could also be employed for this purpose. These techniques could be configured to run periodically or continuously to maintain the alignment accuracy within 1-2 pixels, even if minor mechanical shifts occur in the camera rig of robot 1 over time due to factors such as vibration at 10-100 Hz or temperature changes of ±20 °C.

Operationally, the display 3150 can be physically configured in multiple ways to accommodate different use cases and operator preferences. It might be designed to be worn by the operator with head strap tensions of 10-30N, as is the case with an HMD weighing 300-800 grams, it might be mounted directly on the mobile data collection apparatus 3200 at eye level, or it could be positioned in a stationary manner, like a desktop monitor at viewing distances of 50-100 cm, in front of the operator during the operation of the apparatus 3200. Additionally and/or alternatively, the display 3150 system or the broader portable data collection system 3010 may include the capability to process image data through real-time rendering engines achieving 60-120 fps and sensor fusion algorithms with latencies under 5 ms. These algorithms are designed to integrate inputs from various sensors, including inertial measurement units (IMUs) that are located within the display 3150 device itself with update rates of 500-1000 Hz, LiDAR sensors on the robot 1 with 300,000-2,000,000 points per second, infrared depth cameras on the robot 1 operating at 30-90 fps, electromagnetic motion tracking systems with update rates of 240-360 Hz, environmental microphones for spatial audio processing with 48-192 kHz sampling, and other vision-based tracking systems, such as SLAM running on the headset cameras achieving 6-DOF tracking. Specifically for a VR headset implementation of the display 3150, the rendering engine may use inputs from the headset's own IMU updating at 1000 Hz and its tracking system, which could be, for example, inside-out tracking using the headset's cameras with 4-6 cameras or outside-in tracking using external sensors with sub-millimeter precision.

Additionally or alternatively, the display 3150 may include capabilities to provide augmented reality (AR) overlays with registration accuracies of 1-5 mm. These overlays would utilize environmental mapping techniques, such as simultaneous localization and mapping (SLAM) algorithms processing 30-60 fps, which could run either on the robot 1 or on the AR display device itself with dedicated processors. This would enable the dynamic alignment of virtual information or graphics with the view of the operator of their physical surroundings with update rates of 60-90 Hz, as seen either directly or through the cameras of the robot 1. Further, machine learning-based predictive tracking algorithms with prediction horizons of 20-100 ms may be implemented to anticipate the head movements of the operator more accurately and preemptively begin rendering the corresponding visuals, which further contributes to the reduction of perceived latency by 30-50%.

Moreover, the display 3150 system may also include features like diagnostic modes showing system metrics updated at 10-30 Hz, which could show raw sensor data or system status, playback functionalities for reviewing recorded sessions at variable speeds from 0.25× to 4×, or immersive simulation modes for training or testing with physics simulations at 1000 Hz. In these modes, latency minimization may be achieved through techniques such as variable refresh rate (VRR) supporting 48-240 Hz and adaptive sync technologies with response times under 1 ms, which help to ensure that the effective frame update interval remains consistent even under rapid motion conditions exceeding 180 degrees/second, although techniques like ATW/ASW are generally considered for maintaining smooth visual perception during frame rate fluctuations in VR environments. Ensuring low latency under 20 ms and smooth visuals above 90 fps is a constant focus of the system design achieving user comfort ratings above 4/5. For instance, an alternative diagnostic mode may overlay the predicted trajectories or planned paths of the robot 1 onto the view of the operator with trajectory updates at 30 Hz, which would allow for an intuitive assessment of the intentions of the robot 1. The Playback functionalities may also incorporate the synchronized playback of multiple sensor data streams alongside the visual feed with synchronization accuracy within 1 ms, a feature which facilitates a detailed post-session analysis of the performance of both the robot 1 and the inputs of the operator with analysis tools supporting frame-by-frame review.

### b. Display-Side Latency Compensation Stack

In some embodiments, the VR headset 3152 (embodied as a head-mounted display implementation of the display 3150) comprises an asynchronous time warp module configured to reproject each received stereoscopic frame to a current head-pose estimate at a display-refresh instant, the asynchronous time warp module operating with a prediction window of 20 ms calibrated to a measured end-to-end system latency through a closed-loop control mechanism. The VR headset 3152 further comprises an asynchronous space warp module configured to synthesize intermediate frames responsive to a frame arrival rate falling below 45 frames per second, a phase-synchronization module aligning frame reprojection to a vertical blanking interval of the display, and a low-persistence display panel operating at a duty cycle below 30%. The asynchronous time warp prediction window, the asynchronous space warp threshold, the phase-synchronization module, and the low-persistence panel collectively form a display-side latency compensation stack that preserves perceived motion continuity across transient variations in the upstream synthesis and transport stages. In one embodiment, the closed-loop control mechanism comprises a proportional-integral-derivative controller that regulates the asynchronous time warp prediction window based on the measured end-to-end system latency.

The asynchronous time warp module operates on stereoscopic frames produced by the neural view synthesis module of the edge computing node from the vertical arrangement of cameras 108.2.2, 108.2.4, such that the reprojection is applied to frames derived from camera imagery transformed from the vertical-baseline capture frame to a horizontal stereoscopic viewport. The asynchronous time warp prediction window of 20 ms is selected because this window corresponds to the median interval between a head-pose measurement at the VR headset 3152 and the display-refresh instant at which the reprojected frame appears, such that the residual head-motion prediction error at the display instant remains within sub-pixel bounds at the viewport resolution. The closed-loop proportional-integral-derivative controller adjusts the 20 ms window responsive to variations in the measured end-to-end system latency, maintaining the residual prediction error within bounds across operating conditions. In alternative embodiments, the asynchronous time warp module may operate with prediction windows of approximately 10 ms, 30 ms, or 50 ms, with the selected window value being determined based on the characteristics of the transport path and the display refresh rate.

### i. Data Storage

The data storage database 3204 collects and stores robot data generated by the actuators (J1-J7) for subsequent training and analysis purposes. The robot data collected and stored by the data storage database 3204 can be filtered, labeled, refined, and/or modified to generate training data that can be used for training of networks that will run on one or more robots 1. The data storage database 3204 may be a server, a hard drive, a computer, or other device or devices suitable to collect and store data with sufficient capacity and throughput. Similar to the discussion regarding the location of the computer 3110, the data store 3204 may be local to the robot 1 with direct bus connections, the mobile data collection apparatus 3200 (e.g., integrated with piloting control system 3202), or the computer 3110 with high-speed interfaces. In other examples, the data store 3204 may not be local and instead may be remote relative to one or more of the robot 1, the mobile data collection apparatus 3200, or the computer 3110, connected through network links with appropriate bandwidth and reliability.

### c. Wearable Data Collection Apparatus

As best shown in FIGS. 9-11, the mobile data collection apparatus 3200 includes (i) a base mount 3240, (ii) left and right articulated arms 3300 pivotably attached to the base mount 3240, (iii) a wrist assembly 3370 coupled to each articulated arm 3300, (iv) a glove 3400 coupled to the wrist assembly 3370 via a glove mount 3394, and (v) an apparatus electronics assembly 3201. The apparatus electronics assembly 3201 includes a piloting control system 3202, data storage 3204, a battery 3206, a plurality of sensors 3208, and other circuitry 3209. The mobile data collection apparatus 3200 is configured to be worn by a human operator to perform data collection tasks. The operator wears the mobile data collection apparatus 3200 on the back and secures it in position using the adjustable harness 3270. The operator also wears the gloves 3400 on each hand to capture fine motor movements of the fingers and thumbs. The articulated arms 3300 are configured to move with the arms of the operator wearing the mobile data collection apparatus 3200 as the operator performs data collection tasks, where a plurality of sensors 3208 capture the position, orientation, and/or pitch of the operator's wrists and hands.

The sensors 3208 coupled to the mobile data collection apparatus 3200 include encoders 3211, 3212, 3213, IMUs 3220 and 3224, and hand sensors 3410. The encoders 3211-3213 are fixed to respective rigid frame links 3310-3312 to measure the rotational and positional movement of each rigid frame link. A torso IMU 3224 may be coupled to the base mount 3240 and wrist IMUs 3220 may be coupled to the glove mount 3394, or optionally the glove 3400, to provide information regarding the pitch and orientation of the operator's wrist. The gloves 3400 provide additional positional information for the fingers and thumbs of the operator. The pilot movement data is collected by the piloting control system 3202 as the operator performs tasks. The collected pilot movement data is processed by the piloting control system 3202 and/or computer 3110 to provide robot control data to the robot 1 via the network 2999A-X to be processed by the WBC 1550 of the robot 1. The WBC 1550 utilizes the robot control data to control the actuators 1.2.4 of the robot 1 to replicate the operator's movements and sensor data from the robot 1 is collected as training data as the robot 1 performs the task.

In some embodiments, the wrist IMUs 3220, the torso IMU 3224, and a population of inertial measurement units (IMUs) located on the humanoid robot 1 are selected from a common sensor technology, such that each IMU in the operator-side and robot-side populations exhibits substantially matched noise characteristics, bias stability, and axis alignment. In one embodiment, each IMU comprises a device of a common part specification, for example, a Bosch BMI088 or an InvenSense ICM-42688. The common sensor technology is selected because a cross-platform mapping from operator motion to robot motion then resolves to an identity-plus-calibration transformation, which may yield a bounded latency contribution in the control loop and a bounded accumulated drift across extended teleoperation sessions. The significance of the shared sensor specification is that sensor-level noise and bias characteristics propagate identically through the operator-side and robot-side signal chains, permitting a single calibration to span both platforms.

The wearable apparatus 3200, the humanoid robot 1, and a training-data logging module may cooperate to generate paired operator-command and robot-response records suitable for training an imitation-learning or behavior-cloning controller. The wearable apparatus 3200 contributes high-rate operator kinematic data from the joint encoders 3211-3213, the wrist IMUs 3220 and torso IMU 3224, and the instrumented gloves 3400; the humanoid robot 1 contributes high-rate joint-state, torque, and contact-sensor data; and the training-data logging module contributes timestamped alignment of the two data streams via an IEEE 1588 Precision Time Protocol (PTP) clock shared between the wearable apparatus 3200 and the humanoid robot 1. Together, these elements yield a training dataset in which each operator motion segment is paired with the robot's physically-executed response segment to sub-microsecond temporal alignment, because the shared clock bounds the inter-platform timestamp offset within the sensor sampling intervals. In one embodiment, the training-data logging module records continuously at sensor-native rates and segments recordings into task-bounded episodes.

### i. Sensors of the Apparatus

The mobile data collection apparatus 3200 can include a plurality of sensors 3208 and other circuitry 3209 for signal conditioning and data processing. The plurality of sensors 3208 include encoders 3211-3213 (e.g., actuator encoders), wrist inertial measurement units (IMUs) 3220 and a torso IMU 3224, and hand position sensors 3410. The mobile data collection apparatus 3200 may also include additional sensors (e.g., IMU, GPS, etc.) to capture other sensor data while the operator is performing data collection tasks while wearing the apparatus 3200. The mobile data collection apparatus 3200 is designed to collect sensor data and communicate the position of one or more of the operator's wrists relative to their torso through the kinematic chain. The IMUs 3220, 3224 may include one or more accelerometers, gyroscopes, and one or more magnetometers to provide complete 9-axis motion sensing.

The apparatus 3200 may include a comprehensive array of sensors 3208 providing multi-modal data capture capabilities for robust tracking. In addition to the encoders 3211-3213 (e.g., optical encoders with resolutions of 12-16 bits or magnetic encoders with absolute position capabilities) located at the joints of the articulated arms 3300 and hand position sensors 3410 in the gloves 3400, the apparatus 3200 may include accelerometers with ranges of 2 g to ±16 g, gyroscopes with ranges of 250 to ±2000 degrees/second, and inertial measurement units (IMUs) combining both sensor types with additional magnetometers. In some embodiments, the accelerometers and gyroscopes in the IMUs 3220, 3224 may exhibit noise density of approximately 0.05 degrees per second per root Hertz for the gyroscope and approximately 150 micro-g per root Hertz for the accelerometer, with bias stability of approximately 2 degrees per hour for the gyroscope and approximately 40 micro-g for the accelerometer. The axis alignment accuracy of the IMUs 3220, 3224 may be approximately 0.1 degrees per axis upon factory calibration.

The torso IMU 3224 may be located on base mount 3240 to measure the relative position of the operator's (H) torso and may provide or establish a distance from the ground or a support surface using barometric pressure sensors with altitude resolutions of 10-50 cm. For example, the torso IMU 3224 may be coupled separately or included in electronics and other circuitry 3209 coupled with the piloting control system 3202 on the base mount 3240, maintaining thermal isolation from heat-generating components to prevent temperature-induced measurement drift. Additional IMUs 3220 may be positioned at a distal portion of the articulated arms 3300 (e.g., the glove mount 3394 and/or glove 3400) to measure the relative position of the operator's (H) wrist with 6-DOF tracking capabilities. Further, the torso IMU 3224 may be used to determine the orientation of the operator's torso with accuracies better than 1 degree and establish a reference point for the wrist IMUs 3220 through coordinate transformation matrices. In some cases, the sensor data collected from IMUs 3220 positioned at the wrist of the operator from the apparatus 3200 for wrist pose estimation might rely on the change in position and orientation as determined from the IMUs 3220 and/or other sensors 3208 used for minimizing drift through zero-velocity updates and magnetic heading correction, which is then fused with the kinematic chain data derived from the encoders 3211-3213 at the joints 3313-3315 of the articulated arms 3300 using extended Kalman filtering or complementary filtering approaches.

Advantageously, these sensors 3208 are an integral part of the structure of the apparatus 3200 and are not placed manually by the human operator or other operators each time the device is used, ensuring consistent sensor placement within 1-2 mm across sessions. This fixed placement methodology eliminates the variability that can arise due to the misplacement of sensors 3208 by the operator and reduces substantial changes in relative sensor locations between different operators or different sessions, thereby aiding in the consistency and reliability of the collected data with repeatability better than 95%. In further embodiments, the fixed sensor placement may also simplify the calibration of the apparatus 3200 by allowing a single set of calibration parameters to be applied across multiple operators. In yet further embodiments, the fixed sensor placement may be augmented with per-operator calibration to account for differences in limb length and body geometry.

Moreover, in some embodiments, the sensors 3208 utilized in the apparatus 3200 may employ the same or similar underlying sensor technology as the sensor technology used in the corresponding parts of the robot 1, maintaining measurement consistency across platforms for simplified data processing. This could include, for example, using specific types of optical encoders (e.g., encoders 3211-3213) with identical line counts and interpolation factors or the exact same model of IMU chip such as the Bosch BMI088 or InvenSense ICM-42688 in both the apparatus 3200 and the robot 1. The use of such similar or identical sensor technology provides a technical advantage by reducing or eliminating the step of performing complex translation, manipulation, or alteration of the sensor data collected from the apparatus 3200, reducing computational overhead by 50-70%. As a result, this data can be more directly and meaningfully used to control the robot 1 or to serve as high-quality training data with minimal preprocessing demand. Additionally, using the same or similar sensor technology can help to mitigate problems that are commonly associated with comparing data from sensors 3208 that exhibit different drift characteristics (typically 0.1-1 degree/hour for gyroscopes), noise profiles (with noise densities of 0.01-0.1 degrees/second/√Hz), or sensitivities to various environmental factors such as temperature coefficients of 0.01-0.05%/°C. In particular, when subjecting two significantly different sensor technologies (e.g., an IMU vs. an optical encoder, or two IMU models from different manufacturers with different Allan variance characteristics) to the same environmental noise sources (e.g., electromagnetic interference (EMI) noise commonly found on a factory floor with field strengths of 1-10 V/m, or mechanical vibrations at frequencies of 10-1000 Hz), the resulting drift or noise patterns associated with these different sensor technologies might be sufficiently different that combining or comparing their data becomes a significant challenge, potentially rendering the collected human data less usable for direct robot control or for imitation learning without extensive calibration and compensation. Thus, the disclosed apparatus 3200, by using the same sensor technology and sometimes even the exact same sensor components as the robot 1 for corresponding measurements (like joint angles), aims to overcome some of these long-standing challenges in cross-platform data consistency.

In addition to these specifically mentioned sensors 3208, the mobile data collection apparatus 3200 may incorporate a variety of additional sensors 3208, or it may obtain data from other external sensors (such as those found in a VR system), to enhance the quality of data collection and to improve the accuracy of training or control with sensor fusion improving overall system accuracy by 20-40%. For clarity, These additional sensors 3208 may be grouped by category:
Motion and Position: This category includes accelerometers with measurement ranges from ±2 g to ±200 g and bandwidths up to 5 kHz, gyroscopes with drift rates better than 10 degrees/hour, and magnetometers with resolutions of 1-10 nT (which are often combined within IMU packages 3220, 3224), flex sensors for measuring bending with resistance changes of 10-100% over their range, GPS modules for absolute outdoor positioning with accuracies of 1-10 meters, 3D cameras or depth sensors for tracking limb position relative to the body or the environment with depth resolutions of 1-10 mm, optical encoders (such as 3211-3213) with resolutions up to 20 bits, tilt sensors with accuracies of 0.01-0.1 degrees, inclinometers with measurement ranges of 180 degrees, absolute or relative position sensors with resolutions down to nanometers, velocity sensors measuring speeds from 0.01-100 m/s, displacement sensors with ranges from micrometers to meters, vibration sensors detecting frequencies from 0.1 Hz to 10 kHz, angular rate sensors, linear accelerometers, rotary encoders, potentiometers for measuring rotation angle with linearities better than 0.1%, vision-based tracking systems that use markers placed on the operator or apparatus 3200 viewed by external cameras achieving sub-millimeter tracking accuracy, or Ultra-Wideband (UWB) tags for achieving precise relative positioning with accuracies of 10-30 cm.
Biometric: This category includes Electromyography (EMG) sensors for measuring muscle electrical activity with signal amplitudes of 50 V to 30 mV, which can be used for control input or for fatigue monitoring, and eye-tracking sensors with gaze accuracies of 0.5-1 degree, which may be integrated into the apparatus 3200. Other biometric sensors such as Electroencephalography (EEG) for brain activity monitoring with 8-256 channels, Galvanic Skin Response (GSR) for stress levels detecting conductance changes of 0.01-100 μS, or heart rate monitors measuring 30-250 BPM could also be integrated into or interfaced with the system. Skin temperature sensors with accuracies of 0.1-0.5 °C may also be included to monitor the physiological state of the operator.
Environmental: This category includes acoustic sensors such as microphones with frequency responses from 20 Hz to 20 kHz, which can be used for voice commands or for ambient noise awareness, proximity sensors for detecting nearby objects at ranges of 1 mm to 10m, temperature sensors with ranges from −40 °C to +125 °C, barometric pressure sensors with resolutions of 0.1 Pa, humidity sensors measuring 0-100% RH, and ambient light sensors detecting 0.01-100,000 lux.
Force and Pressure: This category includes force-sensitive resistors (FSRs) with force ranges of 0.1-100N, pressure sensors for measuring applied pressure over an area from 1-1000 kPa, piezoelectric sensors that generate voltages of 1-1000V under stress, piezoresistive sensors that change resistance by 1-10% under stress, strain gauges for measuring deformation with gauge factors of 2-200, load cells for measuring force, torque sensors (which include types like strain gauge-based with accuracies of 0.1-1%, piezoresistive with response times under 1 ms, magnetoelastic with non-contact measurement, capacitive with resolutions of 0.01%, fiber-optic with immunity to EMI, and rotary transformers for continuous rotation), tactile sensor arrays that provide distributed pressure information similar to artificial skin with spatial resolutions of 1-5 mm, shear force sensors measuring tangential forces of 0.01-100N, bending moment sensors, compression sensors, tension sensors, and impact sensors detecting accelerations up to 10,000 g.
Other: A wide variety of other sensor types might be included based on specific application needs. These can include photodiodes for light detection with spectral responses from UV to IR, Hall effect sensors for magnetic field detection with sensitivities of 1-100 mV/mT, capacitive sensors for proximity or touch detection with sensing distances of 0-50 mm, inductive sensors for metal detection or positioning with ranges of 0.5-80 mm, ultrasonic sensors for distance measurement with ranges of 2 cm to 10 m, thermal sensors for non-contact temperature measurement from −70 °C to +380 °C, radar sensors operating at 24-77 GHz, or LiDAR sensors with range resolutions of 1-5 cm, though the latter are less common on a apparatus 3200 compared to their use on robots.

It should be understood that other similar sensors or sensor technologies, including emerging sensor types not listed here such as quantum sensors or neuromorphic sensors, may be utilized by the mobile data collection apparatus 3200. This includes sensor types or specific sensor technologies that might be disclosed in other sections of this application or are otherwise known in the art. Sensor fusion strategies that are specific to the apparatus 3200, employing algorithms such as complementary filters with time constants of 0.5-5 seconds, Kalman filters (including variants like the EKF with 15-30 state variables or UKF with sigma point selections), or machine learning-based approaches using neural networks with 103 to 10⁶ parameters, may be implemented within the piloting control system 3202 or the computer 3110. The goal of these strategies is to combine data from multiple sensors 3208 in an effective manner, aiming to achieve more accurate and robust estimates of the pose, motion, and intent of the operator with position accuracies better than 5 mm and orientation accuracies better than 2 degrees.

In addition to the sensors already mentioned, the mobile data collection apparatus 3200 may incorporate additional sensors to enhance data collection and improve training accuracy. These may include:
Electromyography (EMG) Sensors (e.g., Delsys Trigno Wireless EMG System, Advancer Technologies MyoWare Muscle Sensor, Otto Bock MyoBock System)
Force-Sensitive Resistors (FSR) or Pressure Sensors (e.g., Interlink Electronics FSR 400 Series, Tekscan FlexiForce Sensors, Honeywell FSS-SMT Series Force Sensors)
Haptic Feedback Devices (e.g., Precision Microdrives Vibration Motors, Tactile Labs Haptics Actuators, Ultrahaptics (Ultraleap))
Flex Sensors (e.g., Spectra Symbol Flex Sensor, Adafruit Flex Sensor, Flexpoint Bend Sensors)
Acoustic Sensors (e.g., Knowles MEMS Microphones (e.g., SPH0645LM4H-B), Audio Analytic's ai3 Acoustic Sensor, MaxBotix MB1000 LV-MaxSonar-EZ1)
Eye-Tracking Sensors (e.g., Tobii Eye Trackers, Pupil Labs Eye Tracking Headsets, SR Research EyeLink Systems)
Proximity Sensors (e.g., Sharp GP2Y0A21YKOF Infrared Proximity Sensor, STMicroelectronics VL53LOX ToF Sensor, Pepperl+Fuchs Ultrasonic Proximity Sensors)
GPS Modules (e.g., u-blox NEO-M8N GPS Module, Adafruit Ultimate GPS Breakout v3, SparkFun GPS Dead Reckoning Breakout (NEO-M8U))
Temperature Sensors (e.g., Maxim Integrated DS18B20, Texas Instruments LM35, Sensirion STS3x Series)
3D Cameras or Depth Sensors (e.g., Intel RealSense Depth Cameras (D435, D455), Microsoft Azure Kinect DK, Structure Sensor by Occipital)

### ii. Piloting Control System

The piloting control system 3202 is coupled to data storage 3204, a battery 3206, other circuitry 3209 including power management and signal conditioning, multiple sensors 3208 including encoders 3211-3213, hand sensors 3410 detecting finger positions, and IMUs 3220, 3224 of the mobile data collection apparatus 3200. The piloting control system 3202 includes a processor, a memory, and instructions stored in the memory configured to be executed on the processor, where the instructions include applications to facilitate the collection of sensor data using the mobile data collection apparatus 3200 at sampling rates of 100-10,000 Hz. Additionally, the piloting control system 3202 may be in data communication with the robot 1, as well as the computer 3110, the data storage database 2900, the clutch 3140, and/or the optional display 3150 via a network 2999A-X supporting bandwidths of 1-1000 Mbps.

The piloting control system 3202 may be attached directly to the main support portion 3242 in a mounting region that is designed to receive electronics with appropriate thermal dissipation capabilities through heat sinks or thermally conductive mounting interfaces. In some embodiments, both the battery 3206 and the piloting control system 3202 are carried by the base mount. In other embodiments, the piloting control system may be remotely located from the base mount, and the base mount may be coupled to a power source that is also remotely located from the portable data collection apparatus. Said electronics may include sensors operating at various sampling rates from 10 Hz to 10 kHz, communication interfaces supporting protocols such as USB 3.0, Ethernet, Wi-Fi 6, and Bluetooth 5.0, processors including ARM Cortex-A series or Intel Atom processors, data storage devices using solid-state drives or eMMC storage, or any other electronic component that facilitates obtaining and transmitting sensor data from the mobile data collection apparatus 3200 to the computer 3110, the data storage 3204, and/or the robot 1 with end-to-end latencies under 20 ms. In some embodiments, the battery 3206 or power source for the piloting control system 3202 may reside with the piloting control system 3202 in a housing or be coupled separately to the main support portion 3242 and electrically connected to the piloting control system 3202 through power cables rated for 5-50 W. In some embodiments, the main support portion 3242 is configured to support at least the battery 3206 and/or piloting control system 3202 with vibration isolation providing 20-40 dB attenuation at frequencies that could affect sensor measurements.

The piloting control system 3202 may also be configured to integrate various software applications or functionalities (e.g., running on embedded Linux or real-time operating systems). These applications may include a sensor tracking application operating at 500-1000 Hz update rates, which may incorporate a drift correction algorithm to enhance tracking accuracy to sub-degree levels. For example, the sensor tracking application is tasked with the real-time acquisition of data from the array of sensors 3208 that are distributed across the apparatus 3200, managing data streams totaling 10-100 MB/s. The sensor tracking application communicates this collected sensor data to the computer 3110 for further processing through TCP/IP or UDP protocols, or it may process the data locally within the piloting control system 3202 using edge computing capabilities. The computer 3110 and/or the on-board processors that are located within the piloting control system 3202 then operate to refine the raw sensor data through filtering, calibration, and fusion algorithms. This refined sensor data can then be utilized, in connection with robot control data received from the robot 1, to dynamically adjust the data that is provided to generate the robot control data that is sent to the robot 1 with control loop frequencies of 100-1000 Hz.

Advanced algorithms, including various machine learning models such as recurrent neural networks with 10⁴ to 10⁶ parameters, can be employed to analyze the various data streams, such as the raw sensor data sampled at native rates, the refined sensor data after processing, and/or the received robot control data, in order to identify patterns with recognition accuracies above 95%, perform sensor fusion reducing uncertainty by 30-50%, correct for sensor drift maintaining errors below 1 degree/hour, and optimize control strategies improving task success rates by 20-40%. This comprehensive feedback loop, which incorporates data from the operator, the apparatus 3200, and the robot 1 with round-trip latencies under 50 ms, not only improves the performance of the apparatus 3200 in real-time but also contributes to the iterative development of more sophisticated control algorithms (or AI models) that can be tailored to operator-specific training regimens or particular task demands through transfer learning and fine-tuning approaches. This overall system architecture facilitates an adaptive training or teleoperation environment where the mobile data collection apparatus 3200 can continuously adjust its behavior based on accumulated interaction data from the operator and feedback from the robot 1, thereby maximizing both task efficacy achieving success rates above 90% and the immersion of the operator with presence ratings above 4 on a 5-point scale.

In some embodiments, the piloting control system 3202 further comprises: (i) sensor-interface circuits for each input modality, including interface circuits for the encoders 3211-3213, the wrist IMUs 3220, the torso IMU 3224, and the hand position sensors 3410; (ii) a kinematic-mapping processor with defined inputs comprising the measurements from the sensors 3208 and defined outputs comprising the robot control commands; and (iii) a whole-body-controller interface with a defined protocol for communication with the WBC 1550 of the robot 1 and an update rate within a range of 10 Hz to 10 kHz. The sensor-interface circuits, the kinematic-mapping processor, and the whole-body-controller interface may be implemented as discrete hardware blocks, as firmware modules executing on the processor of the piloting control system 3202, or as a combination thereof. In further embodiments, the piloting control system 3202 may log a training-data record into the data storage 3204 that contains the sensor measurements, the robot control commands, and a robot-side state record, with each entry timestamped using an IEEE 1588 Precision Time Protocol (PTP) clock shared between the wearable apparatus 3200 and the humanoid robot 1 for sub-microsecond temporal alignment.

### d. Robot Head-Mount Sensors

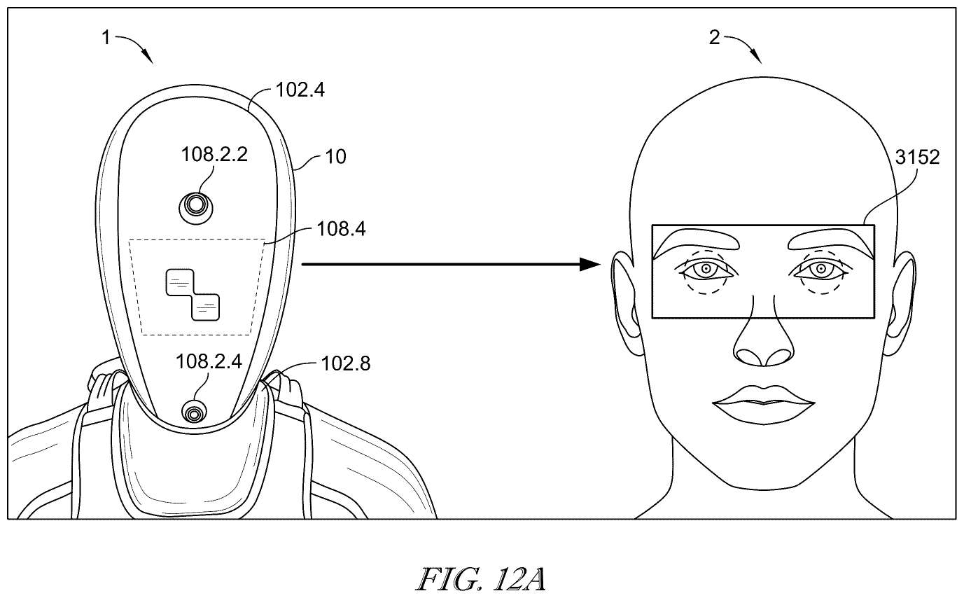

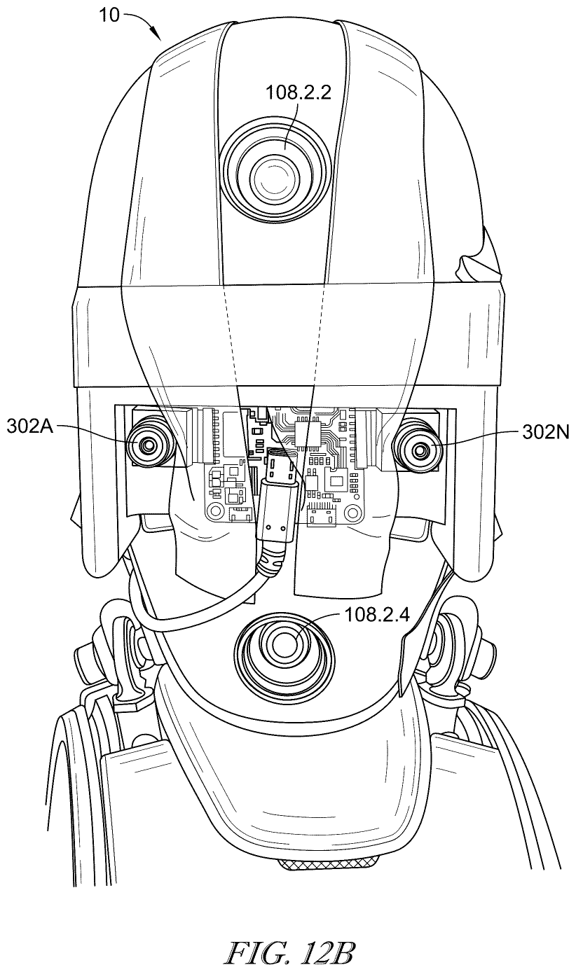

As best shown in FIGS. 12A-12B, the head and neck assembly 10 of the humanoid robot 1 may be designed to enhance anthropomorphic characteristics while providing functional capabilities that support interaction, perception, and communication. For example, the head 10 may house a range of components, such as high-resolution cameras, microphones, and displays, within an impact-resistant polymer shell designed to resemble a human head. Cameras embedded within the head 10 may include RGB, depth-sensing, or thermal imaging capabilities, enabling the robot 1 to perform tasks such as object recognition, environmental mapping, and facial expression analysis. For the specific purpose of generating a low-latency VR view, a pair of high-resolution, high-frame-rate RGB cameras with global shutters may be utilized. For example, the pair may be the vertically arranged cameras 108.2.2, 108.2.4 and/or the horizontally arranged external cameras 302A, 302N. Microphones may be arranged in an array to facilitate directional audio input and noise cancellation, enhancing the ability of the robot 1 to understand and respond to verbal commands. Displays integrated into the head 10 could serve as user interfaces, providing visual feedback or conveying expressions to improve communication and user engagement. Additionally, the head 10 may house other sensors such as gyroscopes, accelerometers, heat management systems, and communication equipment such as radios and antennas. This integrated design may enable seamless operation and robust functionality in dynamic and interactive environments. The head and neck assembly 10 may also incorporate materials and shock-absorbing structures to protect the electronic components housed within, potentially improving the overall durability and reliability of the robot 1.

The head and neck assembly 10 may include two primary actuators: a head twist actuator J8.1, responsible for enabling rotational movement of the head 10 about the vertical axis (yaw), and a head nod actuator J8.2, which adjusts the pitch of the head 10 about the horizontal axis. Together, these actuators J8.1, J8.2 may provide two degrees of freedom (2 DoF) for the head 10, allowing the head 10 to perform movements that emulate human head motions. The head twist actuator J8.1 may typically be located at the base of the neck, where the head twist actuator J8.1 interfaces with the torso 16, while the head nod actuator J8.2 may be positioned within the head assembly and enables forward and backward tilting of the head 10. This head twist actuator J8.1 and head nod actuator J8.2 may utilize a similar motor, gear reduction system, sensors, and/or encoders as the actuators discussed above in connection with the wearable training apparatus 3200. The head actuators J8.1 and J8.2 may work in coordination to position the head 10 accurately, enabling the robot 1 to track objects, focus on specific areas, or maintain eye contact during human-robot interactions. The actuators J8.1, J8.2 may be controlled by a motion planning system that processes input from visual and inertial sensors to execute smooth, human-like movements. For example, the head twist actuator J8.1 may rotate the head 10 to follow a moving object, while the head nod actuator J8.2 adjusts the pitch to maintain an optimal viewing angle.

Variations of this design could include the addition of a third actuator to provide roll motion, further increasing the range of movement of the head 10 to 3 DoF, which could enable more expressive head gestures, such as tilting the head 10 sideways to convey curiosity or empathy. Alternatively, the actuators J8.1, J8.2 could be replaced with compact linear actuators or parallel-link mechanisms for specialized applications demanding higher precision or load capacity. Additionally, variations could include modular head designs that allow for quick customization or replacement of components. These modular designs may facilitate easy upgrades or modifications to the sensory and communication capabilities of the robot 1 without demanding extensive changes to the overall head and neck assembly 10. Furthermore, control algorithms could be implemented to enable more natural, biomimetic head movements, potentially incorporating machine learning techniques to adapt and refine the motion patterns of the head 10 based on interaction data and environmental feedback.

As shown in FIG. 12A, the head 10 includes an enclosure 102.2, a frontal shield 102.4 and a neck shell 102.8. The head 10 can also include an opening for a screen 108.4, and (ii) at least one sensor (e.g., upper camera 108.2.2 and lower camera 108.2.4), representing the vertically arranged onboard cameras central to the image transformation problem. The screen 108.4 may be rectangular with a curvature. The opening for the screen 108.4 formed in the enclosure 102.2 of the head 10 may be shaped with contours around said screen opening to receive the curved shape of the screen 108.4 without obstructing the view. The upper camera 108.2.2 and the lower camera 108.2.4 may be arranged in a vertical orientation and may be placed at the same angle relative to the horizontal plane or transverse plane. For example, the angle between the upper and lower cameras 108.2.2, 108.2.4 may be positioned at a slight downward angle of about 0 to about 9.0 degrees, or about 6.7 to about 8.2 degrees with respect to a horizontal plane or transverse plane. In further embodiments, the downward angle of each camera 108.2.2, 108.2.4 relative to the horizontal plane may be selected within a broader range of about 0 to about 40 degrees, or about 0 to about 30 degrees, to accommodate alternative task geometries such as tabletop manipulation or floor-level inspection in which a larger downward bias aligns the combined field of view with a lower workspace. The specific vertical separation (baseline distance) and convergence angle of these cameras 108.2.2, 108.2.4 are key input parameters for the geometric transformation algorithms, and may be precisely calibrated prior to operation and occasionally during field service.

### e. Vertical-to-Horizontal Stereo Transformation Pipeline

In accordance with one aspect of the disclosed subject matter, the humanoid robot 1 supports a vertical-arrangement stereo camera pair, the pair including the upper camera 108.2.2 and the lower camera 108.2.4 separated by a vertical baseline in a range of 15 cm to 35 cm, each of the upper camera 108.2.2 and the lower camera 108.2.4 comprising a fisheye lens having a field of view exceeding 120 degrees, a global shutter configured for exposure intervals below 5 ms, and a frame rate of at least 60 frames per second. The vertical baseline of the stereo camera pair is selected within the 15 cm to 35 cm range to produce a parallax magnitude sufficient for depth-based synthesis of a horizontal stereoscopic viewport matched to an operator interpupillary distance, such that the synthesized viewport subtends a disparity range consistent with natural stereopsis in a head-mounted display. The fisheye lens geometry captures a hemispherical light field around the head, and the global shutter registers all pixel rows at a common exposure instant, producing temporally consistent image pairs for rectification and synthesis during rapid head or robot motion. In a preferred embodiment, the vertical baseline is approximately 25 cm, the fisheye field of view is approximately 170 degrees, and each of the upper camera 108.2.2 and the lower camera 108.2.4 operates at 90 frames per second with exposure intervals of approximately 2 ms.

The system further comprises an edge computing node positioned within 10 m of the humanoid robot 1 and coupled to the vertical-arrangement stereo camera pair through a dedicated MIPI CSI-2 interface operating at a data rate of at least 10 Gbps, the MIPI CSI-2 interface configured to deliver raw pixel data from the upper camera 108.2.2 and the lower camera 108.2.4 directly into memory buffers of the edge computing node through direct memory access with zero-copy buffer management. The dedicated MIPI CSI-2 interface routes pixel data from each camera sensor to a processing fabric of the edge computing node through a path separate from a main processing stack of the humanoid robot 1, such that the latency from photon capture to first-stage pixel availability at the edge computing node is bounded by the sensor readout interval plus the CSI-2 serialization interval. As a consequence, the cumulative transport latency is bounded within a sub-millisecond regime, and the main processing stack of the humanoid robot 1 retains full throughput capacity for locomotion and manipulation control. In one embodiment, the edge computing node is located within 5 m of the humanoid robot 1 and exhibits a measured round-trip time of less than 5 ms between the camera sensor and the processing fabric of the edge computing node. In further embodiments, the edge computing node may be defined in terms of its round-trip propagation time rather than its physical distance, such that the edge computing node is positioned to provide a propagation-induced round-trip delay below 100 ns (corresponding to approximately 10 m of cable length at a signal propagation speed of roughly 5 ns per meter), without regard to the specific layout of a surrounding facility.

The edge computing node comprises a field-programmable gate array having at least 500,000 logic elements programmed to execute a semi-global matching operation on the image pair produced by the vertical-arrangement stereo camera pair, the semi-global matching operation configured with 8 aggregation paths, a Census 9×7 cost function, penalty parameters P1=8 and P2=32, a uniqueness ratio of 0.95, and a disparity search range of at least 256 levels. The field-programmable gate array is further configured to apply a Brown-Conrady distortion correction with at least 5 distortion coefficients and a homography rectification optimized to minimize a Loop-Zhang distortion metric. The semi-global matching operation produces a depth map with sub-centimeter accuracy in a deterministic time budget by virtue of the fixed-function pipelined logic, such that the depth-estimation latency contribution is bounded within a fraction of the overall motion-to-photon budget. In a further embodiment, the field-programmable gate array implements the Brown-Conrady correction with 8 distortion coefficients and 16 parallel processing elements operating on 16-bit fixed-point arithmetic.

The edge computing node further comprises a graphics processing unit having at least 16 GB of video memory and hardware-accelerated ray tracing cores and tensor cores, the graphics processing unit configured to execute a neural view synthesis module that transforms the depth-augmented image pair from the vertical-baseline coordinate frame into a horizontal stereoscopic viewport matched to the operator interpupillary distance. The neural view synthesis module is implemented, in one embodiment, as a multi-resolution hash grid encoding comprising 16 levels and a fully-connected network having a width of 64 channels, with the hash-grid level count adjustable within a range of 16 to 24 and the network width adjustable within a range of 32 to 128 channels responsive to a current compute budget. The multi-resolution hash grid encoding is selected for the neural view synthesis module because the 16-level configuration captures spatial features from coarse to fine scales within a single compact parametric structure, which results in synthesis throughput consistent with a motion-to-photon budget below 20 ms in a foveal region of the head-mounted display. The lower bound of the 16-level minimum is that configurations below 16 levels may render insufficient high-frequency texture for foveal viewing, while the 24-level ceiling reflects the tensor-core throughput limit at the target frame rate.

The vertical-arrangement stereo camera pair, the dedicated MIPI CSI-2 interface, the field-programmable gate array, and the graphics processing unit operate in cooperation to produce the horizontal stereoscopic viewport within a motion-to-photon latency below 20 ms in the foveal region. The vertical-arrangement stereo camera pair contributes a spatially consistent parallax along the vertical axis and wide field-of-view peripheral coverage; the dedicated MIPI CSI-2 interface contributes deterministic, low-jitter pixel delivery with bounded serialization latency; the field-programmable gate array contributes pipelined disparity estimation with a fixed worst-case execution time; and the graphics processing unit contributes flexible neural synthesis within a thermal and utilization envelope. Together, these elements may satisfy the sub-20 ms foveal motion-to-photon budget because each element bounds a distinct latency source that the others cannot address alone. The significance of the edge computing node's physical proximity within 10 m of the humanoid robot 1 is that the proximity constrains the round-trip propagation component below 5 ms, permitting the remaining budget to be allocated to capture, synthesis, encoding, transport, and display-side reprojection.

In another embodiment, the neural view synthesis module implements a three-dimensional Gaussian splatting representation comprising 2 million to 5 million Gaussian primitives, with adaptive density control that subdivides primitives in regions of high depth gradient and prunes primitives in regions of low projected contribution. The Gaussian splatting representation produces the horizontal stereoscopic viewport by projecting each Gaussian primitive into a pair of virtual cameras separated by the operator interpupillary distance, yielding left-eye and right-eye viewports for delivery to the VR headset 3152. In a further embodiment, the neural view synthesis module implements depth-image-based rendering using the semi-global-matching depth map, with hole-filling for disocclusion regions through a neural inpainting network. In yet another embodiment, the edge computing node may implement multi-plane image (MPI) representations with 32 to 128 depth planes, with each depth plane rendered as a separate RGBA layer and composited at the VR headset 3152 in a parallax-correct manner.

### f. Adaptive Synthesis Control by Network and Compute Telemetry

In accordance with another aspect, the edge computing node comprises an adaptive synthesis controller configured to select, for each stereoscopic frame or group of stereoscopic frames, one of a first synthesis mode and a second synthesis mode, the first synthesis mode comprising a homography-based rectification executed on the field-programmable gate array and the second synthesis mode comprising a neural view synthesis executed on the graphics processing unit. The adaptive synthesis controller is coupled to a plurality of telemetry inputs comprising a network round-trip time measurement, a network jitter measurement, a graphics-processing-unit utilization measurement, and a graphics-processing-unit thermal-headroom measurement. The adaptive synthesis controller selects the first synthesis mode responsive to the network round-trip time measurement falling below 5 ms and the network jitter measurement falling below 1 ms, and selects the second synthesis mode responsive to the network round-trip time measurement exceeding 5 ms or the network jitter measurement exceeding 1 ms, conditioned on the graphics-processing-unit utilization measurement remaining below 80% and the graphics-processing-unit thermal-headroom measurement exceeding 10 degrees Celsius. As a result, the adaptive synthesis controller maintains a bounded end-to-end latency across a spectrum of network and compute conditions while preserving the maximum available synthesis fidelity consistent with the current operating state.

The adaptive synthesis controller is further configured to scale synthesis quality parameters of the second synthesis mode along a quality axis, the scaling actuated responsive to the graphics-processing-unit utilization measurement or the graphics-processing-unit thermal-headroom measurement approaching their respective thresholds. The quality axis comprises adjustment of training iterations within a range of 5,000 to 15,000, adjustment of hash-grid levels within a range of 16 to 24, and adjustment of network width within a range of 32 to 128 channels. The quality-axis scaling operates continuously during synthesis, such that the synthesis throughput tracks the available graphics-processing-unit capacity while retaining the neural synthesis mode whenever the network telemetry indicates the homography-only mode is insufficient. The joint conditioning on network and compute telemetry is that evaluation of network telemetry alone would select the neural mode under conditions where the graphics processing unit is thermally constrained, while evaluation of compute telemetry alone would select the homography mode under conditions where the network itself already consumes the latency budget. The adaptive synthesis controller may comprise (i) telemetry collection logic configured to poll the telemetry inputs at a defined polling rate, (ii) threshold comparison logic configured to compare each telemetry input against its associated threshold, (iii) a mode-selection state machine configured to advance between the first and second synthesis modes based on the threshold comparison results, and (iv) an optional hysteresis model configured to resist rapid mode oscillation between the first and second synthesis modes.

The plurality of telemetry inputs, the adaptive synthesis controller, and the quality-axis scaling parameters of the neural view synthesis mode operate in cooperation to preserve a target motion-to-photon latency across a spectrum of operating conditions. The network round-trip and jitter telemetry indicate whether a lightweight rectification is sufficient to recover a valid horizontal stereo pair within the latency budget, while the graphics-processing-unit utilization and thermal-headroom telemetry indicate the residual compute capacity available for neural synthesis within the thermal envelope. Together, these telemetry channels and scaling parameters permit the second synthesis mode to be invoked only when network and compute conditions jointly accommodate its computational cost, because the joint evaluation couples the selection decision to the actual physical state of both the transport path and the synthesis hardware. In some embodiments, the telemetry collection logic may additionally poll a measured motion-to-photon latency at the VR headset 3152 and may fold the measured motion-to-photon latency into the mode-selection decision, such that the system adapts its synthesis mode in response to observed display-side behavior rather than solely to upstream indicators.

In another embodiment, the adaptive synthesis controller further comprises a predictive telemetry model trained on historical telemetry records to forecast a mode-switching probability over a horizon of 50 ms to 500 ms, the predictive telemetry model providing a hysteresis signal that regulates switching frequency between the first synthesis mode and the second synthesis mode. In a further embodiment, the field-programmable gate array implements the homography-based rectification with 16 parallel processing elements operating on 16-bit fixed-point arithmetic, providing a deterministic worst-case execution interval that establishes a latency floor for the first synthesis mode. In yet another embodiment, the adaptive synthesis controller may further include a third synthesis mode comprising a hybrid of the first and second synthesis modes, in which the homography-based rectification produces an initial horizontal-baseline estimate and the neural view synthesis refines the initial estimate to correct residual distortion and disocclusions.

The upper and lower cameras 108.2.2, 108.2.4 are primarily for tasks, providing a field of view in front of the robot 1. In other embodiments, a rear camera may be included primarily for situational awareness and localization of the robot 1, providing a field of view behind the robot 1. Similarly, a top camera may assist with localization of the robot 1. The cameras 108.2.2, 108.2.4 are not 360-degree cameras and have restricted fields of view. For example, the angles of the upper camera 108.2.2 and the lower camera 108.2.4 may be adjusted to provide a fuller field of view and minimize blind spots or dead space. Positioning the camera sensors 108.2.2, 108.2.4 on the head 10 of the robot 1 also allows for movement of the sensors 108.2.2, 108.2.4 for better viewing with less movement of the overall robot 1. By moving the head 10 up and down and rotating the head 10 left and right, the target image within the fields of view of the cameras 108.2.2, 108.2.4 is changed and provides a larger, derivative field of view from the sensor assembly 108.2.

The robot 1 may move its head 10 up and down by bending at the neck to adjust the orientation of the cameras 108.2.2, 108.2.4. For example, the neck is able to bend up and down about ±25 degrees, which allows the upper and lower cameras 108.2.2, 108.2.4 to view 200 mm in front of the feet 92 of the robot 1. About 20 degrees of forward torso lean allows the upper and lower cameras 108.2.2, 108.2.4 to view the feet 92. The positions of the cameras 108.2.2, 108.2.4 thus provide a closer or better view to the feet 92 of the robot 1 compared to cameras mounted to the torso 16 of the robot 1 because the fields of view of the upper and lower cameras 108.2.2, 108.2.4 are not entirely blocked by the legs 6 of the robot 1. Additionally, the robot 1 may turn its head 10 left and right to adjust the orientation of the cameras 108.2.2, 108.2.4. The images or video recorded by the cameras 108.2.2, 108.2.4 may be processed for stereoscopic transformation for VR display.

Although upper, lower top, and rear cameras 108.2.2, 108.2.4 are shown as illustrative examples, other sensors may be relied on and coupled to an internal mounting frame in a similar manner to ensure proper directional positioning for respective detection, sensing, or signal reception. Relevant sensor types for low-latency VR include color cameras (typically CMOS), cameras with global shutters (preferred over rolling shutter), high-speed cameras (higher frame rates reduce latency), 3D cameras (like ToF or structured light, if depth is directly used), light field cameras (for alternative view synthesis), or potentially event cameras (for ultra-low latency paths). Said camera may have a megapixel resolution of between 0.4 MP to 20 MP, may record video at frame rates suitable for VR (e.g., >60 FPS, ideally >=90 FPS), may have a CMOS sensor, pixel size may range from 2.4 um to 6.9 um, and preferably utilizes global shutter. Said sensors may include: (i) scan camera(s), (ii) monochrome camera(s), (iii) color camera(s), (iv) CMOS camera(s), (v) CCD sensor(s) or camera(s) that include CCD sensor(s), (vi) camera(s) or sensor(s) that have rolling shutter or global shutter, (vii) other types of 2D digital camera(s), (viii) other types of 3D digital camera(s), (ix) camera(s) or sensor(s) that are capable of stereo vision, structured light, and laser triangulation, (x) sonar camera(s) or ultrasonic camera(s), (xi) infrared sensor(s) and/or infrared camera(s), (xii) radar sensor(s), (xiii) LiDAR, (xiv) other structured light sensors, camera(s), or technologies, (xv) dot projecting camera(s) or sensor(s), (xvi) Time-of-Flight (ToF) cameras, (xvii) hyperspectral cameras, (xviii) multispectral cameras, (xix) thermal imaging cameras, (xx) high-speed cameras, (xxi) panoramic cameras, (xxii) omnidirectional cameras, (xxiii) polarization cameras, (xxiv) plenoptic (light field) cameras, (xxv) depth-sensing cameras, (xxvi) ultraviolet (UV) cameras, (xxvii) single-photon avalanche diode (SPAD) cameras, (xxviii) electron-multiplying CCD (EMCCD) cameras, (xxix) short-wave infrared (SWIR) cameras, (xxx) medium-wave infrared (MWIR) cameras, (xxxi) long-wave infrared (LWIR) cameras, (xxxii) quantum dot cameras, (xxxiii) microbolometer cameras, (xxxiv) holographic cameras, (xxxv) optical coherence tomography (OCT) cameras, (xxxvi) spectral imaging cameras, (xxxvii) phase contrast cameras, (xxxviii) interferometric cameras, (xxxix) fiber optic cameras, (xl) terahertz cameras, (xli) millimeter-wave cameras, (xlii) acoustic cameras, (xliii) biometric cameras (e.g., iris recognition cameras), (xliv) artificial compound eye cameras, (xlv) volumetric capture cameras, (xlvi) computational photography cameras, (xlvii) smartphone cameras with advanced sensors, (xlviii) augmented reality (AR) and virtual reality (VR) cameras, (xlix) streak cameras, (l) burst-mode cameras, (li) LiFi (Light Fidelity) cameras, or any combination of the above or any other known camera or sensor. For example, said camera may have a megapixel resolution of between 0.4 MP to 20 MP, may record video at 5.6 FPS to 286 FPS, may have a CMOS sensor, pixel size may range from 2.4 um to 6.9 um, may utilize a starves rolling shutter technology, can operate in 55 degree c ambient air temperatures, and may have any other properties, technologies, or features. It should be understood that the cameras are typically configured as video cameras but may have an alternative configuration, such as an image camera. The head 10 can also include one or more cameras, temperature sensors, pressure sensors, force sensors, inductive sensors, capacitive sensors, ultrasonic sensors, infrared sensors, proximity sensors, microphones, gas sensors, light sensors (photodiodes, phototransistors), UV sensors, time-of-flight sensors, LiDAR sensors, optical flow sensors, RFID readers, laser rangefinders, 3D depth cameras, or any combination of these sensors or other known sensors.

The information from each of the upper and lower cameras 108.2.2, 108.2.4, may be used alone or in combination with information from other cameras (e.g., top and rear cameras) and/or sensors included on the robot 1 to aid in the control of the robot 1. The information from said cameras may be used to help the robot 1 navigate or locomote on different terrain, localize to different environments and plan routes, and sense and avoid obstacles. When these cameras 108.2.2, 108.2.4 are used for both control/perception of the robot 1 and generating the VR feed, resource contention (compute, memory bandwidth, data bus) must be managed to avoid impacting the latency of the VR stream. Architectures separating the VR feed (e.g., using external cameras 302A-N and a direct dataflow) can mitigate the latency issues. The upper, lower top, and rear cameras may be utilized in similar ways or methods that are discussed within U.S. Patent Application Publication 2005/0267631 and U.S. Pat. Nos. 10,638,906, 10,437,251, 11,020,860, 10,580,208, 11,485,013, 11,759,075, or 10,614,588, all of which are incorporated herein by reference.

### g. Hybrid Internal-Vertical and External-Horizontal Camera Fusion

In accordance with one aspect, the humanoid robot 1 further comprises, in addition to the vertical-arrangement stereo camera pair (comprising cameras 108.2.2, 108.2.4), an external horizontal-arrangement stereo camera pair 302A, 302N mounted on the head 10 and separated by a horizontal baseline matched to a nominal operator interpupillary distance, the external horizontal-arrangement stereo camera pair 302A, 302N having a field of view narrower than the field of view of the vertical-arrangement stereo camera pair 108.2.2, 108.2.4. The edge computing node is further configured to fuse image data from the vertical-arrangement stereo camera pair 108.2.2, 108.2.4 and image data from the external horizontal-arrangement stereo camera pair 302A, 302N through a multi-view synthesis network, such that the synthesized stereoscopic viewport delivered to the VR headset 3152 combines peripheral coverage from the vertical-arrangement pair 108.2.2, 108.2.4 and central coverage from the external horizontal-arrangement pair 302A, 302N. The multi-view synthesis network selects per-region evidence from whichever of the vertical-arrangement and external horizontal-arrangement pairs provides higher geometric fidelity for each region. In some embodiments, the external horizontal-arrangement stereo camera pair 302A, 302N may be removably coupled to the head 10 through a standardized mechanical and electrical connector, such that the external camera pair may be installed for teleoperation tasks and removed for autonomous operation.

The multi-view synthesis network comprises a transformer having 12 encoder layers, 8 attention heads, and a hidden dimension of 768, the transformer preceded by an encoder comprising a modified ResNet-50 backbone with dilated convolutions and a feature pyramid network, and followed by a fusion network implementing cross-attention and a three-dimensional convolutional neural network constructing a volumetric grid of 128 channels and 64 depth planes, and a renderer implementing differentiable ray marching with 64 samples per ray through a four-layer multi-layer perceptron with 128 units per layer. The multi-view synthesis network is trained on 100,000 robot-captured multi-view images with ground-truth depth from a LiDAR reference, using a composite loss comprising an L1 photometric term with weight 0.8, a VGG-16 perceptual term with weight 0.1, and a PatchGAN adversarial term with weight 0.1, the composite loss optimized with Adam at a learning rate of 1×10⁻⁴, a batch size of 8, and 500,000 training iterations. The volumetric grid of 128 channels and 64 depth planes is selected because this resolution captures scene geometry at sub-centimeter depth precision within the synthesis compute budget, which results in synthesized viewport fidelity matched to the resolution of the VR headset 3152. In alternative embodiments, the multi-view synthesis network may have 6 encoder layers, 4 attention heads, and hidden dimension of 512, or 18 encoder layers, 12 attention heads, and hidden dimension of 1024, with the corresponding values selected based on compute budget and fidelity requirements.

The edge computing node is further configured to allocate synthesis compute across the three concentric regions in a ratio of 80% for the foveal region, 15% for the parafoveal region, and 5% for the peripheral region. The vertical-arrangement stereo camera pair 108.2.2, 108.2.4, the external horizontal-arrangement stereo camera pair 302A, 302N, the multi-view synthesis network, and the gaze-contingent compute allocator operate in cooperation to produce a synthesized viewport in which central visual fidelity corresponds to the native horizontal baseline of the external pair 302A, 302N while peripheral fidelity is supplied by the wider field of view of the vertical-arrangement pair 108.2.2, 108.2.4. The vertical-arrangement pair 108.2.2, 108.2.4 contributes hemispherical peripheral imagery, the external horizontal-arrangement pair 302A, 302N contributes high-resolution central imagery at the operator interpupillary distance, the multi-view synthesis network contributes fusion of the two image sources at each pixel, and the gaze-contingent compute allocator contributes region-weighted compute distribution. Together, these elements align synthesis compute expenditure with retinal acuity across the viewport, because the gaze-contingent allocator concentrates transformer inference cycles in the region of highest visual sensitivity while maintaining synthesis continuity across the parafoveal and peripheral regions.

### F. OPERATION OF THE DATA COLLECTION SYSTEM

A method for operating the robot data collection system 3010 to train robot 1 and neural networks running on one or more robots begins by linking the piloting control system 3202 of the wearable training apparatus 3200 to the robot 1 and/or computer 3110 via the network 2999A-X. User 2 then dons the wearable training apparatus 3200 on the back and secures it in position using the adjustable harness 3270. The user 2 may also wear the glove components 3400 on each hand. The left and right actuated pilot arms 3300 may extend from the base frame 3240 to the glove components 3400 and may be configured to move with the arms of the user 2 wearing the wearable training apparatus 3200 as the user 2 performs data collection tasks.

The combination of the data obtained from: (i) the actuator sensors (e.g., encoders 3211, 3212, 3213), (ii) the wrist inertial measurement units (IMUs) 3220, (iii) a torso IM 3224, (iv) potentially additional body-worn IMUs (e.g., on upper arms, head), (v) physiological sensors integrated into the apparatus 3200 or headset display 3150 (e.g., eye-tracking for gaze/intent, EEG/EMG for cognitive state or refined motor commands), and (vi) any of the above sensors or other known sensors can be combined by the wearable training apparatus 3200 and considered sensor data. The actuator sensors are configured to measure the rotational and positional movement of each frame link, while left and right wrist IMUs 3220 are designed to provide information regarding the pitch and orientation of the wrist. Finally, the torso IMU 3224 is designed to provide ground truth for determining the position and orientation of said wrist.

This sensor data is transmitted to the computer 3110 over the network 2999A-X. Upon receiving the data, the computer 3110 processes the sensor data and generates control data. The control data typically includes the six degrees of freedom (DOF) pose of each wrist of user 2 relative to the user's torso. Notably, the control data only includes the difference, or delta, between the last known location of each wrist and their current positions, rather than determining the absolute positions, though absolute poses might be simpler to manage robustly. However, in alternative embodiments, the system 3010 may be designed to compute the absolute six DOF pose of the user's wrists. Based on processing data from the sensors 3208, the computer 3110 generates control data at frequencies suitable for robotic control, typically between 10 Hz and 10 kHz. This control data is sent to robot 1 via the network 2999A-X.

Specifically, the delta for the left wrist is determined using data from encoders 3211a, 3212a, 3213a, wrist IMU 3220a, and torso IMU 3224. Similarly, the delta for the right wrist is determined from encoders 3210b, 3211b, 3213b, wrist IMU 3220b, and torso IMU 3224. The IMUs 3220 and 3224 are primarily used to determine the orientation of the user's wrists, not their positions. In cases where each IMU includes only a 3-axis gyroscope and a 3-axis accelerometer, the computer 3110 may implement a Mahony algorithm or a similar sensor fusion technique to combine these sensors into an orientation signal. The gyroscope signal is integrated to obtain wrist orientation, while the accelerometer provides a measurement of the gravity vector. The Mahony algorithm effectively removes any bias due to gyroscope signal integration along the pitch and roll axes. When the IMUs also include a magnetometer, an absolute heading signal is provided, and the computer 3110 uses a Madgwick algorithm or similar technique to determine an absolute orientation. The data from encoders 3210, 3211, 3213 is then fused with the absolute orientation and heading signals to correct drift in the IMU data, as the encoders are less susceptible to magnetic interference and exhibit less drift.

### a. Open Loop Real-Time Communication

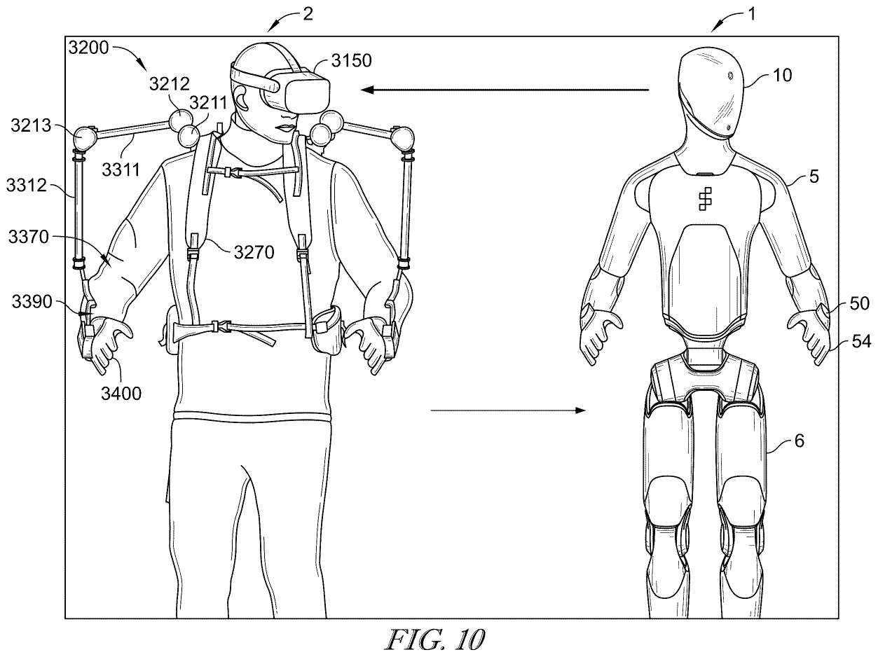

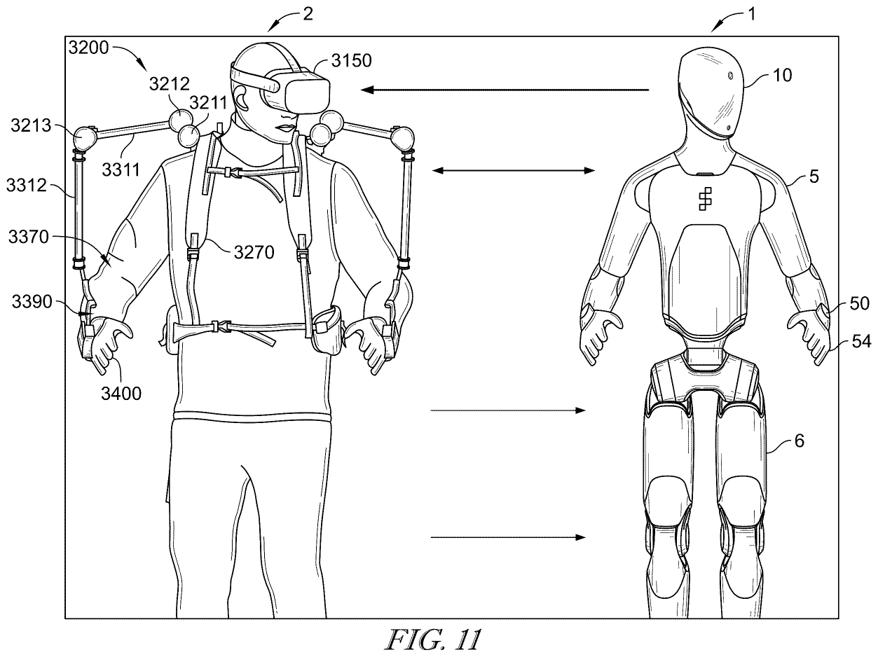

Referring to FIG. 10, the user 2 wearing the wearable training apparatus 3200 interacts with robot 1 by receiving primarily visual robot sensor data from robot 1 in real-time and transmitting control data to robot 1. Here, limited data is transmitted between the robot 1 and the piloting control system 3202 of the wearable training apparatus 3200, reducing the bandwidth and/or transmission speed to be used for real-time communication. In particular, complete and robust sensor data is sent from the wearable training apparatus 3200 to the computer 3110, and then complete and robust control data is sent to the robot 1, meanwhile a limited amount of robot data is sent from the robot 1 to the wearable training apparatus 3200 via the computer 3110. This limited data from the robot 1 may include: (i) video data from what the robot 1 is viewing, and/or (ii) data from the actuators (e.g., torque, current, position). This limited data can then be used by the wearable training apparatus 3200 and the display 3150 to: (i) display what the robot 1 is seeing, and (ii) provide a limited amount of information regarding what the robot 1 is feeling. For example, the limited amount of information regarding the feeling may be only transmitted once the torque or current of an actuator exceeds a threshold limit. This will inform the pilot that is wearing the wearable training apparatus 3200 that the robot 1 has made contact with an object in the real world. In this situation, the pilot can then use this information to proceed with caution while moving the robot 1.

### b. Closed Loop Real-Time Communication

Referring to FIG. 11, the humanoid robot data collection system 3010 may operate in a closed loop mode. In this mode, the closed loop mode may be effective in a networked environment that is capable of high-speed data transmittal between the robot 1 and the piloting control system 3202 of the wearable training apparatus 3200. In particular, the wearable training apparatus 3200 controls the robot 1 using control data that is generated from the sensor data obtained from said wearable training apparatus 3200, and the robot 1 provides robot data to the wearable training apparatus 3200 to help control the actuators of said wearable training apparatus 3200, and provides video data to the display 3150. Unlike the open loop mode, the closed loop mode provides sufficient robot data for the wearable training apparatus 3200 to provide accurate feedback to the pilot or user 2 of the wearable training apparatus 3200 to inform said user or pilot of the forces that the robot 1 is feeling. In other words, the data is transmitted from the wearable training apparatus 3200 to the robot 1 to control said robot 1, and then data is transmitted back to the wearable training apparatus 3200 to control the wearable training apparatus 3200. The user 2 can then push against the forces applied by the wearable training apparatus 3200 to cause the robot 1 to apply additional force to the object. This closed loop mode causes the user or pilot to step in the shoes of the robot 1 and feel, see, touch, and interact with the world as if he/she is the robot 1.

### G. IMAGE DATA TRANSFORMING

The disclosed technology provides for transforming image data from robot cameras 108.2.2, 108.2.4 for display in a VR headset 3152, aiming to minimize latency below perceptual thresholds, ideally less than 20 ms motion-to-photon latency. One or more cameras can be arranged in a horizontal arrangement to reduce image processing called for in rendering images generated by the cameras for the VR display of the VR headset 3152. This corresponds to the external cameras 302A-N that are designed to be in a horizontal configuration. As a result of the horizontally-arranged cameras, processing can occur more efficiently and quickly. While this simplifies the geometric transformation, it may introduce parallax differences compared to the robot's potentially vertically offset “eyes” used for its own perception, unless these external cameras 302A-N are also used for robot control. These cameras 302A-N can be external to the robot 1 and thus affixed or attached to the robot 1 in the horizontal arrangement. The cameras 302A-N may involve additional hardware that can be primarily used for controlling the robot 1 during teleoperation, such as where image data generated by the cameras 302A-N is not of use for robot control model training or development, representing a design choice to use dedicated cameras solely for the low-latency VR feed.

In some implementations, the image data from these external cameras 302A-N can sometimes be transmitted directly to the VR headset 3152 or computing architecture 3110, while cameras 108.2.2, 108.2.4 that are integrated into or otherwise part of the robot 1 collect other image data for use in training the robot control models (corresponding to dataflow 1 or 5). In other implementations, the disclosed technology can leverage cameras that are already part of the robot 1, such as cameras 108.2.2, 108.2.4 installed within the head 10 of the robot 1. The cameras 108.2.2, 108.2.4 that are part of the robot 1 can be vertically-arranged. As a result of this arrangement, more extensive image processing techniques (calling for rectification and/or view synthesis) may be used to transform the vertically-arranged images for rendering in the VR display of the VR headset 3152 than if the horizontally-arranged images from the cameras affixed to the robot 1 are used. Although the internal robot cameras 108.2.2, 108.2.4 generate images that would benefit from additional processing and compute resources, this setup may not rely on additional hardware to be deployed in the system. Moreover, the images captured by the internal cameras 108.2.2, 108.2.4 can be used for both training the robot 1 control models and rendering views in the VR headset 3152.

As yet another example implementation, the disclosed technology can use a hybrid setup, where external cameras 302A-N attached to the robot 1 and internal cameras 108.2.2, 108.2.4 of the robot 1 generate image data for rendering views in the VR headset 3152, perhaps using external horizontal cameras 302A-N for the primary VR view (low latency) and internal vertical cameras 108.2.2, 108.2.4 for auxiliary views or robot perception. Here, data collected from the horizontally-arranged external cameras can also be used for training, but used in a less relevant capacity since such data may not represent the robot's hardware. The choice between these configurations depends on factors such as the available compute budget, the need for training-data-to-display-data alignment, and the physical constraints of the robot's head assembly.

Once the image data is generated by the camera(s), the image data can be communicated directly out of the robot 1 for further processing (e.g., training), potentially bypassing the main robot CPU/OS stack using direct hardware paths (DMA, dedicated encoders) or specific network offloads (RDMA). The image data need not be routed through a robot stack, which can introduce other latencies. Similarly, the image data can be routed directly from the alternative set of cameras described above to another computing architecture (e.g., directly to an edge node such as computing architecture 3110 as in dataflow 5 or dataflow 1) for execution of the processing described herein.

One or more processing techniques may be used to transform the image data into a horizontal arrangement (e.g., stereovision) for the VR headset 3152. For example, the processing can include use of different types of shutters, onboard image processing (e.g., on ISP/FPGA), mapping algorithms (e.g., rectification), synthesis techniques (e.g., DIBR, NeRF, 3DGS), deep learning models, neural network-based rectification and/or mapping techniques, other stereo algorithms and techniques, encoding and compression techniques, predictive tracking, synchronization techniques, and other techniques described herein.

### a. Robot with External Set of Cameras

FIG. 12B is a diagram showing an external set of cameras 302A-N removably affixed to the robot head 10. The robot head 10 can include existing cameras 108.2.2-108.2.4 disposed therein. The existing cameras 108.2.2-108.2.4, as described above, may be arranged in a vertical arrangement on the robot head 10. The external set of cameras 302A-N can be arranged in a vertical path, a horizontal path, and/or any combination thereof. The robot head 10 can include additional or fewer cameras 302A-N affixed thereto. Although not depicted, one or more of the cameras 302A-N can be affixed to other portions of a robot 1, including but not limited to a chest portion, arms, legs, fingers, hands, shoulders, and/or any combination thereof. Placing cameras on end-effectors (hands) could provide key close-up views for manipulation tasks, potentially fused or switched with the head camera view.

The external set of cameras 302A-N can be removably coupled to the head 10. In some implementations, cameras 302A-N can be installed within the head 10 but may be electronically decoupled from the robot's processing stack. As a result, image data generated by the external set of cameras 302A-N can be transmitted directly from the cameras 302A-N to other components, such as a VR headset 3152 or computing architecture 3110, rather than being routed through the robot's processing stack (enabling dataflows 1, 3, or 5). Although the external set of cameras 302A-N are depicted as being attached or mounted to the robot head 10, the external set of cameras 302A-N can be removed from the robot head 10 and attached or mounted to other system components. For example, the external set of cameras 302A-N can be attached to a first robot's head for purposes of capturing images during training or operation of the first robot. Once the training or operation is complete, the external set of cameras 302A-N can be detached from the first robot and then mounted on a second robot. In this example, the external set of cameras 302A-N can be electronically paired or coupled with the wearable training apparatus 3200 such that a wearer of the apparatus 3200 can teleoperate the second robot based on seeing, in a VR headset 3152, rendered views from images captured by the external set of cameras 302A-N on the second robot. This modular camera unit could contain its own minimal processing/encoding hardware to facilitate easy integration.

In the example of FIG. 12B, a first external camera 302A and a second external camera 302N can be arranged in a horizontal path across the robot head 10 (e.g., across a mid-portion of the robot head 10, such as where a human's eyes may be in the human's head). This configuration in FIG. 12B can advantageously minimize a drive to change orientation of camera views (i.e., reduces the complexity of the geometric transformation compared to vertical cameras). Where the external set of cameras 302A-N are used, their image data can be transmitted to other components, such as the VR headset 3152, while the existing cameras 108.2.2-108.2.4 of the robot head 10 continue to collect data for use in training models for controlling the robot 1, representing an architecture separating the VR feed from robot perception.

In some implementations, the external set of cameras 302A-N may include event cameras, which can be coupled with neuromorphic processing techniques. The event cameras can be paired with spiking neural networks (SNNs) on neuromorphic hardware. This can offer a path to ultra-low latency perception while leveraging event-based view synthesis for VR and specialized hardware. SNNs can mimic the brain's natural way of processing information by transmitting data as discrete spikes rather than continuous signals, enabling sparse, time-dependent computation. Neuromorphic hardware can be designed to support this type of model, using analog and/or mixed-signal circuits to emulate neurons and synapses, thereby allowing for energy-efficient, real-time processing. Neuromorphic processing can include event-driven computation where processing units activate only when spikes occur, thereby reducing power consumption and latency to make it highly suitable for asynchronous inputs like those from event cameras.

### b. Dataflow

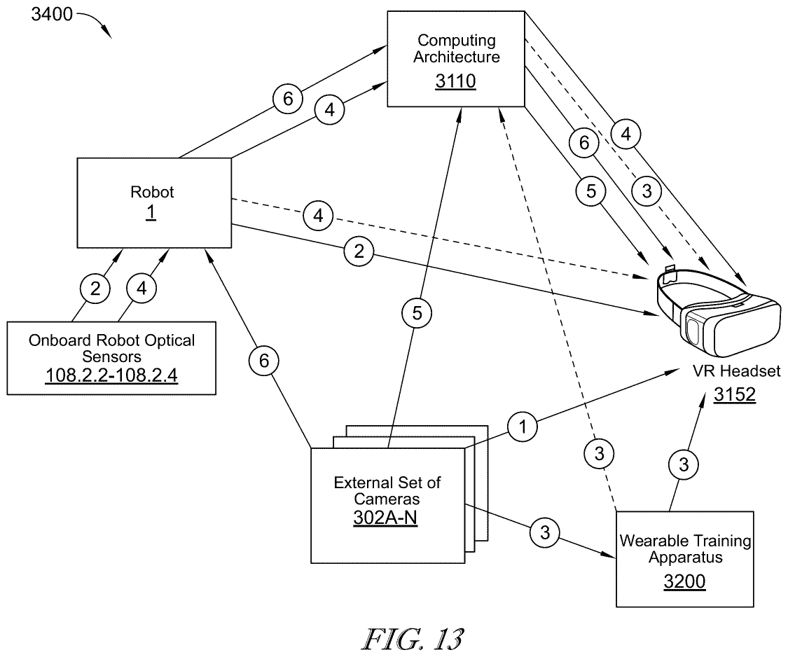

FIG. 13 is a conceptual diagram illustrating example dataflows 1, 2, 3, 4, 5, and 6 (where 5 and 6 are implied or clarified interpretations) between components for use in transforming image data for VR displays. The components can include the robot 1, the onboard robot optical sensors (e.g., cameras) 108.2.2-108.2.4, the external set of cameras 302A-N, the wearable training apparatus 3200, a computing architecture 3110, a VR headset 3152, and/or any combination thereof. The computing architecture 3110 can be a cloud-based system, edge node, and/or other computing system or network that can be configured to process images captured by the cameras (302A-N or 108.2.2-108.2.4) to generate images that are presented in the VR headset 3152. The computing architecture 3110 can be separate from the robot 1 or part of any one or more of the other components shown and described in FIG. 13.

Sometimes, the computing architecture 3110 can be at a same location or environment as the robot 1, the cameras 302A-N, the VR headset 3152, and/or any combination thereof. In some implementations, one or more of the robot 1, the cameras 302A-N, the computing architecture 3110, and/or the VR headset 3152 can be remote from each other. The choice of dataflow significantly impacts latency. Direct paths minimize hops but might demand processing on less powerful devices or specific camera arrangements. Paths involving the robot stack leverage robot compute but add potential delays. Paths involving edge/cloud nodes such as computing architecture 3110 offer powerful processing but can introduce network latency.

As shown in FIG. 13, conceptually dataflow 1 can exist between the external set of cameras 302A-N and the VR headset 3152. This provides the fastest data transmission speed by bypassing the other dataflows 2, 3, and 4. The dataflow 1 can provide a direct feed of image data generated by the external set of cameras 302A-N to the VR headset 3152 without having to run the data through the robot 1's processing stack and/or the wearable training apparatus 3200. The dataflow 1 can also include routing the image data from the external set of cameras 302A-N to the computing architecture 3110 for processing and transformation before being routed to the VR headset 3152. In some implementations, the image data generated by the external set of cameras 302A-N already appear in a horizontal arrangement, so minimal processing may be performed before routing the image data from the external set of cameras 302A-N to the VR headset 3152. As a result, the minimal processing may be performed locally by the external set of cameras 302A-N and/or locally at the VR headset 3152, without routing the image data to the computing architecture 3110.

Dataflow 2 can exist between the onboard robot optical sensors 108.2.2-108.2.4, the robot 1, and the VR headset 3152. The dataflow 2 may have slower data transmission speeds than the dataflow 1. Images captured by the onboard robot optical sensors 108.2.2-108.2.4 can be used for both the VR headset 3152 display and robot model training. The captured images can be processed locally at the robot 1 in order to transform the images for the stereoscopic view of the VR headset 3152 display. The captured images can be transmitted to the robot 1 then the computing architecture 3110 to perform said transformations. Thus, the dataflow 2 can also include routing the image data from the onboard robot optical sensors 108.2.2-108.2.4 to the robot 1 and to the computing architecture 3110 for processing and transformation before being routed down to the VR headset 3152.

Dataflow 3 can exist between the external set of cameras 302A-N, the wearable training apparatus 3200, and the VR headset 3152. The dataflow 3 may have slower data transmission speeds than the dataflows 1 and 2. The dataflow 3 can be preferred where the image data generated by the external set of cameras 302A-N is also being used for robot model training. The image data can sometimes be processed locally at the external set of cameras 302A-N and/or the wearable training apparatus 3200 in order to transform the images for the stereoscopic view of the VR headset 3152 display. In some implementations, the dataflow 3 can also include routing the image data from the external set of cameras 302A-N to the wearable training apparatus 3200 and to the computing architecture 3110 for processing and transformation before being routed down to the VR headset 3152. In yet some implementations, although not depicted, the dataflow 3 can include routing the image data from the external set of cameras 302A-N to the computing architecture 3110 for processing and transformation, then to the wearable training apparatus 3200 before being routed down to the VR headset 3152.

Dataflow 4 can exist between the external set of cameras 302A-N, the robot 1, and the VR headset 3152. The dataflow 4 may have slower data transmission speeds than the dataflow 1, 2, and/or 3. Images captured by the external set of cameras 302A-N can sometimes also be used for robot model training. Sometimes, the image data can be processed locally at the robot 1 in order to transform the images for the stereoscopic view of the VR headset 3152 display. In some implementations, the images can be transmitted to the robot 1 then the computing architecture 3110 to perform said transformations. Thus, the dataflow 4 can also include routing the image data from the external set of cameras 302A-N to the robot 1 and to the computing architecture 3110 for processing and transformation before being routed down to the VR headset 3152. Sometimes, instead of using the dataflow 4, the dataflow 2 can be implemented.

Dataflow 5 involves external cameras 302A-N sending data directly (bypassing robot stack) to the computing architecture 3110 (edge node) for processing, before transmission to the VR headset 3152. Dataflow 6 is similar to dataflow 4 but using external cameras 302A-N as input to the robot 1, followed by processing split between the robot 1 and the edge node computing architecture 3110 before going to the VR headset 3152.

Where a system 3010 implements (i) the computing architecture 3110 (edge node) and (ii) the external set of cameras 302A-N, the data flows 5 or 6 can be used. Where the system only relies on the onboard robot optical sensors 108.2.2-108.2.4, the data flows 2 and/or 4 can be used. In data flow 2, the robot 1 performs the image processing. In data flow 4, processing is split between the robot 1 (e.g., preprocessing) and the computing architecture 3110 (e.g., transformation). If both camera sets are used, onboard data might use flow 2 or 4, while external data might use flow 1, 5, or 6, potentially simultaneously. Processing image data from either or both camera sets can be performed by the robot 1's processing stack, the computing architecture 3110, or a combination thereof (split processing). The optimal dataflow choice depends on factors like camera type (vertical/horizontal), available compute power on the robot 1 vs. edge node, network bandwidth/latency, and whether camera data is desired for simultaneous robot control.

### c. Image Transformation Hardware

### i. Robot Only

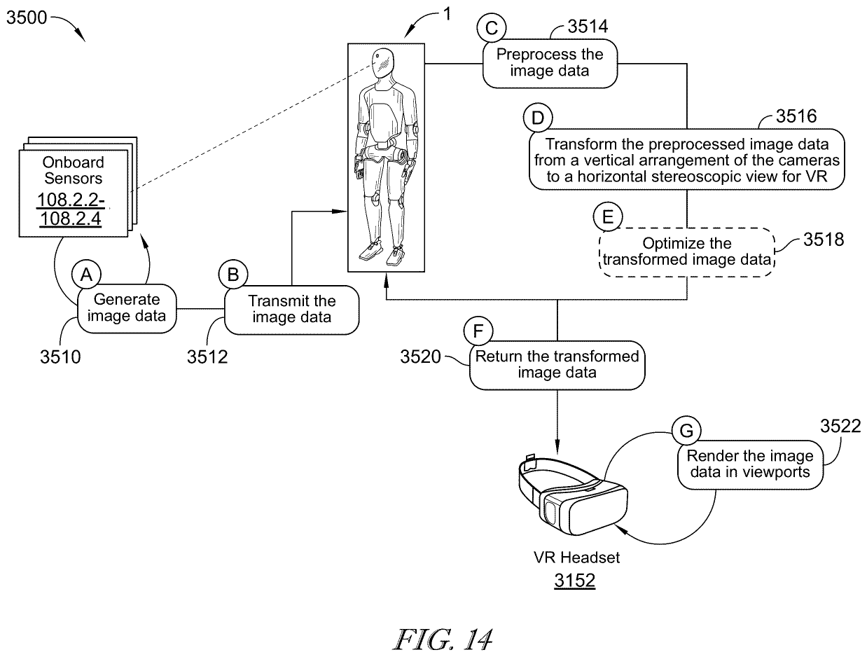

FIG. 14 is a conceptual diagram of a system 3500 for robot-based image transformation for a VR display 3150 of a VR headset 3152. In the system 3500, the robot 1, the onboard optical sensors (e.g., cameras) 108.2.2-108.2.4, and the VR headset 3152 can be in communication (e.g., wireless, wired) with each other. In the system 3500, processing can be performed locally at the robot 1's processing stack, which corresponds to the data flow 2 in FIG. 13. In further embodiments, the robot 1's processing stack may include a dedicated coprocessor or neural processing unit to handle the image transformation pipeline without preempting the locomotion and manipulation control threads.

The onboard sensors 108.2.2-108.2.4 can be configured to generate image data in block A 3510. The images can be generated as the robot 1 performs tasks in an environment and/or is controlled to perform the tasks in the environment. Refer to FIG. 18 for further discussion about the image data that can be generated. The onboard sensors 108.2.2-108.2.4 can then transmit the image data to the robot 1's processing stack (block B 3512).

The robot 1's processing stack can preprocess the image data in block C 3514. For example, the robot 1's processing stack can be configured to sync and/or align the image data. Preprocessing the image data can include but is not limited to adjusting the image data for a uniform perspective, fixing distortion across the image data, and/or fixing offset across the image data. In some implementations, the image data may already be horizontally-arranged, similar to viewports in the VR headset 3152. Accordingly, minimal preprocessing may be performed.

In block D 3516, the robot 1's processing stack can transform the preprocessed image data from a vertical arrangement of the onboard sensors 108.2.2-108.2.4 to a horizontal stereoscopic view for VR. For example, the robot 1's processing stack can convert or stitch together the vertical arrangement of images into the horizontal stereoscopic left eye/right eye configuration for the VR headset 3152. The robot 1's processing stack may perform other operations to transform or otherwise map the image data to the horizontal stereoscopic view of the viewports of the VR headset 3152.

Optionally, the robot 1's processing stack may optimize the transformed image data in block E 3518. For example, the robot 1's processing stack can apply latency-reduction techniques. The robot 1's processing stack can reduce resolution and/or frame size. The robot 1's processing stack may optimize algorithms for GPU and/or hardware processing acceleration. The robot 1's processing stack can implement encoding and/or transmission protocols.

The robot 1's processing stack can return the transformed image data to the VR headset 3152 (block F 3520). The transformed image data can be transmitted efficiently, such as through a low-latency wireless (and/or wired) connection. In further embodiments, the transmission may use a dedicated radio link operating at a carrier frequency separate from other wireless traffic to minimize interference.

The VR headset 3152 can render the image data in viewports in block G 3522. In other words, the VR headset 3152 can render the stereoscopic images in the VR headset 3152's viewports with minimal delay. For example, with less than 20 ms motion-to-photon latency. In some embodiments, the VR headset 3152 may additionally apply the display-side latency compensation stack described herein to reproject the received stereoscopic images to the current head pose at the display-refresh instant.

### ii. External Device or Edge Computer Only

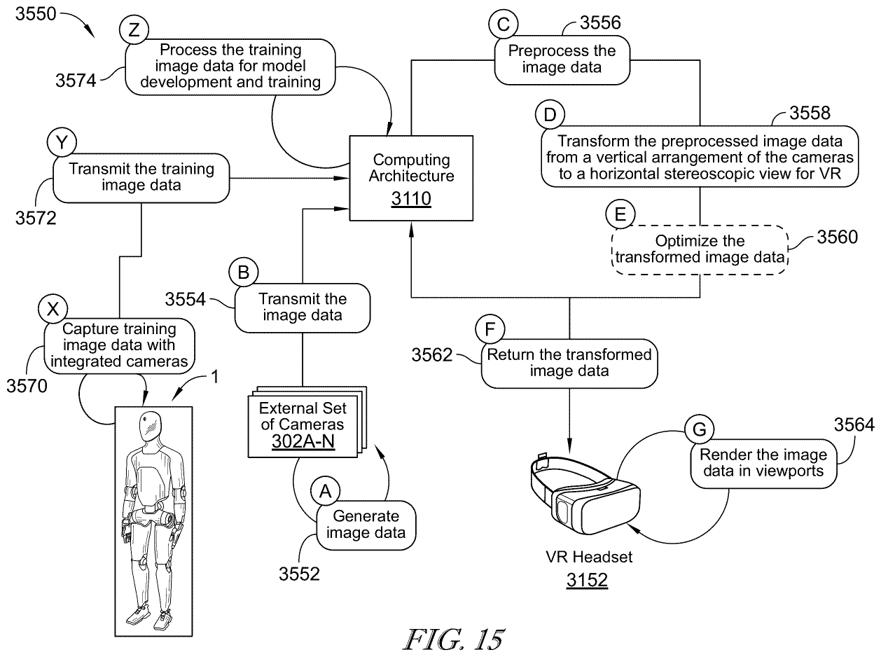

FIG. 15 is a conceptual diagram of a system 3550 for edge computing node-based image transformation for VR display. In the system 3550, all processing can be performed on the edge, at the computing architecture 3110, which can correspond to the data flows 1 and/or 5 in FIG. 13.

The computing architecture 3110 described herein can be a client-side computing device and/or an edge compute node. Sometimes, raw or minimally processed vertical camera streams can be transmitted directly to the client-side computing device, which can then perform additional operations such as intensive image reorientation, stereo processing, and/or rendering. Such operations can minimize local processing at the robot 1 and avoid latency from robot-side processing and/or encoding. Sometimes, this implementation may benefit from higher bandwidth connections and/or powerful client processing and compute abilities. Where the computing architecture 3110 is the edge compute node, the edge compute node can be computationally-powerful and can be placed close to the robot 1 within a network. The robot 1 and/or the cameras 302A-N can stream the raw image data directly to the edge compute node, which can be configured to perform the heavy vertical-to-horizontal transformations, stereo processing, and/or rendering. This configuration can keep processing off a potentially resource-constrained robot 1 while also minimizing network latency for the raw image data transfer.

In the system 3550, the robot 1, the external set of cameras 302A-N, the computing architecture 3110, and the VR headset 3152 can be in communication (e.g., wireless, wired) with each other. In some implementations, the computing architecture 3110 can be remote from or part of one or more components of the system 3550. The external set of cameras 302A-N can be configured to generate image data in block A 3552. The images can be generated as the robot 1 performs tasks in an environment and/or is controlled to perform the tasks in the environment. Refer to FIG. 18 for further discussion about the image data generated by the cameras 302A-N.

In some implementations, the system 3550 can demonstrate adaptive latency compensation. For example, the computing architecture 3110 may dynamically measure end-to-end latency and adjust overall system parameters accordingly. The adjusting can include adjusting a level of predictive strength, dynamically changing resolution, framerate, and/or compression level of images, switching between different mapping algorithms based on current latency (e.g., faster, lower-quality algorithm when latency spikes), adapting the robot 1's control responsiveness based on visual latency, and/or any combination thereof. The computing architecture 3110 can continuously measure the latency and adjust the system parameters in real-time, as operations described herein are being performed.

As shown in the example of FIG. 15, the external set of cameras 302A-N may transmit the image data directly to the computing architecture 3110 (block B 3554) instead of routing the data first through the robot 1's processing stack (refer to the dataflow 1 in FIG. 13). As a result, the speed of data transmission is faster than if the data were routed through the robot 1. The image data can be routed directly to the computing architecture 3110 and then the VR headset 3152 because the external set of cameras 302A-N are physically attached to the robot 1 but not electronically attached to the robot 1's processing stack.

In some implementations, if not bypassing the robot 1's stack entirely, a hardware path from the cameras 302A-N sensor output to a hardware encoder input of the computing architecture 3110 can be as direct as possible, minimizing memory copies and OS/middleware interaction using techniques like DMA (Direct Memory Access) and kernel bypass where feasible. With respect to kernel bypass, if infrastructure allows (e.g., compatible NICs, network configuration) and network latency is a bottleneck, DPDK and/or RDMA can be evaluated and implemented for significant data paths. This can offer maximum network stack performance but may benefit from some additional infrastructure investment. Moreover, if the image data passes through the robot 1's stack, then a real-time operating system (RTOS) can be used in the robot 1's processing unit to ensure predictable, low-jitter execution of capture, processing, and/or encoding pipeline(s).

The computing architecture 3110 can preprocess the image data in block C 3556. For example, the computing architecture 3110 can be configured to sync and/or align the image data. Preprocessing the image data can include but is not limited to adjusting the image data for a uniform perspective, fixing distortion across the image data, and/or fixing offset across the image data. In some implementations, the image data from the external set of cameras 302A-N may already be horizontally-arranged, similar to viewports in the VR headset 3152. Accordingly, minimal preprocessing may be performed.

In block D 3558, the computing architecture 3110 can transform the preprocessed image data from a vertical arrangement of the cameras 302A-N to a horizontal stereoscopic view for VR. For example, the architecture 3110 can convert or stitch together the vertical arrangement of images into the horizontal stereoscopic left eye/right eye configuration for the VR headset 3152. The architecture 3110 may perform other operations to transform or otherwise map the image data to the horizontal stereoscopic view of the viewports of the VR headset 3152.

Optionally, the computing architecture 3110 may optimize the transformed image data in block E 3560. For example, the architecture 3110 can apply latency-reduction techniques. The architecture 3110 can reduce resolution and/or frame size. The architecture 3110 may optimize algorithms for GPU and/or hardware processing acceleration. The architecture 3110 can implement encoding and/or transmission protocols.

The computing architecture 3110 can return the transformed image data to the VR headset 3152 (block F 3562). The transformed image data can be transmitted efficiently, such as through a low-latency wireless (and/or wired) connection. The VR headset 3152 can render the image data in viewports in block G 3564. In other words, the VR headset 3152 can render the stereoscopic images in the VR headset 3152's viewports with minimal delay. For example, with less than 20 ms motion-to-photon latency.

Additional operations may be performed by the computing architecture 3110, or at the robot 1 before, during, or after performing the blocks A-G 3552-3564. For example, cameras that are already part of or integrated into the robot 1 can capture training image data (block X 3570). The training image data can also be transmitted to the computing architecture 3110 (block Y 3572), which can also process the training image data for robot model development and training (block Z 3574). In some implementations, the image data generated by the external set of cameras 302A-N may also be used by the computing architecture 3110 to develop and train the robot control model(s) in block Z 3574. Sometimes, the training image data can be used in combination with the image data from the external set of cameras 302A-N to generate the horizontal stereoscopic view for display at the VR headset 3152 in block D 3558.

Sometimes, one or more additional processes and/or techniques can be implemented in the system 3550. For example, compressed neural representation streaming techniques can be performed, which can include real-time generation and streaming of compressed neural scene representations. Sometimes, this may call for additional onboard computation resources at the robot 1 and/or the computing architecture 3110. As another example, the system 3550 can incorporate light field (LF) display technology to provide the disclosed techniques. The LF technology can be used to reconstruct rich, multi-perspective views that simulate natural depth and parallax. By capturing and rendering the direction and intensity of light rays rather than flat images, light field systems enable more accurate spatial representation and view synthesis across different head positions. This allows vertically captured input to be reprojected and remapped into a wider horizontal field, aligning with the user's perspective in real time. The result can be a more immersive and natural visual experience in VR, with enhanced depth cues and seamless horizontal coverage, all while minimizing the need for extensive computational reprojection or view interpolation.

As yet another example, Gaze-Contingent Rendering, Optimized 3D Gaussian Splatting (3DGS), IMU-based Prediction, and RDMA networking can be combined to efficiently transform vertically captured images into a horizontally optimized format for VR display. Gaze-Contingent Rendering reduces computation by prioritizing detail only where the user is looking, while Optimized 3DGS synthesizes realistic scene geometry and appearance from sparse input views. IMU Prediction enables real-time pose estimation and correction, aligning rendered content with head motion for seamless immersion. Meanwhile, RDMA facilitates high-speed, low-latency data transfer across systems, ensuring synchronized delivery of visual updates. Together, these technologies enable responsive, bandwidth-efficient reformatting and streaming of vertical source images into immersive, wide-field horizontal layouts tailored for VR.

### iii. Hybrid or Split Between Robot and External Device

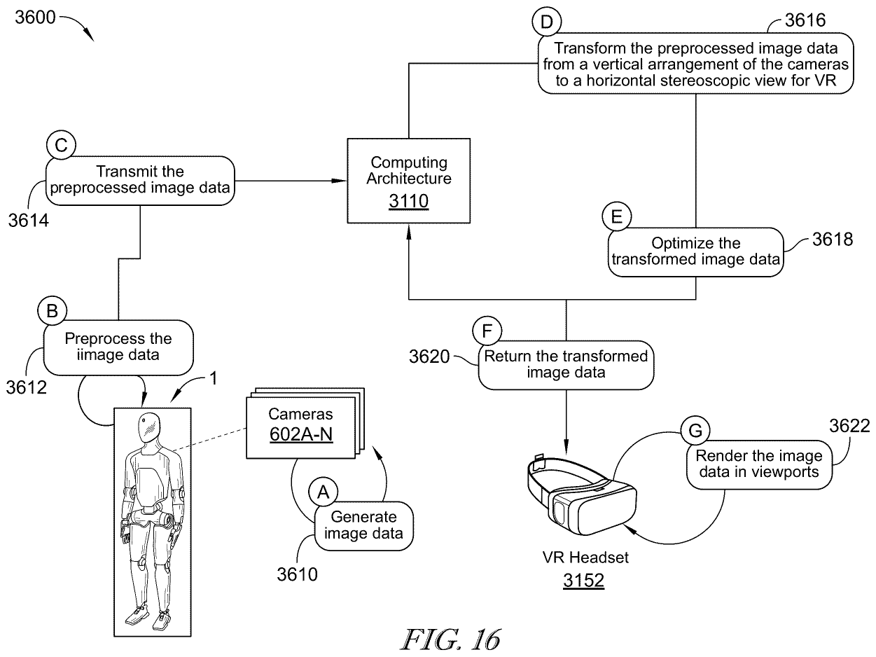

FIG. 16 is a conceptual diagram of a split processing architecture 3600 for transforming images for VR display. In the split processing architecture 3600, processing operations can be performed by both the robot 1's processing stack and the computing architecture 3110, which can correspond to the data flows 4 and/or 6 in FIG. 13. Operations described herein can be intelligently split. For example, images can be captured at the robot 1, the robot 1 can perform lens distortion correction, and the robot 1 may also calculate a sparse depth map. The computing architecture 3110 (which can be an edge node, cloud server, and/or client computing device) can perform additional operations such as vertical-to-horizontal re-projection of the images, dense stereo matching (if needed), and/or view synthesis and rendering. An optimal or preferred split of processing operations can vary based on available computational resources and network characteristics at each stage of performing said operations.

Although FIG. 16 depicts operations for transforming the images for the VR display, the operations of FIG. 16 can be performed in combination with other operations described herein, such as using the image data to develop and train robot control models (refer to blocks X-Z 3570-3574 in FIG. 15). In the example architecture 3600 of FIG. 16, some processing operations can be performed locally at the robot 1 while other operations can be performed remotely or on the edge at the computing architecture 3110.

Here, cameras 602A-N at the robot 1 can generate image data in block A 3610. The cameras 602A-N can include the external set of cameras 302A-N, the onboard robotic optical sensors 108.2.2-108.2.4, and/or any combination thereof. The image data can be preprocessed by the robot 1's processing stack in block B 3612. The robot 1 can then transmit the preprocessed image data to the computing architecture 3110 (block C 3614). The computing architecture 3110 can transform the preprocessed image data from a vertical arrangement of one or more of the cameras 602A-N to a horizontal stereoscopic view for the VR headset 3152 display (block D 3616). Optionally, the computing architecture 3110 may also optimize the transformed image data in block E 3618. The computing architecture 3110 can return the transformed image data to the VR headset 3152 (block F 3620), which can be configured to render the image data in the respective viewports (block G 3622).

### d. Image Transformation Process

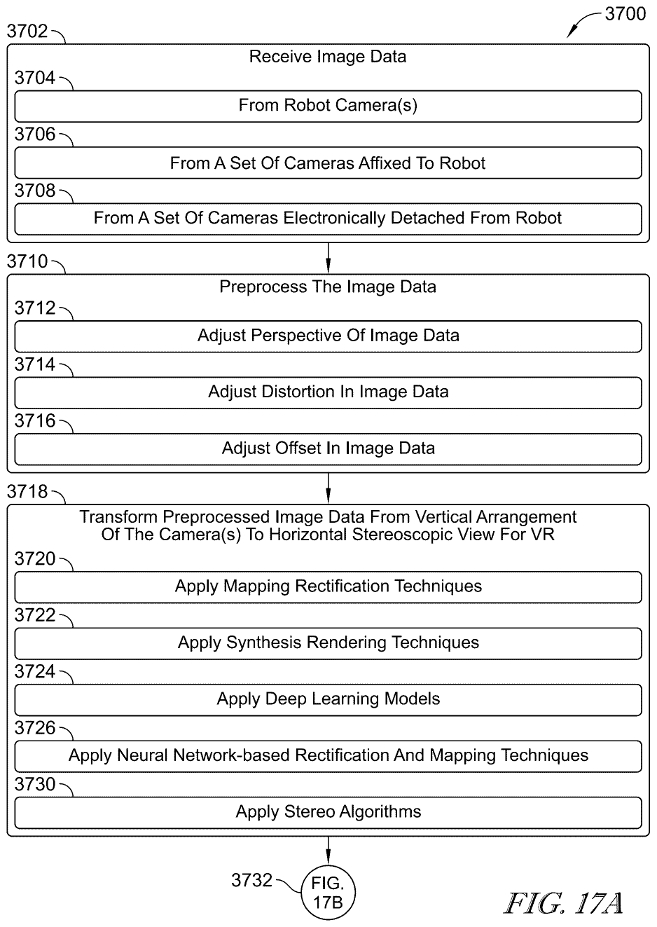

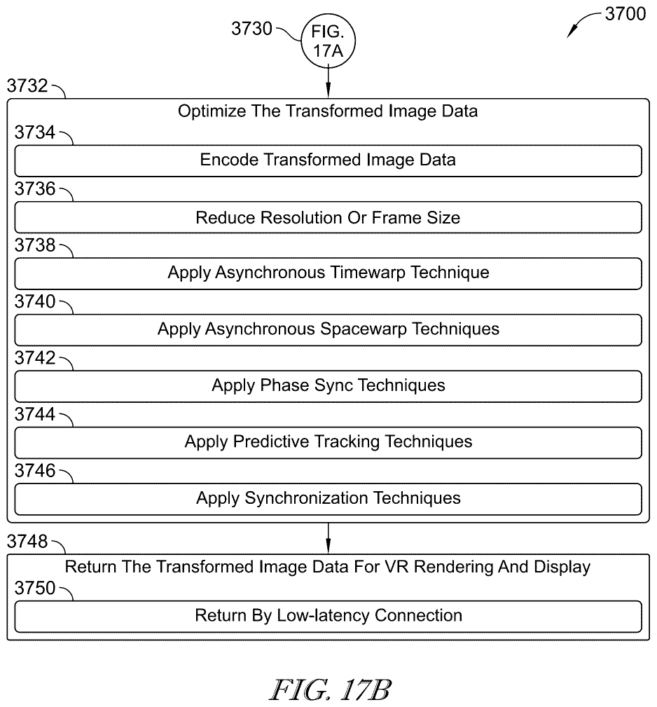

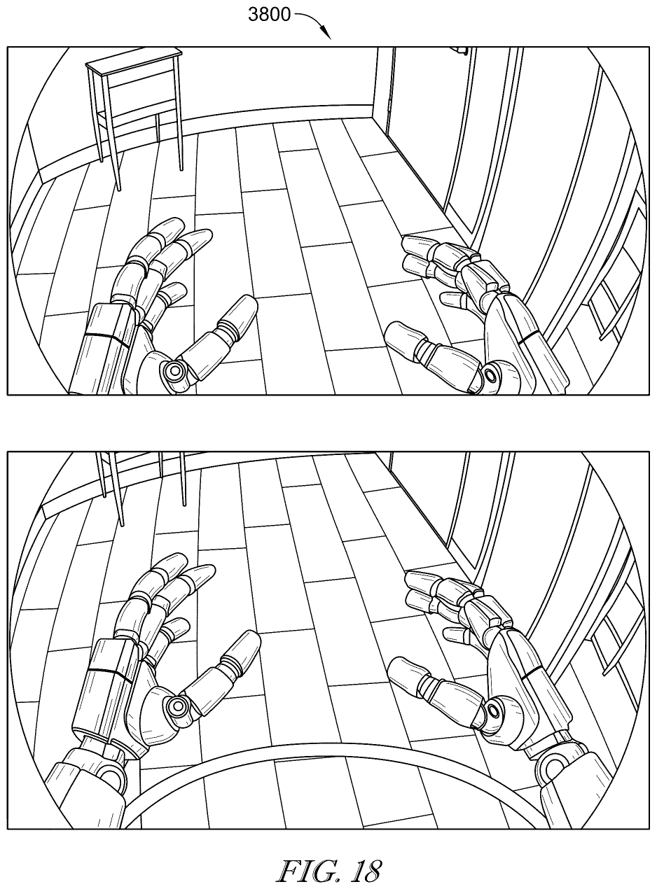

FIGS. 17A and 17B illustrate a flowchart of a process 3700 for transforming image data for VR display. The process 3700 can be performed by system components described herein, such as the computing architecture 3110 and/or the robot 1's processing stack. One or more operations in the process 3700 can additionally or alternatively be performed by other system components, including but not limited to edge compute nodes, client-side computing devices, the wearable training apparatus 3200, and/or any combination thereof. For illustrative purposes, the process 3700 is described from the perspective of a computing architecture.

Referring to the process 3700 in both FIGS. 17A and 17B, the computing architecture can receive image data in block 3702. The image data can be received from robot cameras (block 3704), a set of cameras affixed to the robot (block 3706), a set of cameras electronically detached from the robot (block 3708), and/or any combination thereof. For example, the computing architecture 3110 or the robot 1's processing stack can receive the image data generated by the external set of cameras 302A-N and/or the onboard robot optical sensors 108.2.2-108.2.4. Receiving the data directly from the cameras that are electronically detached from the robot 1 in block 3708 can drastically increase data transmission speed and thus resolve latency issues that arise when transmitting the image data from cameras, through the robot 1, and then to the computing architecture.

In some implementations, one or more of the cameras can have global camera shutters, which can expose all pixels simultaneously for a duration of exposure time and then read them out. This can ensure that a geometrically consistent snapshot of a scene can be captured at a single point in time. As a result, the global shutters can provide for eliminating motion artifacts even with fast movement. In implementations where processing is done locally at the robot 1, such as with the data flow 2 of FIG. 13, the image data can be received at the robot 1. In implementations where the processing can be done externally at the computing architecture 3110, such as with the data flows 4, 5, and/or 6 of FIG. 13, the image data can be received at the computing architecture 3110. In implementations where the processing is split, such as with the data flows 4 and/or 6 of FIG. 13, the image data can be received at the robot 1, then once the robot 1 processes the image data, the processed image data can be transmitted from the robot 1 to the computing architecture 3110 for further processing.

In block 3710, the computing architecture can preprocess the image data. For example, the computing architecture 3110 (or the robot 1's processing stack) can adjust a perspective of the image data (block 3712), adjust distortion in the image data (block 3714), adjust an offset in the image data (block 3716), and/or any combination thereof. In some implementations, the preprocessing can be performed by the onboard the camera(s) and/or the robot 1. FPGA's can be used for implementing parallel algorithms with high throughput and deterministic, low latency, often with lower power consumption compared to GPUs for equivalent tasks. They can be well-suited for regular, data-parallel computations found in stereo matching algorithms including but not limited to Semi-Global Matching (SGM) and/or hardware-adapted versions of Efficient Large-scale Stereo (ELAS). Disparity calculation latencies can occur at less than 2 ms at 60 fps. Hybrid onboard image processing may also be used, which can integrate multi-core CPUs alongside an FPGA fabric and/or GPUs on a single chip. This can allow for the hybrid approach, thereby partitioning a stereo vision pipeline so that computationally intensive, parallelizable tasks run on an accelerator (e.g., FPGA/GPU) while sequential logic, control, and/or higher-level processing runs on CPU cores.

In implementations where processing is done locally at the robot 1, such as with the data flow 2 of FIG. 13, the preprocessing of blocks 3710-3716 can be performed at the robot 1's processing stack. In implementations where the processing can be done externally at the computing architecture 3110, such as with the data flows 4, 5, and/or 6 of FIG. 13, the image data can be preprocessed at the computing architecture 3110. In implementations where the processing is split, such as with the data flows 4 and/or 6 of FIG. 13, the image data can be preprocessed at the robot 1.

The computing architecture can also transform the preprocessed image data from a vertical arrangement of the camera(s) to a horizontal stereoscopic view for the VR display (block 3718). The computing architecture can apply mapping verification techniques (block 3720), synthesis rendering techniques (block 3722), deep learning models (block 3724), neural network-based rectification and mapping techniques (block 3726), stereo algorithms (block 3730), and/or any combination thereof. In implementations where processing is done locally at the robot 1, such as with the data flow 2 of FIG. 13, the image data can be transformed at the robot 1. In implementations where the processing can be done externally at the computing architecture 3110, such as with the data flows 4, 5, and/or 6 of FIG. 13, the image data can be transformed at the computing architecture 3110. In implementations where the processing is split, such as with the data flows 4 and/or 6 of FIG. 13, the image data can be preprocessed at the robot 1, transmitted from the robot 1 to the computing architecture 3110, and then transformed by the computing architecture 3110 in blocks 3718-3730.

The mapping verification techniques (block 3720) can include rectification techniques. The rectification techniques can include but are not limited to Homography-Based Rectification/Warping, Distortion-Minimized Homographies, Polar Rectification/Log-Polar Transformation (e.g., instead of applying a single projective warp to the entire image, this techniques operates in a polar coordinate system centered at the epipoles), Cylindrical Projection/Warping, Spherical/Equirectangular Projection Mapping, Cube Map Projection Mapping, Stereographic Projection, Lens Distortion Correction Models (e.g., Brown-Conrady applied forward/inverse), Polynomial Warping Functions, Piecewise Affine/Perspective Warping (Mesh-Based), Look-Up Table (LUT) Based Hardware Acceleration (for any geometric warp), Online Flow-Guided Warping/Rectification (Deep Learning based), Online Adaptive Rectification Parameter Estimation (e.g., using Kalman Filters), Gaze-Aware Adaptive Warping (varying distortion based on gaze), Content-Aware Image Warping/Resizing Adaptations, Fisheye Lens Simulation/Rectification Models, and/or any combination thereof.

The Homography-Based Rectification, for example, can include computing a pair of homography matrices, HL and HR, that warp original left and right images (IL, IR) into rectified images (JL, JR) where epipolar lines can be horizontal and corresponding points share a same vertical coordinate. Various different methods can be used for the Homography-Based Rectification, including but not limited to Hartley's Method, Bouguet's Algorithm, Loop & Zhang's Method, Fusiello et al.'s Method, and/or any combination thereof. Hartley's Method is often based on the Fundamental Matrix. Bouguet's Algorithm can be implemented in widely used libraries such as OpenCV and MATLAB's Camera Calibration Toolbox. This algorithm typically uses full calibration data and includes parameters (like alpha) to control a trade-off between preserving image content and minimizing distortion/black areas. Loop & Zhang's Method can focus on minimizing perspective distortion by decomposing the homography and using numerical optimization. Fusiello et al.'s Method can provide a simpler approach that fixes a rectifying plane based on orientation of one camera.

The Distortion Minimization techniques can include a Loop & Zhang Metric, analytical solutions, geometric rotation minimization, and/or any combination thereof. The Loop & Zhang Metric can decompose H into projective, similarity, and shearing components. A metric can be defined to quantify a non-affineness (perspective distortion) introduced by a projective part. Numerical optimization (e.g., Levenberg-Marquardt) can also be used to find homography parameters that minimize this metric. These techniques can also include other closed-form (non-iterative) solutions that directly calculate the homography parameters minimizing the Loop & Zhang distortion metric. These can involve solving a quartic polynomial whose coefficients depend on camera geometry and image dimensions. This can avoid potential convergence issues and computational cost of iterative optimization. Multi-step methods can also minimize rotation angles involved in transforming the cameras to the rectified configuration, assuming smaller rotations lead to less distortion.

As described above, the mapping can be performed by applying LUT-Based (FPGA/ASIC) technique. Instead of calculating a source coordinate for each destination pixel using the homography matrix (or other transformation) in real-time, a mapping can be pre-calculated for all pixels and stored in a LUT. The LUT typically stores a displacement (or absolute source coordinate) for each pixel in the rectified image.

Online and Adaptive Rectification can also be performed as part of applying the mapping techniques. Camera calibration parameters (intrinsics and extrinsics) can drift over time due to factors such as vibrations, temperature changes, or mechanical stress. To address this, online or adaptive rectification methods can continuously estimate and update a relative camera pose (specifically a rotation component relevant for rectification) in real time. Said methods can utilize features extracted by a convolutional neural network (CNN) or other neural network, enhanced with positional encoding and processed through a transformer encoder (incorporating self- and cross-attention) to capture global and cross-view context. A correlation volume can be built from these enhanced features to represent matching likelihoods between the views. A decoder network can also process this volume to predict the relative rotation correction. Online and Adaptive (Flow-Guided DL) can sometimes use deep learning models to estimate the relative camera pose (specifically, the relative rotation R, as translation T is often assumed stable or less of focus for rectification) online. Key components often can include: feature extraction, feature enhancement, correlation volume, pose prediction, self-supervised loss (vertical flow), and/or any combination thereof. The CNNs can extract rich feature representations from the stereo images. Transformer architectures with self-attention and cross-attention mechanisms can enhance features by incorporating global and cross-view context, thereby improving matching robustness.

A volume representing a matching likelihood between features in the left and right images can be constructed. A decoder network can also be used to process the correlation volume to predict relative rotation, often as a correction to an initial estimate. A loss function can also be used based on minimizing the magnitude of the vertical component of the optical flow computed between the rectified images (using the predicted rotation). Since perfect horizontal rectification implies zero vertical disparity, minimizing vertical flow can serve as a dense, self-supervised signal for optimizing the predicted rotation, thereby eliminating the demand for ground truth poses during online operation. This loss can be adapted for vertical stereo by minimizing horizontal flow. Sometimes, frameworks such as Flow-Guided Online Stereo Rectification adapted for vertical baselines (minimizing horizontal flow) can be used. This can offer a robust, real-time alternative to complex view synthesis if visual quality is sufficient. This may rely on GPU resources on the robot 1.

In some implementations, the online and adaptive rectification can include Kalman filters. Kalman filters provide a framework for state estimation and sensor fusion. In the context of rectification or related pose estimation tasks, they can be used to: fuse estimates from different sources (e.g., visual features, optical flow, IMU data) to obtain a more robust and accurate estimate of the relative camera pose over time, combine drift-prone but low-noise measurements (like dense optical flow) with drift-free but potentially noisier measurements (like feature-based pose estimation or direct line detection) to mitigate drift while reducing noise, predict the state (e.g., relative pose) for the next time step, which can help in tracking or narrowing search spaces, and/or any combination thereof.

The synthesis rendering techniques (block 3722) can include but is not limited to Depth Image Based Rendering (DIBR), Light Field Rendering/Plenoptic Rendering, Multi-Plane Images (MPI)/Layered Depth Images (LDI), Neural Radiance Fields (NeRF) and Real-Time Variants (e.g., Instant-NGP, Plenoxels), 3D Gaussian Splatting (3DGS), Generative Adversarial Networks (GANs) for View Extrapolation/Inpainting, Diffusion Models for View Extrapolation/Inpainting, Image Warping with Learned Inpainting/Outpainting, Point-Based Rendering/Surface Splatting (from MVS or LiDAR data), Learned Monocular Depth Estimation (feeding into DIBR), Learned Multi-View Stereo (MVS) for Scene Reconstruction, 3D Panorama Stitching/View Morphing, General Neural Rendering Techniques (Implicit and Explicit Representations), Hybrid Approaches (e.g., DIBR+GAN Inpainting, MPI+NeRF refinement), Volumetric Video Representations, Environment Map Generation and Rendering (involving scene understanding), and/or any combination thereof. DIBR can involve projecting pixels from the source view into three-dimensional (3D) space using their depth values and then re-projecting these 3D points onto the image plane of the desired virtual camera. Light field rendering approaches view synthesis by capturing and representing a distribution of light rays in space. A light field can be thought of as a function that describes the radiance of light traveling along any ray, often parameterized by the ray's intersection with two planes (four-dimensional (4D) parameterization) or using other plenoptic function representations. MPI can represent a scene using a set of fronto-parallel planes positioned at different depths relative to a reference camera. Each plane can contain an RGBA image (color and alpha/transparency). This layered, camera-centric representation can model complex effects like transparency, reflections, and disocclusions more effectively than a single depth map.

Still referring to the synthesis techniques, NeRF can represent a scene implicitly using a deep multilayer perceptron (MLP). This network can map a 5D input coordinate (3D position x=(x, y, z) and 2D viewing direction d=(θ, φ)) to an output volume density (a) and view-dependent emitted radiance (color c=(r, g, b)). This approach may utilize multi-resolution hash grids to encode features, allowing smaller MLPs and enabling training in seconds to minutes and real-time rendering (tens to hundreds of FPS). Sometimes, this approach may include explicit voxel grids (Plenoxels) and/or factorizing the representation. Frameworks such as Nerfstudio can provide modular implementations of various NeRF techniques. PlenOctrees, for example, provides for pre-computing and storing the NeRF's output (color and density predicted using spherical harmonics) in an octree structure. This allows for real-time rendering (>150 fps reported) by replacing network queries with fast lookups. The main trade-offs can be potentially large memory demand and time to be used for the initial pre-computation (baking) step, which can make it less suitable for dynamic scenes. RT-NeRF, on the other hand, employs algorithm-hardware co-design. Algorithmically, it can use an efficient pipeline that directly computes geometry for pre-existing points (avoiding uniform sampling) and uses view-dependent ordering to skip occluded points. Hardware-wise, it can use a dedicated accelerator with hybrid sparsity encoding and specialized processing units. This can achieve real-time performance (~45 fps reported) on edge devices but may demand additional, specialized hardware. As yet another example, FoV-NeRF can be specifically designed for VR, and can incorporate gaze-contingent rendering based on human visual and stereoscopic acuity models. It renders a foveal region at high resolution and stereoscopically, while rendering the periphery monoscopically at lower resolutions. Combined with an egocentric neural representation using concentric spherical coordinates, it drastically reduces latency (from 9 seconds to 20 ms reported) but may sometimes rely on accurate, low-latency eye tracking.

3DGS is another synthesis technique that can represent a scene using large numbers (millions) of 3D Gaussian primitives. While methods like GaussianStreaming and 3DGStream exist, they often involve per-frame optimization, leading to reconstruction/update times of 10 seconds or more. Instant Gaussian Stream (IGS) aims to reduce this to ~2 seconds using a generalized motion network but still exceeds typical VR latency targets. SwinGS aims to improve streamability for long videos. 3DGS models can also be large, posing some challenges for storage and transmission in streaming scenarios. Techniques such as SRBF-Gaussian can use viewport-dependent color encoding (based on Spherical Radial Basis Functions and HSL color space) and adaptive transmission to reduce data volume and latency (7-59% reduction reported in cloud VR). GS-Cache can focus on optimizing large-scale 3DGS rendering specifically for VR, using cache-centric computation reuse and multi-GPU scheduling to achieve >120 fps for binocular 2K rendering in city-scale scenes. EvaGaussians can leverage event streams to improve 3DGS reconstruction quality from blurry input images, which can aid robustness in dynamic scenarios. Sometimes, real-time NeRF variants (like PlenOctrees if static scenes are acceptable, or gaze-contingent methods like FoV-NeRF) and/or optimized 3DGS streaming solutions (like GS-Cache or SRBF-Gaussian) can be used and/or benchmarked for the vertical-to-horizontal task. This can include integration and additional evaluation efforts.

PBR is another synthesis technique, which can use point primitives, often enhanced with attributes such as radius and normal (splats), as an explicit scene representation. Real time rendering can be possible, with frame rates of 55-100 fps for point clouds ranging from 1 million to 14 million points on older GPUs. PBR can be used in some teleoperation visualization systems. However, achieving high photorealism (complex lighting, reflections) can be more challenging than with ray tracing or neural rendering. A limitation for dynamic scenes may be the often significant preprocessing to be performed to generate point attributes (normals, radii) and build acceleration structures (e.g., octrees, k-d trees), which can take seconds to hours.

The deep learning models (block 3724) can include but are not limited to generative adversarial networks (GANs), diffusion models, hybrid approaches, and/or any combination thereof. Using large pre-trained diffusion models as priors can allow for improving robustness, handling sparse inputs, and enabling challenging synthesis tasks like extrapolation or 3D generation from text/images. This can include techniques for distilling knowledge from 2D diffusion models into 3D representations such as NeRF or 3DGS and using diffusion models for tasks like 3600 avatar generation or video viewpoint control. Given its success, there are additional improvements to 3DGS. The improvements can include reducing its memory footprint via compression, quantization, or pruning, improving geometric accuracy and enabling surface reconstruction through regularization or explicit surface modeling, extending it to handle dynamic scenes, object tracking, and physics simulation, enabling semantic understanding and segmentation within the Gaussian representation, and/or integrating it more tightly with SfM and/or SLAM pipelines. Unsupervised and Self-Supervised Dynamic Scene Modeling can also be used, thereby moving beyond reliance on pre-computed optical flow or depth maps for supervising dynamic scene reconstruction is an active area.

Said approaches can include designing unsupervised consistency losses (e.g., surface consistency, multi-view consistency) to implicitly learn scene flow and geometry from monocular video alone. Bootstrapping techniques, where synthesized novel views are fed back into the training pipeline to augment sparse input data, can also be used for methods such as 3DGS. Developing models that can perform novel view synthesis on unseen scenes without involving lengthy per-scene optimization remains a goal. This often can include learning scene-agnostic feature representations or meta-learning strategies. Exploring combinations of explicit and implicit representations continues. Structural MPI (S-MPI), for example, can use posed planar primitives that better approximate scene geometry than standard fronto-parallel MPIs, thereby bridging view synthesis and 3D reconstruction.

The neural network-based rectification and mapping techniques (block 3726) can include but are not limited to stereo compression/processing, MPI prediction, deep stereo matching, arbitrary view synthesis, and/or any combination thereof. With respect to stereo compression/processing, LLSS (Low-Latency neural codec for Stereo video Streaming) can employ a parallel architecture with two branches (left/right view) and a BiShiftMod module. This module can handle disparity through learned feature shifting, enabling parallel processing and minimizing latency for stereo video compression. While focused on compression, its parallel design and implicit disparity handling can lead to architectures for low-latency view synthesis. HESIC can use a deep regression network to estimate a homography matrix for warping one view towards the other, primarily for compression, but demonstrating learned geometric transformation. Networks have also been designed to predict MPI representations directly from stereo pairs or even single images, which can then be rendered efficiently. Deep neural networks for stereo disparity estimation may also be used. These networks often employ cost volumes (measuring similarity between features at different disparities) processed by 3D convolutions. While primarily focused on depth estimation, the accurate disparity maps produced can serve as input to a DIBR-like view synthesis stage. Some architectures can be designed for efficiency and/or real-time performance on mobile devices. Some networks can also be used to synthesize novel views directly from single or multiple input images without necessarily relying on intermediate representations like MPI or NeRF.

The stereo algorithms (block 3730) can be adapted or chosen based on their hardware compatibility with the disclosed systems. Traditional local methods can be used, which can compute disparity based on comparing small local windows around pixels in left and right images. Examples can include but are not limited to Sum of Absolute Differences (SAD), Sum of Squared Differences (SSD), Normalized Cross-Correlation (NCC), and Census Transform. Semi-Global Matching (SGM) techniques can be used, which can approximate a global energy minimization by aggregating matching costs along multiple 1D paths (typically 4, 8, or 16 directions) across the image. Efficient Large-scale Stereo (ELAS) can be used, which can operate by first identifying a sparse set of reliable support points using robust matching, then triangulating these points to form slanted plane priors, and finally propagating disparities based on these planes. Deep learning techniques can also be used, which may involve learning feature representations, constructing a cost volume, and using 3D convolutions or recurrent refinement mechanisms to regress the final disparity map. Hybrid methods, which combine traditional methods (like SGM or ZNCC for initial cost/disparity estimation) with a lightweight DL network for refinement and upsampling, can be used to offer a way to balance speed of traditional methods with accuracy of deep learning. Self-supervised methods can aim to train networks without calling for ground-truth depth data, which can be challenging to obtain.

The computing architecture 3110 may also optimize the transformed image data in block 3732. The computing architecture 3110 can encode the transformed image data (block 3734), reduce a resolution or frame size of the transformed image data (block 3736), apply asynchronous timewarp (ATW) techniques (block 3738), apply asynchronous spacewarp (ASW) techniques (block 3740), apply phase sync techniques (block 3742), apply predictive tracking techniques (block 3744), apply synchronization techniques (block 3746), and/or any combination thereof. In implementations where processing is done locally at the robot 1, such as with the data flow 2 of FIG. 13, the optimizations can be performed by the robot 1's processing stack. In implementations where the processing can be done externally at the computing architecture 3110, such as with the data flows 4, 5, and/or 6 of FIG. 13, the optimizations can be performed by the computing architecture 3110. In implementations where the processing is split, such as with the data flows 4 and/or 6 of FIG. 13, the optimizations can be performed by the computing architecture 3110.

Encoding the transformed image data (block 3734) can include the use of video codecs. The video codecs can include but are not limited to H.264 (AVC—Advanced Video Coding), H.265 (HEVC—High Efficiency Video Coding), VP9, AV1 (AOMedia Video 1), H.266 (VVC), MJPEG, JPEG XS, TICO, Colibri, MPEG-4 Part 2, Theora, Proprietary Codec, and/or any combination thereof. For ultra-low latency where bandwidth can be less constrained, hardware-accelerated H.264 Baseline remains a strong contender. For bandwidth-constrained scenarios calling for high resolution, hardware-accelerated HEVC offers a good compromise. AV1 offers an improved efficiency but may pose challenges for real time embedded encoding. Sometimes, neural video codecs can be used. Leveraging deep learning for video compression is another avenue. Codecs such as LLSS are designed for low-latency stereo streaming. LLSS uses a bidirectional feature shifting mechanism to process left and right views in parallel, avoiding the sequential dependency of traditional stereo/multiview codecs. This parallel architecture can lead to faster inference (1.7× faster encoding/decoding reported compared to prior neural codec LSVC) and improved rate-distortion performance (e.g., 50.6% BD-rate savings over MV-HEVC on CityScapes). While not directly transmitting a scene representation, these codecs learn efficient latent representations for compression, potentially adaptable for the teleoperation context. Other work explores using autoencoders to compress prediction residuals in traditional codecs to improve quality and speed.

### e. Gaze-Contingent Three-Tier Foveated Encoding Ladder

In some implementations, foveated encoding can be used. Such encoding can include but is not limited to Gaze-Based Variable Quantization (QP) Mapping, Codec-Specific Region of Interest (ROI) Encoding, Multi-Resolution Tiling, Layered/Scalable Video Coding (SVC/SHVC) Adaptation, Encoding Based on Variable Rate Shading (VRS) Output, Contrast-Sensitivity Function (CSF) Based Perceptual Masking, Eccentricity-Based Quality Adjustment, Tile-Based Encoding with Differential Quality, Foveal Cropping/Focus Encoding, Hybrid Approaches Combining Rendering and Encoding Foveation, and/or any combination thereof. By tracking the user's gaze in real time, the system can identify the foveal region on the VR display of the VR headset 3152. The video encoder then can allocate more bitrate and computational resources to maintain high quality and resolution within this region, while progressively reducing the quality or resolution in the peripheral areas where the user's eye is less sensitive to detail.

In accordance with one aspect, the edge computing node comprises a gaze-contingent encoder configured to partition the horizontal stereoscopic viewport into three concentric regions defined by eccentricity relative to a current gaze point, the three concentric regions comprising a foveal region spanning an eccentricity below 5 degrees, a parafoveal region spanning an eccentricity of 5 to 15 degrees, and a peripheral region spanning an eccentricity exceeding 15 degrees, with each of the three regions encoded with independent codec parameters. The foveal region is encoded with an H.264 High profile at a bitrate of 50 Mbps and a quantization parameter of 18, the parafoveal region is encoded with an H.264 Main profile at a bitrate of 20 Mbps and a quantization parameter of 24, and the peripheral region is encoded with an H.264 Baseline profile at a bitrate of 10 Mbps and a quantization parameter of 28. The total bitrate of the composed stream thereby approaches 80 Mbps in an uncompressed equivalent while bandwidth consumption remains bounded, because the region with the highest bitrate and quality subtends only the central portion of the viewport corresponding to the foveal acuity of the operator. The three concentric regions with their corresponding codec profiles, bitrates, and quantization parameters form a gaze-contingent encoding ladder that aligns codec expenditure with perceptual sensitivity, such that bandwidth is concentrated at the fovea where operator acuity is highest.

The VR headset 3152 comprises an eye tracker operating at 240 Hz and coupled to a gaze-prediction module configured to forecast a gaze point 50 ms in advance of a display-refresh instant using a Kalman filter incorporating a non-linear saccade detection model. The 240 Hz sampling rate and the 50 ms forecast horizon are selected because this combination of measurement rate and prediction window matches the median latency from gaze measurement to the encoder adjusting the boundaries of the three concentric regions, which results in foveal bits being allocated to the region the operator is actually looking at when each frame appears on the VR headset 3152. The eye tracker samples at 240 Hz because samples more frequently than the display refresh rate allow a Kalman filter to update its gaze estimate multiple times per frame, and this oversampling produces a prediction error substantially below the foveal boundary radius. The non-linear saccade detection model in the Kalman filter segments gaze trajectories into fixation, smooth pursuit, and saccade phases, applying phase-specific motion models that accommodate the characteristic velocity profiles of each phase.

The horizontal stereoscopic viewport, the three concentric regions, the eye tracker and the gaze-prediction module operate in cooperation to maintain bounded bandwidth while delivering foveal-quality imagery at the point of regard. The viewport provides the per-eye imagery, the three concentric regions assign codec parameters to each eccentricity band, and the eye tracker combined with the gaze-prediction module provides the real-time gaze point that positions the region boundaries within the viewport. Together, these elements may satisfy the bandwidth-constrained high-acuity delivery requirement because the gaze-prediction module compensates for the end-to-end latency of the encoding and transport path, such that by the time a frame reaches the VR headset 3152, the foveal region overlaps with where the operator is fixating. In another embodiment, the gaze-prediction module may implement an LSTM network trained on 10,000 or more recorded gaze trajectories, with the LSTM forecast substituted for or combined with the Kalman filter forecast.

### f. Pose-Triggered Predictive Rendering and Cache Management

In accordance with another aspect, the edge computing node further comprises a predictive rendering module coupled to an inertial measurement unit of the VR headset 3152, the predictive rendering module configured to: (i) receive a measured head-pose sample from the inertial measurement unit, (ii) forecast a plurality of candidate head-pose trajectories over a prediction horizon of 20 ms, (iii) render, from the three-dimensional Gaussian splatting representation or the multi-resolution hash grid representation stored in a representation cache, a plurality of stereoscopic viewports corresponding to the candidate head-pose trajectories, (iv) store the rendered stereoscopic viewports in a frame cache, and (v) select, at a display-refresh instant, a rendered stereoscopic viewport corresponding to a measured head pose most proximate to one of the candidate head-pose trajectories. The predictive rendering module is further configured to invalidate the representation cache responsive to a translational motion measurement exceeding 1 cm or a rotational motion measurement exceeding 1 degree, the invalidation triggering a rebuild of the three-dimensional Gaussian splatting representation or the multi-resolution hash grid representation from fresh image data from the vertical-arrangement stereo camera pair. The translational threshold of 1 cm is selected because translational head motions below 1 cm produce parallax shifts below the perceptibility threshold for VR headset resolutions, such that the cached representation remains valid, and the rotational threshold of 1 degree is selected on similar perceptibility grounds. The prediction horizon of 20 ms is selected because this horizon corresponds to the median end-to-end latency from pose measurement to frame display, such that the pre-rendered viewport matches the head pose at the display instant to within sub-degree error.

In a further embodiment, the predictive rendering module renders the plurality of stereoscopic viewports concurrently on the graphics processing unit using a tile-based splatting pipeline that exploits the shared representation cache across the candidate head-pose trajectories. The plurality of stereoscopic viewports, the representation cache, and the frame cache operate in cooperation to hide transport and render latency behind local head motion. The predictive rendering module contributes anticipation of the head pose at the display instant; the representation cache contributes reuse of the volumetric scene representation across multiple candidate viewports; and the frame cache contributes the pre-rendered viewports ready for immediate display. Together, these elements may satisfy the low-latency, high-fidelity rendering target because pre-rendering multiple candidate viewports within a bounded motion envelope is less expensive than repeatedly transporting and rendering from scratch under each candidate pose.

The predictive rendering module further invalidates the representation cache responsive to the robot 1 undergoing a base-frame translation exceeding a translational threshold, such that the cached volumetric representation remains consistent with the most recent camera viewpoints from the vertical-arrangement stereo camera pair. In yet a further embodiment, the predictive rendering module may implement a hierarchical cache in which a coarse volumetric representation is retained across larger translational motions and a fine volumetric representation is invalidated more aggressively, the hierarchical cache permitting rapid recovery of an approximate viewport while the fine representation is being rebuilt.

### g. Prediction and Synchronization

ASW (block 3740) and motion smoothing are advanced techniques designed to handle situations where the application consistently fails to meet the target frame rate (e.g., running at 45 fps instead of 90 fps). When triggered (typically by detecting consistently low frame rates), ASW can force the application to render at a lower, fixed rate (commonly half the display refresh rate, e.g., 45 Hz for a 90 Hz display). It then synthetically generates the missing intermediate frames. Unlike ATW, which re-uses a previous frame, ASW can attempt to extrapolate motion based on the two most recent rendered frames and the user's head tracking data (both rotation and translation) to create a plausible new frame. The original ASW (1.0) relied only on color information from previous frames, which could lead to noticeable visual artifacts (warping, ghosting) especially around object edges or during complex motion. ASW 2.0 significantly improves quality by utilizing depth buffer information provided by the application, allowing for more accurate extrapolation that accounts for scene geometry and parallax. Positional Timewarp (PTW) is an extension that uses depth information to add high-quality positional correction even for single dropped frames, similar to how ATW handles rotation. Accordingly, ASW allows users to experience a perceptually smooth (e.g., 90 Hz) display rate even when the underlying application may be rendering significantly slower (e.g., 45 Hz), making demanding VR experiences accessible on less powerful hardware or enabling higher graphics settings.

Phase sync (block 3742) and low persistence displays are techniques relating to the timing of the rendering pipeline and the physical characteristics of the VR display itself. Modern VR headsets utilize low persistence displays (often OLED or fast-switching LCDs). Instead of keeping pixels illuminated for the entire duration of a frame (e.g., 11.1 ms at 90 Hz), the display is only lit for a brief period (e.g., <2 ms). Phase sync and similar scheduling techniques are scheduling mechanisms within the VR runtime that aim to precisely coordinate the timing of all pipeline stages—sensor reading, simulation/application logic, rendering, warping (ATW/ASW), and display scanout. The goal is to minimize the latency between when the head pose is predicted and when the corresponding photons are emitted, ensuring that the image generation process uses the most up-to-date information possible at each step and that the final warp occurs just in time for the display refresh.

The predictive tracking techniques (block 3744) can include but are not limited to Head Motion Pose Prediction (6DoF—Rotation & Position), Gaze Point Prediction (Eye Tracking based), Controller/Hand Pose Prediction, Kalman Filtering (including EKF, UKF) for State Estimation and Prediction, Machine Learning-Based Prediction Models (e.g., LSTMs, Neural Networks), Simple Motion Extrapolation Models (Constant Velocity/Acceleration), Sensor Fusion for Robust Tracking Input (IMU, Optical Tracking, etc.), Adaptive Prediction Algorithms (adjusting based on user/latency), Predictive Rendering (using predicted pose for frame generation), Integration of Eye-Tracking Data for Enhanced Pose Prediction, Late Pose Latching for Rendering/Warp Stages, Body/Limb Pose Prediction (for full-body avatars or interaction), and/or any combination thereof. Briefly, predictive warping based on robot head IMU data can be implemented as an additional corrective step to compensate for residual latency of a chosen view synthesis/rectification pipeline.

With head motion prediction, before rendering a frame, the VR runtime uses algorithms (often based on Kalman filters or other time-series prediction methods) to estimate the user's head position and orientation at the future moment when the frame will actually be visible on the display (e.g., after rendering and display delays). The scene can then be rendered using this predicted pose, rather than the pose measured at the start of the rendering process. Advantageously, when the prediction is accurate, this technique significantly reduces the perceived latency associated with head movements, making the virtual world appear more stable and responsive. Measurements show that effective prediction can reduce perceived MTP latency from tens of milliseconds down to the low single-digit or low-teen milliseconds once the user's motion pattern is established.

In some implementations, robot-side predictions may also be generated. Prediction can be implemented not only on the VR client (head motion) but also on the robot side. The user's future head pose can be predicted based on received tracking data and latency measurements. The robot 1 can then start rendering or processing the view for that predicted future pose, effectively hiding some of the round-trip latency.

With predictive displays, instead of directly displaying the delayed video feed from the robot 1, the operator's interface renders a predicted view of the remote environment and the robot's state. This prediction can be generated immediately based on the operator's control commands and a model of the robot's dynamics and potentially the environment. The delayed video feed from the actual robot 1 might be used to update the model or could be overlaid on the predictive display to provide grounding in reality. Some systems may show a ghost or virtual preview of the robot's commanded pose before execution. The predictive model can range in complexity. Early systems used pre-defined wireframe models of the robot 1 and known objects. More advanced approaches use online computer vision techniques to build 3D models of unknown environments from the robot's camera feed in real-time. RGB-D sensors can also provide input for modeling. Neural rendering techniques offer possibilities for synthesizing novel predicted views based on learned models. Advantageously, predictive displays provide the operator with immediate visual feedback corresponding to their control inputs, mitigating the disorienting effects of communication delay and reducing the drive for inefficient move-and-wait control strategies. This can significantly improve task performance, control stability, and the operator's sense of presence.

In some implementations, context-aware encoding can be used. This approach can adapt video encoding parameters based on the content of the video itself or the context of its use. Techniques like Brightcove's Context-Aware Encoding (CAE) can analyze complexity of each video segment (e.g., high-motion sports vs. simple animation) and generate a custom Adaptive Bitrate (ABR) ladder. This can avoid using a one-size-fits-all ladder, resulting in more consistent quality across different content types and significant reductions in storage and bandwidth usage (up to 50% claimed) for a same perceptual quality. Task-adaptive encoding can also be performed. Encoding parameters can be adjusted based on the teleoperation task or robot state. For example, video quality or frame rate could be selectively reduced when robot odometry indicates low motion or when the operator is not actively manipulating objects, conserving bandwidth without impacting task performance. Frame rates can also be adapted based on sender/receiver context or network conditions.

One or more other perceptual models can be employed for encoding purposes. For example, task context degradation can be performed, which can include intelligently degrading visual information deemed less significant for a current task. For instance, if the operator is focused on manipulating an object, the visual quality of the distant background can be reduced more aggressively than standard foveation might dictate. This can involve scene understanding and task awareness. Advanced acuity models can be used, which can move beyond simple concentric foveation regions by incorporating detailed models of human vision, such as the Contrast Sensitivity Function (CSF), which describes sensitivity to different spatial frequencies at various eccentricities. Predictive foveation can be used in some implementations, which can combine eye tracking with gaze prediction algorithms to anticipate where the user will look next. This allows the system to start rendering the predicted foveal region slightly ahead of time, helping to compensate for the inherent latency in the eye-tracking and rendering pipeline.

In yet some implementations, dynamic foveated rendering/compression techniques can be implemented, especially if eye tracking is available or feasible. Gaze-contingent techniques or context-aware encoding can be leveraged to significantly reduce processing and bandwidth load for the vertical-to-horizontal view synthesis pipeline. This offers substantial gains with relatively mature technology. Moreover, profile distance-based or foveated hybrid mono/stereo rendering techniques can be used. If a scene composition and rendering overhead allow for net performance gains, this can significantly reduce the GPU load for the stereo aspect.

Sometimes, performing the encoding can include using hardware encoders. Example hardware encoders include but are not limited to NVIDIA NVENC, AMD VCE/VCN, Intel Quick Sync Video (QSV), Qualcomm Snapdragon Hardware Encoders, MediaTek Hardware Encoders, Samsung Exynos Hardware Encoders (MFC), Apple Silicon Video Encoders, Rockchip VPUs, NXP i.MX Hardware Codecs, Texas Instruments (TI) Hardware Video Accelerators, Ambarella SoC Encoders, Socionext Encoder ASICs, FPGA-based Encoders, Custom ASIC-based Encoders, and/or any combination thereof. Software-based video encoding on general-purpose CPUs can typically be too slow and power-hungry for real time, low-latency streaming from embedded robotic platforms, especially for complex codecs or high resolutions.

As mentioned above, one or more additional or other techniques can be performed, including but not limited to ATW, ASW/Motion Smoothing/Frame Synthesis, Low Persistence Displays (OLED/LCD Strobing), Phase Sync/Synchronized Scanout/Backlight Timing, Head Motion Prediction/Pose Prediction (Rotation & Position), Positional Timewarp/Depth-Based Reprojection, Display Pixel Overdrive, Variable Refresh Rate (VRR) adapted for VR Displays, Single Pass Stereo/Multi-View Rendering Optimizations, Foveated Rendering (for reducing rendering load and latency), Latency Measurement and Reduction Frameworks/SDKs (e.g., NVIDIA Reflex), Predictive Rendering, Late Latching (Updating inputs just before rendering submission), and/or any combination thereof.

More specifically, ATW (block 3738) can be a fundamental technique designed to compensate for latency related to head rotation. Just before the VR display is about to refresh with a new frame, ATW takes the most recently completed rendered frame and geometrically re-projects (warps) it based on the absolute latest head orientation data obtained from the tracking system. This warping step can be computationally inexpensive compared to rendering the entire scene again. It runs asynchronously, meaning it operates in a separate, high-priority thread parallel to the main application rendering loop. Advantageously, if the main application fails to render a new frame in time for the display's refresh deadline (e.g., it drops a frame), ATW steps in. Instead of displaying an old, incorrectly oriented frame or causing a noticeable stutter, it can display the previous frame warped to match the user's current head orientation. This significantly can reduce perceived latency and judder associated with rotational head movements, effectively decoupling the visual experience of looking around from the application's raw frame rate. ATW can act as a safety net for maintaining visual stability during occasional performance dips.

The synchronization techniques (block 3746) can include but are not limited to IEEE 1588 (Precision Time Protocol—PTP), NTP (Network Time Protocol), gPTP (IEEE 802.1AS/TSN Synchronization), GPS/GNSS-based Time Synchronization, White Rabbit Protocol (WR), 5G Network Synchronization Mechanisms (from base station), Wi-Fi Timing Synchronization Function (TSF—within BSS), Custom Application-Level Time Synchronization (e.g., RTT-based offset estimation, timestamping), Hardware Triggering/Dedicated Sync Lines (for intra-system synchronization, e.g., sensors on robot 1), Event-Based Synchronization (using shared signals or markers), and/or any combination thereof. IEEE 1588, commonly known as the Precision Time Protocol (PTP), is a network protocol designed to achieve high-precision clock synchronization among devices connected via Ethernet. PTP can operate on a primary-secondary (master-slave) architecture. Devices exchange a series of timestamped messages (Sync, FollowUp, DelayReq, Delay_Resp). By comparing the timestamps of when these messages are sent and received at both the primary and secondary clocks, the secondary device can calculate both the offset between its clock and the primary's clock, and the network propagation delay between them. The secondary clock then adjusts its own time and/or frequency to align with the primary. A key assumption is that the network path delay is symmetrical in both directions. PTP networks typically use Best Master Clock (BMC) algorithm. Each PTP-enabled device advertises the quality of its own clock, and the algorithm automatically selects the highest-quality clock within a network segment to act as the grandmaster clock, to which all other clocks synchronize. A dedicated grandmaster clock device, often synchronized to GPS time, can be used to provide a real-world time base if desired. PTP can achieve synchronization accuracy in the microsecond or even nanosecond range, significantly better than protocols like NTP (Network Time Protocol) which typically operate at the millisecond level.

Achieving the highest precision generally demands hardware support. PTP-aware network interface cards (NICs) and switches can timestamp PTP packets at the physical layer, avoiding unpredictable delays introduced by operating system stacks. Special PTP-aware switches, known as Boundary Clocks or Transparent Switches, can further improve accuracy in larger networks by actively participating in the protocol to measure and compensate for the time PTP packets spend traversing the switch itself. The GigE Vision standard, commonly used for industrial cameras, includes support for IEEE 1588 timestamps, facilitating synchronization of camera networks. Advantageously, PTP provides a standardized way to achieve precise time synchronization across distributed Ethernet-based systems with relatively low network overhead. This enables accurate timestamping of events (like camera triggers or sensor readings), precise coordination of actions across multiple devices (e.g., triggering cameras simultaneously), reduced system jitter, and more predictable throughput.

One or more other mapping and synthesis techniques may be performed in the process 3700. For example, direct vertical rendering in VR can be performed. Instead of converting the vertical stereo pair to a virtual horizontal pair before rendering, rendering techniques that can directly consume the vertically offset views can be performed. This may involve custom shaders or rendering pipelines within the VR environment that understand the vertical baseline geometry and perform the called—for perspective corrections and interpupillary distance (IPD) adjustments directly during the final rendering pass. This can avoid an intermediate synthesis/rectification step.

As another example, a hybrid synthesis rectification process can be performed by combining lightweight rectification with more advanced synthesis. A rough, computationally less expensive rectification (e.g., simple rotation/translation) can be performed to get closer to a horizontal alignment, and then a faster view synthesis technique (perhaps AI-based) primarily for correcting the remaining distortions and disocclusions can be performed, rather than generating the entire view from scratch.

As yet another example, an intermediate representation transmission can be performed. Instead of sending fully rendered left/right eye views, the robot 1 can process the vertical stereo pair into an intermediate representation like a textured mesh, a point cloud, or a multi-plane image (MPI) representation derived from the vertical baseline. This representation can then be transmitted, and the VR headset 3152 can perform the final rendering from the correct horizontal viewpoints based on the user's IPD and head pose. This shifts some computational load (final view generation) to the VR client but potentially reduces the complexity of the data transmitted.

Sometimes, AI-based direct transformation can be performed. A neural network can be trained to take the raw vertical stereo pair as input and directly output the horizontal stereo pair that corresponds to the VR headset 3152 viewports. This end-to-end approach can learn efficient transformations that bypass traditional geometric pipelines, potentially running faster on compatible hardware (like NPUs or GPUs).

In block 3748, the computing architecture 3110 can return the transformed image data for VR rendering and display. For example, the computing architecture 3110 can return the transformed image data by a low-latency connection (block 3750). In implementations where processing is done locally at the robot 1, such as with the data flow 2 of FIG. 13, the transformed image data can be provided by the robot 1 to the VR headset 3152. In implementations where the processing can be done externally at the computing architecture 3110, such as with the data flows 4, 5, and/or 6 of FIG. 13, the transformed image data can be transmitted by the computing architecture 3110 to the VR headset 3152. In implementations where the processing is split, such as with the data flows 4 and/or 6 of FIG. 13, the transformed image data can be transmitted by the computing architecture 3110 to the VR headset 3152.

### h. Network Protocols Used in the System

One or more different network protocols can be used to perform the disclosed techniques. Any of these network protocols can be used to provide reliable, low-latency communications between the onboard robot optical sensors 108.2.2-108.2.4 and the robot 1's processing stack (as in the data flows 2 or 4 in FIG. 13), the robot 1 and the computing architecture 3110 (as in the data flows 4 or 6 in FIG. 13), the robot 1 and the VR headset 3152 (as in the data flows 2 or 4 in FIG. 13), the external set of cameras 302A-N and the robot 1 (as in the data flow 6 of FIG. 13), the external set of cameras 302A-N and the computing architecture 3110 (as in the data flow 5 of FIG. 13), the external set of cameras 302A-N and the wearable training apparatus 3200 (as in the data flow 3 of FIG. 13), the external set of cameras 302A-N and the VR headset 3152 (as in the data flow 1 of FIG. 13), the computing architecture 3110 and the VR headset 3152 (as in the data flows 3, 4, 5, or 6 of FIG. 13), the wearable training apparatus 3200 and the computing architecture 3110 (as in the data flow 3 of FIG. 13), the wearable training apparatus 3200 and the VR headset 3152 (as in the data flow 3 of FIG. 13), and/or any combination thereof.

For example, transport protocols can be used amongst any of the hardware components described above that include but are not limited to UDP (User Datagram Protocol), TCP (Transmission Control Protocol), WebRTC (Web Real-Time Communication), QUIC (Quick UDP Internet Connections), RTP (Real-time Transport Protocol), SRTP (Secure Real-time Transport Protocol), RTCP (RTP Control Protocol), SCTP (Stream Control Transmission Protocol), DDS (Data Distribution Service), UDT (UDP-based Data Transfer), RUDP (Reliable UDP—various implementations), Custom UDP-Based Protocols, and/or any combination thereof. While raw UDP offers the lowest overhead, its lack of reliability and congestion control can make it fragile over typical wireless networks. TCP's reliability mechanisms introduce unacceptable latency. WebRTC provides a complete low-latency P2P solution but can sometimes be complex. QUIC emerges as a strong candidate, offering a modem transport layer that balances low connection latency, HOLB mitigation, and essential reliability/security features, making it well-suited for robust, low-latency client-server video streaming called for in many teleoperation scenarios.

One or more wireless network technologies may be used to provide communication between any of the hardware components described above, which can include but are not limited to Wi-Fi 6/6E (IEEE 802.11ax), Wi-Fi 7 (IEEE 802.11be), 5G NR (including URLLC and Private 5G Networks), 6G (Future Research/Standard), WiGig (IEEE 802.11ad/ay), Wi-Fi 5 (IEEE 802.11ac), Free Space Optics (FSO), Li-Fi (Visible Light Communication), Proprietary Wireless Systems (Custom implementations, e.g., in specific frequency bands), and/or any combination thereof. Similarly, one or more quality of service (QoS) mechanisms can be used with the disclosed technology, including but not limited to Packet Classification (Flow ID, Deep Packet Inspection), Packet Marking (DSCP, 802.1p/CoS), Priority Queuing (PQ), Weighted Fair Queuing (WFQ), Class-Based Weighted Fair Queuing (CBWFQ), Low Latency Queuing (LLQ), Active Queue Management (AQM: e.g., RED, CoDel, PIE), Traffic Shaping (Rate Limiting, Smoothing), Traffic Policing (Dropping, Re-marking), Bandwidth Reservation Protocols (e.g., RSVP, NSIS), Explicit Congestion Notification (ECN), Wi-Fi Multimedia (WMM/EDCA —Access Categories ACVO, ACVI), Wi-Fi Admission Control (WMM-AC TSPEC), Wi-Fi Target Wake Time (TWT) Scheduling, Wi-Fi 7 Multi-Link Operation (MLO) QoS Features, Network Slicing (5G/Future Networks), Software-Defined Networking (SDN) based QoS Orchestration, Differentiated Services (DiffServ) Architecture, Integrated Services (IntServ) Architecture, End-to-End Congestion Control Algorithm Tuning (e.g., BBR), Forward Error Correction (FEC) Implementation, and/or any combination thereof. In networks carrying mixed traffic, QoS mechanisms may help to prioritize latency-sensitive streams, such as teleoperation video and control data, over less time-sensitive traffic (e.g., background updates, logging). Without QoS, congestion caused by other traffic can lead to increased latency, jitter, and packet loss for the teleoperation stream, degrading performance.

In some implementations, the network stack of the disclosed technology can be optimized for network communications between one or more of the hardware components described above. More specifically, a network transport layer can be optimized (e.g., UDP with appropriate handling, potentially WebRTC). OS-level tuning operations may also be performed for network latency reduction. Such tuning operations can include adjusting kernel parameters such as TCP window size and buffer limits to improve throughput and reduce packet loss, enabling interrupt coalescing to minimize CPU overhead, and/or configuring CPU affinity to dedicate processor cores to network handling tasks. Other optimizations may involve using real time scheduling policies to prioritize time-sensitive processes, disabling power-saving features that introduce latency, and/or tuning socket options like TCP_NODELAY to reduce delay in small packet transmission. Collectively, these adjustments can help ensure more consistent and lower-latency network performance, especially significant in high-throughput or time-sensitive applications like VR streaming.

In a specific embodiment, the transport path between the edge computing node and the VR headset 3152 comprises a QUIC transport with application-layer forward error correction and DSCP expedited-forwarding marking. The transport path is further coupled to a Wi-Fi 6E radio operating on a 160 MHz channel, or alternatively to a 5G ultra-reliable low-latency communication channel, the Wi-Fi 6E or 5G path selected to support the three-tier foveated bitrate ladder with bounded latency and bounded packet loss. In further embodiments, the transport path may include both a Wi-Fi 6E radio and a 5G URLLC channel operating in a dual-uplink configuration, with the gaze-contingent encoder distributing the foveal region traffic to a lower-loss path and the peripheral region traffic to a higher-loss path.

### i. Image Transformations

FIG. 18 illustrates example top and bottom images 3800 that can be captured using cameras on a robot 1. The top and bottom images 3800 can be captured by the cameras 108.2.2-108.2.4 of the robot 1, the external set of cameras 302A-N, and/or any combination thereof. In some embodiments, the images 3800 include capture timestamps, exposure parameters, and calibration metadata appended as ancillary data to each frame, such that downstream transformation stages have access to the metadata without separate metadata transport. The images 3800 may also include per-pixel depth data when the image data has been processed through the semi-global matching operation, such that the depth data flows alongside the color imagery to subsequent synthesis stages.

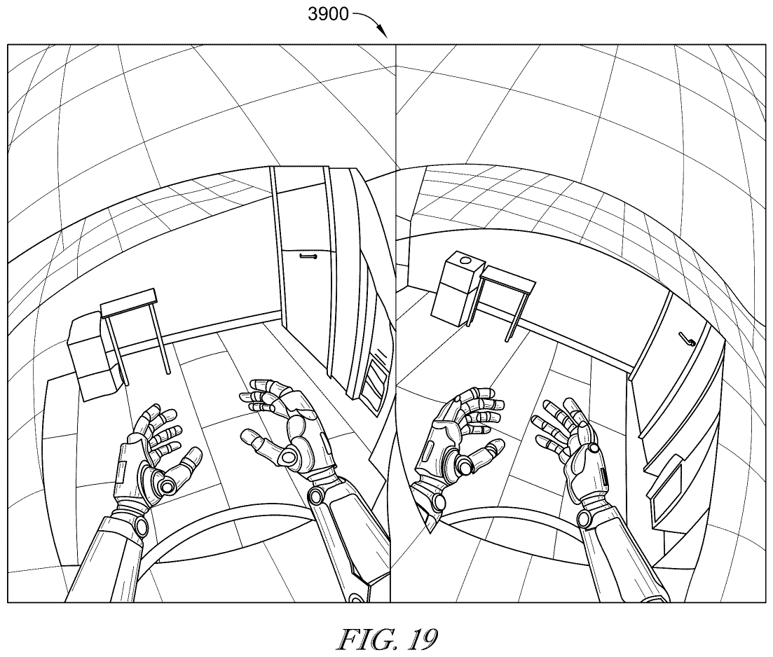

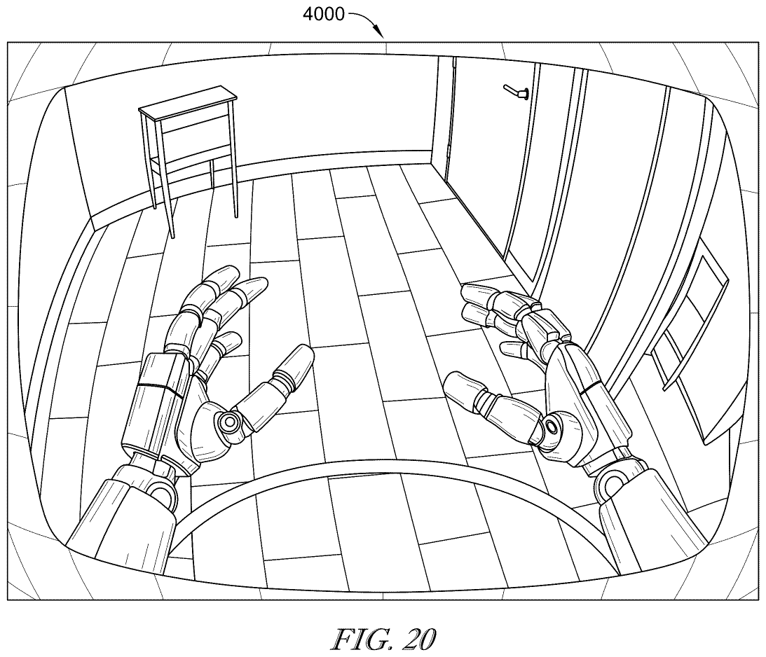

FIG. 19 illustrates an example of the images from FIG. 18 being transformed into stereo images 3900 on either side of viewports of a VR headset 3152. The images 3900 can be generated from the top and bottom images 3800 using the techniques described herein. Refer to at least FIGS. 14-16, 17A, and 17B for further discussion about transforming the images 3800 into the stereoscopic images 3900. The transformation from the top and bottom images 3800 to the stereo images 3900 may proceed through the semi-global matching operation, the homography-based rectification, and the neural view synthesis stages, with the specific combination of stages selected by the adaptive synthesis controller based on current telemetry. In further embodiments, the transformation may include a gaze-contingent spatial partitioning applied to the stereo images 3900 in accordance with the foveated encoding ladder described herein.

FIG. 20 illustrates an example view 4000 of what a user sees when wearing the VR headset 3152. More specifically, the view 4000 is shown in the VR headset 3152 based on rendering the images 3900 of FIG. 19 for display in the VR headset 3152. Refer to at least FIGS. 14-16, 17A, and 17B for further discussion about rendering the images 3900 to provide the view 4000 at the VR headset 3152. The view 4000 may incorporate the display-side reprojection of the images 3900 to the current head pose of the operator through the asynchronous time warp module, such that the view 4000 presents the stereo images 3900 with residual head-motion error within sub-pixel bounds at the viewport resolution.

### j. Alternative Embodiments

Further embodiments may employ hybrid camera configurations to optimize the visual data captured for VR teleoperation. Instead of relying solely on uniformly arranged vertical or horizontal camera pairs, the robot 1 may be equipped with a combination of cameras possessing different characteristics. For instance, a central camera with a wide field-of-view (FoV) could be paired with two peripheral cameras offering higher resolution but narrower FoV, potentially aligned horizontally. Data streams from these cameras could be intelligently fused or selected based on the operator's real-time gaze direction (if eye-tracking is available in the VR headset 3152) or the demands of the ongoing task. For example, the wide FoV stream might provide general situational awareness, while a peripheral high-resolution stream is prioritized and potentially processed with lower latency when the operator focuses on a specific area for manipulation. Such hybrid arrangements call for sophisticated image processing pipelines capable of dynamically selecting, potentially re-projecting, and seamlessly stitching or blending data from disparate camera sources to generate a cohesive and low-latency stereoscopic view for the VR display, balancing FoV coverage with detail acuity.

To enhance the immersive realism and responsiveness of the teleoperation system 3010, sensor fusion techniques may extend beyond visual and inertial data to incorporate other modalities, specifically influencing latency compensation mechanisms like Asynchronous Timewarp (ATW) or predictive tracking. Real-time haptic data relayed from the robot's actuators or contact sensors, indicating forces encountered during interaction, can be used to refine head pose predictions or anticipate subtle view shifts resulting from physical contact, thereby improving the accuracy of ATW warping. Similarly, spatial audio cues captured by the robot's microphones can inform the system about off-screen events, potentially allowing the rendering system to preemptively allocate resources or adjust prediction models for anticipated head turns towards the sound source. Integrating these diverse sensor streams demands robust time synchronization protocols (e.g., PTP) between the robot's sensors, the processing architecture, and the VR system, as well as fusion algorithms capable of weighting and combining multimodal inputs to generate more accurate and timely predictions for latency compensation, ultimately reducing perceived motion-to-photon latency and enhancing the operator's sense of presence.

In closed-loop teleoperation mode, the system may provide nuanced, real-time haptic feedback to the operator via actuators within the wearable training apparatus 3200, moving beyond simple binary contact indication based on exceeding force thresholds. This involves capturing detailed interaction data from the robot 1, including joint torques, motor currents, force/torque sensor readings at the end-effectors, and potentially tactile sensor data. This raw robot data is transmitted back to the computer 3110 or directly to the wearable apparatus 3200, where algorithms map specific patterns and magnitudes of force, torque, vibration, or texture data to corresponding haptic sensations generated by the apparatus's actuators (e.g., varying resistance profiles, specific vibration frequencies and amplitudes, texture simulation). Achieving a compelling and useful haptic feedback loop calls for a dedicated, low-latency data transmission channel for this haptic information, running in parallel with the visual data stream, and efficient processing algorithms to ensure the perceived haptic feedback is tightly synchronized with the visual display and the operator's actions, thereby enhancing the sense of embodiment and task performance.

To ensure safe and reliable operation, particularly during remote teleoperation over potentially unreliable networks, the system incorporates robust error handling and failsafe mechanisms. Continuous monitoring of network link quality (latency, jitter, packet loss) between the operator station (wearable apparatus 3200, VR headset 3152, computer 3110) and the robot 1 is performed. If link quality degrades below predefined thresholds, the system may initiate graceful degradation protocols, such as reducing video resolution or frame rate, decreasing the fidelity of haptic feedback, or increasing the latency tolerance of control loops, to maintain basic functionality. In the event of a complete loss of communication or significant component failure (e.g., VR headset disconnection, processing node failure), predefined failsafe behaviors are triggered. These may include commanding the robot 1 to immediately halt all motion, enter a stable and safe static pose, revert to a limited autonomous mode based on its last received command or environmental perception, or execute a specific emergency shutdown procedure. Protocols for automatically attempting connection re-establishment and secure handover of control upon link restoration are also implemented to minimize downtime and ensure operational continuity.

An alternative or supplementary approach to minimizing latency involves utilizing event cameras paired with neuromorphic processing techniques. Unlike traditional frame-based cameras that capture entire images at fixed intervals, event cameras asynchronously output sparse streams of “events,” each signifying a logarithmic change in brightness at a specific pixel location and time, often with microsecond resolution. This bio-inspired sensing modality drastically reduces redundant data transmission and inherently captures motion information with very low latency. These sparse event streams are particularly well-suited for processing by Spiking Neural Networks (SNNs) running on specialized neuromorphic hardware (e.g., Intel Loihi, BrainChip Akida), which operate asynchronously and consume power primarily when processing incoming events. A potential system architecture involves using event streams to drive an ultra-low latency view synthesis or pose tracking pipeline, potentially generating wireframe or edge-based updates for the VR display with minimal delay, which could then be optionally fused with texture or color information derived from slower, frame-based cameras to provide a complete visual representation while prioritizing motion responsiveness.

In another embodiment, physical rotation methods may be employed. One approach involves incorporating optical relay elements within the VR headset 3152 or an intermediary optical system. These elements, such as precisely angled prisms, mirror arrays (e.g., Digital Micromirror Devices—DMDs, if adaptable), or specialized lens systems, could physically rotate the image path from each camera feed by 90 degrees before the light reaches the horizontally oriented microdisplays commonly used in VR headsets 3152. Another approach involves designing the VR headset 3152 itself with vertically oriented microdisplays for each eye, directly matching the camera arrangement on the robot 1. While these methods eliminate the computational latency associated with digital rectification or view synthesis algorithms, they introduce significant complexity in optical design, alignment, and manufacturing, potentially increasing the headset's bulk, weight, cost, and susceptibility to optical aberrations or distortion if not executed with high precision.

To significantly reduce bandwidth demand in a further embodiment, particularly over constrained wireless networks, the system may transmit intermediate scene representations instead of fully rendered, encoded video streams. In this approach, the robot 1 processes the raw camera data (from vertical or other arrangements) to extract a more compact representation of the scene geometry and appearance. Examples include generating dense or sparse depth maps, creating textured 3D meshes of the environment, extracting point clouds, identifying and transmitting segmented objects with their poses, or constructing Multi-Plane Images (MPI). This intermediate representation is then compressed and transmitted to the operator's station (e.g., computing architecture 3110 or VR headset 3152). The client-side system then performs the final rendering step, synthesizing the appropriate stereoscopic views for the VR display based on this received data and the user's current head pose. While this process shifts rendering computation to the client, it drastically reduces the data volume to be transmitted, potentially enabling teleoperation over lower-bandwidth links, albeit potentially at the cost of visual fidelity compared to full video streaming and calling for sophisticated real-time scene understanding capabilities on the robot 1.

Further embodiments may employ specific neural network architectures to perform the transformation from vertical camera arrangements to horizontal VR views with minimal latency. For view synthesis, variants of Neural Radiance Fields (NeRF) optimized for real-time performance, such as Instant-NGP which utilizes multi-resolution hash grids, or PlenOctrees which pre-compute radiance fields into an octree structure, may be implemented on the computing architecture 3110 or robot hardware. Alternatively, 3D Gaussian Splatting (3DGS) approaches, potentially using streaming-focused variants like GS-Cache optimized for VR rendering or SRBF-Gaussian for adaptive transmission, can represent the scene with 3D Gaussian primitives for fast rendering. Generative Adversarial Networks (GANs) or Diffusion Models could also be trained specifically for the vertical-to-horizontal view extrapolation task, potentially leveraging large pre-trained models as priors for robustness. For rectification tasks, deep learning models incorporating transformer architectures with attention mechanisms may be used for online estimation of relative camera pose corrections, potentially using self-supervised losses based on minimizing horizontal flow in the rectified output. Neural network-based video codecs, such as LLSS with its parallel architecture and feature shifting, might also be adapted not just for compression but for efficient, low-latency transformation and transmission.

In hybrid or split processing architectures, the distribution of image transformation tasks between the robot's onboard processing stack and an external computing architecture 3110 (e.g., edge node) can be refined based on specific hardware capabilities and network conditions. For example, in a scenario with a robot 1 possessing moderate onboard compute (e.g., FPGA or embedded GPU) and a high-bandwidth, low-latency local network connection (e.g., Wi-Fi 6E or private 5G), the robot 1 could perform initial preprocessing tasks such as timestamp synchronization using PTP, fisheye lens distortion correction, Bayer demosaicing, and potentially calculating a sparse depth map using an efficient stereo algorithm like SGM implemented on the FPGA. This partially processed data (e.g., corrected images and sparse depth) could then be transmitted to a powerful edge node such as computing architecture 3110. The edge node would then perform the more computationally intensive tasks like dense view synthesis using NeRF or 3DGS variants, final rendering adjustments, and encoding the resulting stereoscopic video feed (e.g., using hardware-accelerated H.264 or HEVC) before transmission to the VR headset 3152. Conversely, if the robot 1 has very limited compute but access to a camera with direct hardware encoding capabilities and a high-bandwidth uplink, it might only perform minimal preprocessing (e.g., timestamping) and transmit lightly compressed or raw data to the edge node, which would handle distortion correction, depth estimation, view synthesis, and encoding. The optimal split is determined by balancing onboard resource constraints, network bandwidth/latency, and the computational demands of the chosen transformation algorithms to meet the overall motion-to-photon latency target.

Instead of transmitting fully rendered and encoded stereoscopic video streams from the robot 1 or computing architecture 3110 to the VR headset 3152, certain embodiments may transmit more compact intermediate scene representations over the network, particularly advantageous over bandwidth-constrained links. These representations capture essential geometry and appearance information, allowing the client-side VR system to perform the final view synthesis and rendering tailored to the user's instantaneous head pose. Examples of such representations include: (i) Dense or Sparse Depth Maps transmitted alongside corrected texture images, allowing client-side Depth Image Based Rendering (DIBR); (ii) Textured 3D Meshes, where the robot 1 performs real-time 3D reconstruction (e.g., using onboard visual-inertial SLAM or MVS) and transmits simplified, compressed mesh data (e.g., using Draco compression) and associated textures; (iii) Point Clouds, potentially compressed and including attributes like color and normals, generated from LiDAR or stereo matching, suitable for client-side splat-based rendering; (iv) Multi-Plane Images (MPI), representing the scene as a series of RGBA layers at different depths, which can be efficiently compressed and rendered on the client with correct parallax; or (v) Object Lists, where the robot 1 performs semantic scene understanding, transmitting identified objects with their 3D poses, dimensions, and potentially appearance descriptors, allowing the client to render them within a known or dynamically mapped environment. Standardized formats and protocols (potentially extensions of glTF, or custom protocols layered over UDP/QUIC) would define the structure and compression for these representations. The client-side rendering pipeline would then be configured to efficiently decode these representations and perform real-time view synthesis (e.g., DIBR, mesh rendering, point splatting, MPI compositing) synchronized with the VR headset's tracking and display refresh cycle.

To further mitigate perceived latency, especially residual latency remaining after optimizing the capture-to-display pipeline, the VR system leverages sophisticated latency compensation algorithms operating on the client side. Asynchronous Timewarp (ATW) is a fundamental technique that addresses rotational latency. Just before display refresh, ATW takes the most recently rendered frame and warps it based on the very latest head orientation reading from the headset's sensors. This computationally cheap reprojection runs asynchronously and ensures that rotational movements feel responsive even if the application occasionally drops frames, effectively decoupling perceived orientation from the application's frame rate. Asynchronous Spacewarp (ASW) (and related techniques like Motion Smoothing) addresses situations where the application consistently runs below the target frame rate (e.g., 45 Hz vs 90 Hz). ASW synthesizes entirely new intermediate frames by extrapolating motion based on recent frames, head tracking data (rotation and translation), and often depth buffer information (ASW 2.0). This allows a lower application frame rate to be perceived as smooth motion at the display's native refresh rate. Furthermore, predictive tracking algorithms estimate the user's head pose (and potentially controller/hand poses) at the future time when the rendered frame will actually be displayed. Rendering begins using this predicted pose, significantly reducing the perceived lag between physical movement and visual feedback when predictions are accurate. These techniques, often combined with low-persistence displays and precise pipeline scheduling (Phase Sync), are significant for achieving the sub-20 ms perceived latency that is desired for comfortable and effective VR interaction.

In certain embodiments designed for minimal latency, direct hardware connections are established between the cameras and dedicated processing units, completely bypassing the main robot CPU, operating system, and general software stack. For instance, cameras equipped with standard high-speed interfaces like MIPI CSI-2 can be directly connected to the input ports of a dedicated Field-Programmable Gate Array (FPGA), a specialized hardware encoder ASIC, or potentially a GPU via specific capture interfaces. The image data flows directly into this dedicated hardware, which is programmed or configured to perform specific, latency-sensitive tasks such as image preprocessing (e.g., demosaic, rectification), disparity calculation (for stereo pairs), view synthesis, or video encoding. This approach avoids the overhead and non-deterministic delays associated with data copying through system memory, context switching, kernel interactions, and software processing pipelines running on the main robot computer. By processing the image data in a dedicated hardware path immediately after capture, significant latency reductions (potentially milliseconds) can be achieved compared to routing data through the robot's primary computing stack, contributing significantly to achieving ultra-low motion-to-photon latency targets. This architecture is particularly relevant when using external cameras solely for the VR feed, decoupled from the robot's main perception system.

To reduce the computational burden associated with correcting geometric distortions or misalignments arising from camera movement or vibration, particularly relevant for cameras mounted on a mobile robot platform, some embodiments may incorporate mechanical or optical stabilization systems directly at the camera mounting points. Mechanical stabilization could involve active gimbal systems, similar to those used in cinematography, employing motors and inertial sensors to counteract robot motion and vibration, thereby maintaining a stable camera orientation in world space or relative to the robot's base. Alternatively, passive vibration isolation mounts using elastomeric materials or spring-damper systems could mitigate high-frequency jitter. Optical stabilization techniques might involve integrating adaptive optics components within the camera lens assembly or in the optical path immediately before the sensor. These components, potentially using deformable mirrors or liquid lenses controlled by feedback from image sensors or dedicated wavefront sensors, could dynamically compensate for minor misalignments, focus shifts, or optical aberrations introduced by mechanical instability or thermal variations. By physically stabilizing the cameras or correcting optical paths pre-capture, the drive for subsequent, potentially latency-inducing digital image warping, rectification, or online calibration updates is reduced, potentially simplifying the downstream processing pipeline and improving the raw quality and geometric consistency of the captured image data.

### H. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “end effector or hand assembly 56” indicates that the structure that is referenced by the number 56 can be referred to or claimed as either an “end effector” or a “hand assembly.” It should be understood that any parameter that disclosed a range herein may be set to any value within that range, and/or may set a smaller range within the larger disclosed range. For example, disclosing a range between 10 million and 2 trillion parameters discloses a range from 1 billion to 50 billion parameters. Further, disclosing a range between 100 mHz to 50 Hz discloses a range from 1 Hz to 50 Hz.

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a Delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), wheeled robots with torsos and arms, a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be called for in all embodiments. Rather, in some embodiments, such features may be arranged in a different manner or order than shown in the illustrative figures. Additionally, the inclusion of a structural or method feature in a particular figure is not meant to imply that such a feature is to be included in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any other materials have been referenced, they are referenced only to the extent that such references do not conflict with the materials, statements, and drawings set forth herein. In the event of such a conflict, the text of the present document controls, and terms in this document should not be given a narrower reading in virtue of the way in which those terms are used in other materials. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A portable data collection system, comprising:
a base mount;
an adjustable harness coupled to the base mount and configured to secure the base mount to a back of a human operator;
a first articulated arm and a second articulated arm each pivotably coupled to the base mount, each articulated arm comprising a plurality of rigid frame links connected by a plurality of joints and a plurality of joint encoders configured to measure rotational movement of the joints;
a first glove coupled to a distal portion of the first articulated arm and a second glove coupled to a distal portion of the second articulated arm, each glove comprising one or more hand sensors configured to measure finger movement of the human operator; and
a piloting control system communicatively coupled to the joint encoders and the hand sensors, and wherein the piloting control system is configured to suspend and resume the generation or transmission of control data that is based in part on the joint encoders and hand sensors.

2. The portable data collection system of claim 1, wherein the piloting control system is further configured to suspend the generation or transmission of the control data in response to detecting operator movement that falls outside a defined task workspace or a defined task velocity profile, and to resume the generation or transmission of the control data in response to detecting a predetermined resumption movement by the human operator.

3. The portable data collection system of claim 1, further comprising a data storage device coupled to the piloting control system and a time synchronization clock shared between the portable data collection system and a humanoid robot in communication with the piloting control system, wherein the piloting control system is configured to log, in the data storage device, timestamped records comprising measurements from the joint encoders and the hand sensors paired with robot-state data received from the humanoid robot, each record timestamped using the time synchronization clock.

4. The portable data collection system of claim 1, wherein the piloting control system is configured to selectively suspend the generation or transmission of the control data for a predefined subset of degrees of freedom while continuing to generate or transmit control data for one or more remaining degrees of freedom.

5. The portable data collection system of claim 1, further comprising a head-mounted display configured to be worn by the human operator, the head-mounted display comprising a head position sensor communicatively coupled to the piloting control system and configured to provide head positional data to the piloting control system, and wherein the piloting control system is configured to maintain a visual feedback path from a humanoid robot to the head-mounted display during any interval in which the generation or transmission of the control data is suspended.

6. The portable data collection system of claim 1, wherein the joint encoders and one or more inertial measurement units of the portable data collection system are of a common sensor technology with corresponding joint encoders or inertial measurement units installed on a humanoid robot in communication with the piloting control system, such that sensor-level noise and bias characteristics propagate substantially identically through operator-side and robot-side signal chains.

7. The portable data collection system of claim 1, wherein upon resumption of the generation or transmission of the control data, the piloting control system is configured to apply a ramping period during which the control data is generated subject to velocity and acceleration limits, such that motion of a controlled robot smoothly re-engages over the ramping period rather than resuming instantaneously.

8. A portable data collection system, comprising:
a wearable apparatus configured to be worn by an operator and powered by a battery;
a display carried by the wearable apparatus and configured to present visual data to the operator;
one or more sensors configured to detect operator movements; and
a clutch controller configured to:
(i) generate a suspension message in response to detecting an operator movement that falls outside a defined task workspace or outside a defined task velocity profile;
(ii) in response to the suspension message, suspend the generation or transmission of control data;
(iii) generate a resumption message in response to detecting a predetermined resumption movement by the operator; and
(iv) in response to the resumption message, resume generation or transmission of the control data.

9. The portable data collection system of claim 8, wherein the display comprises a virtual reality headset configured to display visual data received from a humanoid robot in communication with the wearable apparatus, and wherein the clutch controller is configured to maintain a visual feedback path from the humanoid robot to the virtual reality headset during suspension of the generation or transmission of the control data.

10. The portable data collection system of claim 8, wherein the predetermined resumption movement comprises one or more of: (i) a predefined gesture detected by the one or more sensors; (ii) actuation of an operator-actuated device integrated with the wearable apparatus; and (iii) a voice command recognized by a speech-recognition module communicatively coupled to the clutch controller.

11. The portable data collection system of claim 8, further comprising a data storage device coupled to the clutch controller and a time synchronization clock shared with a humanoid robot in communication with the wearable apparatus, wherein the clutch controller is configured to log, in the data storage device, each suspension message and each resumption message with a timestamp derived from the time synchronization clock alongside measurements from the one or more sensors.

12. The portable data collection system of claim 8, wherein the suspension message is configured to cause the generation or transmission of the control data to be suspended for a predefined subset of degrees of freedom of the control data while leaving the generation or transmission of the control data unaffected for one or more remaining degrees of freedom.

13. The portable data collection system of claim 8, wherein the clutch controller is configured to apply a hysteresis interval between issuance of the resumption message and subsequent issuance of a further suspension message, the hysteresis interval having a duration selected to inhibit oscillation between suspension and resumption of the generation or transmission of the control data.

14. The portable data collection system of claim 8, wherein the defined task workspace, the defined task velocity profile, or both, are defined by a machine-learning model trained on prior operator-movement records associated with a task performed by the operator, and wherein the clutch controller is configured to update the defined task workspace or the defined task velocity profile as additional operator-movement records are accumulated.

15. A portable data collection system, comprising:
a wearable apparatus configured to be worn by an operator and powered by a battery;
a display carried by the wearable apparatus and configured to present visual data to the operator;
a first glove configured to be worn by the operator and comprising one or more hand sensors configured to measure finger movement of the operator; and
a piloting control system communicatively coupled to the hand sensors, and wherein the piloting control system is configured to suspend and resume the generation or transmission of control data that is based in part on the hand sensors.

16. The portable data collection system of claim 15, further comprising a first articulated arm pivotably coupled to the wearable apparatus, the first articulated arm comprising a plurality of rigid frame links connected by a plurality of joints and a plurality of joint encoders configured to measure rotational movement of the joints, and wherein the first glove is coupled to a distal portion of the first articulated arm.

17. The portable data collection system of claim 15, wherein the piloting control system is configured to suspend the generation or transmission of the control data in response to detecting an operator movement that falls outside a defined task workspace or outside a defined task velocity profile, and to resume the generation or transmission of the control data in response to detecting a predetermined resumption movement by the operator.

18. The portable data collection system of claim 15, wherein the display comprises a virtual reality headset comprising a head position sensor configured to determine a position of a head of the operator and to provide head positional data to the piloting control system.

19. The portable data collection system of claim 15, further comprising a time synchronization clock shared between the wearable apparatus and a humanoid robot in communication with the piloting control system, wherein the piloting control system is configured to log, in a data storage device, records comprising measurements from the hand sensors paired with robot-state records received from the humanoid robot, each record timestamped using the time synchronization clock.

20. The portable data collection system of claim 15, wherein upon resumption of the generation or transmission of the control data, the piloting control system is configured to apply a ramping period during which the control data is generated subject to velocity and acceleration limits, such that motion of a controlled robot smoothly re-engages over the ramping period.

21. The portable data collection system of claim 15, wherein the one or more hand sensors are of a common sensor technology with corresponding sensors installed on a humanoid robot in communication with the piloting control system, such that sensor-level noise and bias characteristics propagate substantially identically through operator-side and robot-side signal chains.
